(19) United States
(12) Patent Application Publication
(10) Pub. No.: US 2004/0139018 A1
(43) Pub. Date: Jul. 15, 2004

(54) Card system

(76) Inventors: Ian R. Anderson, Dublin (GB); Michael E. Abotts, Wedeem (AU); Gyln G.H. Denison, Western Australia (AU)

Correspondence Address: NIXON & VANDERHYE, PC, 1100 N GLEBE ROAD, 8TH FLOOR, ARLINGTON, VA, 22201-4714, US

(21) Appl. No.: 10/332,611

(22) PCT Filed: Jul. 13, 2001
(86) PCT No.: PCT/AU01/00847

(30) Foreign Application Priority Data
Jul. 13, 2000 (AU) PQ 8776

(51) Int. Cl. G06F 17/60

(52) U.S. Cl. 705/41

(57) ABSTRACT

A card system including a plurality of component infrastructures, the component infrastructures each having core components of the system, the infrastructures having a hierarchal relationship such that one infrastructure is dependent on components of a lower infrastructure, and the core components being configurable for different card transaction applications.

### FIELD OF THE INVENTION

The present invention relates to a card system and, in particular, to a system for managing and processing transactions using cards, such as smartcards. A card is a medium, described below, that is capable of storing information that can be used to perform at least one function, including purchase a good or service, cash, funds transfer, loyalty, identification or authentication.

### BACKGROUND OF THE INVENTION

In the past, card transaction systems have been produced for specific applications by developing a system architecture specifically for that application. A typical architecture would be established that involves developing discrete system components for all of the different entities or actors of the system. For example, as shown in FIG. 1, a service provider 2 requires specific components to handle transactions with its Patrons to the extent that it acts not only as a provider of the services, which may be transport services, but also as a Load Agent who provides card services on behalf of an issuer 4 of the cards. The card services may include selling a card, adding value to the card and refunding the card. In addition, the service provider 2 may also require system components to the extent that it acts as an Acquirer who acquires transactions from different parties or components, such as from the Service Provider and Load Agent components or from a Merchant who provides independent goods to Patrons. The issuer 4 also requires specific components to handle its operations as a Clearing house for the cards and as an Owner of the cards, if it does retain ownership of the cards, and also components to the extent that it acts as an Acquirer of transactions from the other components and entities. An Operator who is responsible for operating devices that can communicate with the cards may be entirely separate from the service provider 2 and the issuer 4 and thereby require its own discrete system components. Development of discrete, specific and separate system components also applies for systems where a number of responsibilities for the system components are out-sourced to an entity, such as the issuer 4. For example, as shown in FIG. 2, the service provider 2 may only retain components to the extent that it is the Owner of the cards, to deal with ownership, and Service Provider components to deal with provision of its services. The issuer 4 also acts as the Operator and may have additional system components to handle the devices, cards, device management and the functionalities of a Load Agent. The operator or issuer 4 would then also deal directly with the Patron on all card transactions. Separate specific components are required for independent Merchants, Clearing houses and Acquirers who require separate transaction records.

None of the system architectures described above have any flexibility for deployment in other environments. The systems are specific to one application and do not have an architecture which is readily configurable. It is desired to provide a system which alleviates these difficulties or at least provides a useful alternative.

### SUMMARY OF THE INVENTION

The present invention provides a card system including a plurality of component infrastructures, said component infrastructures each having core components of said system, said infrastructures having a hierarchal relationship such that one infrastructure is dependent on components of a lower infrastructure, and said core components being configurable for different card transaction applications.

The present invention also provides a transaction handler for a card system, executed on a node of the system, having:

an unpacker for unpacking messages received by the node;

a router for routing unpacked messages to a transaction processor; and

a transaction processor for controlling validation, role processing and forwarding of said message.

The present invention also provides software for a multiple application card system, stored on computer readable storage media, including a plurality of component infrastructures, said component infrastructures each having core components, said infrastructures having a hierarchal relationship such that one infrastructure is dependent on components of a lower infrastructure, and said core components being configurable for different card transaction applications.

### BRIEF DESCRIPTION OF THE DRAWINGS

Preferred embodiments of the present invention are hereinafter described, by way of example only, with reference to the accompanying drawings, wherein:

FIG. 1 is a block diagram of a first prior art card system architecture;

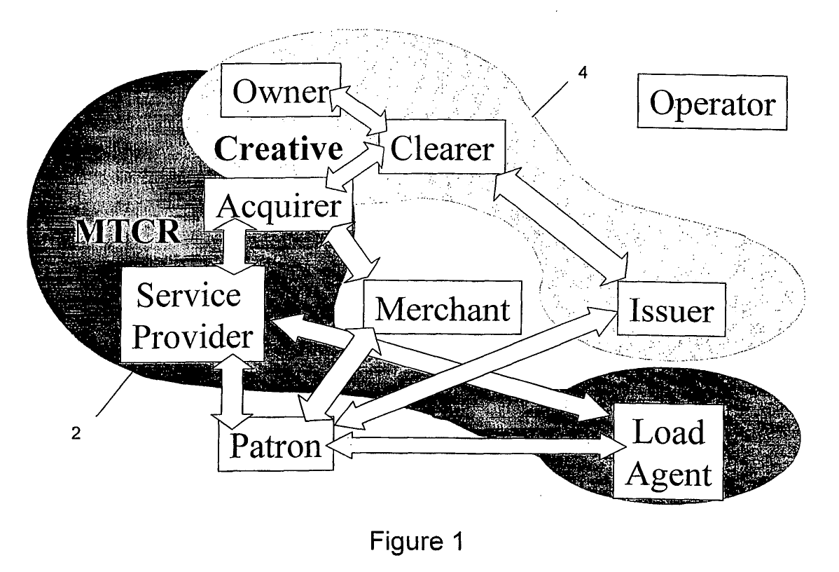

FIG. 2 is a block diagram of a second prior art card system architecture;

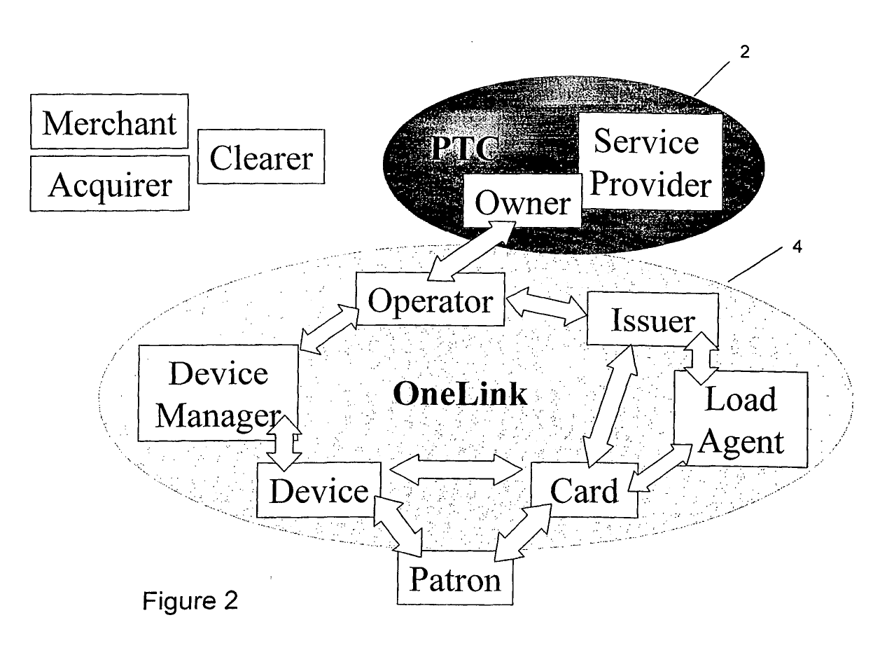

FIG. 3 is a diagram of the component infrastructure layers of a preferred embodiment of a card system;

FIG. 4 is a diagram of the packages of a Business Infrastructure layer of the card system;

FIG. 5 is a diagram of the components of a Management Infrastructure layer of the card system;

FIG. 6 is a diagram of the components of a Technical Infrastructure layer of the card system;

FIG. 7 is a diagram of the components of a Base Services Infrastructure layer of the card system;

FIG. 8 is a block diagram of nodes of the card system;

FIG. 9 is a block diagram of equipment of a service provider of the system;

FIG. 10 is a diagram of relationships between parties of the system for card management;

FIG. 11 is a block diagram of device management components for the system;

FIG. 12 is a screen of a device manager user interface of the system;

FIG. 13 is a control panel of the user interface;

FIG. 14 is an event log display of the interface;

FIG. 15 is a block diagram of a device manager site controller and its components;

FIG. 16 is a diagram of interfaces used for device management;

FIG. 17 is a schematic diagram of devices of the system;

FIG. 18 is a schematic diagram of device adapters;

FIG. 19 is a flow chart for clearing and reconciliation executed by the system;

FIG. 20 is a flow chart for collection and reconciliation of cash used with the system;

FIG. 21 is a diagram of communication architecture of the system for handling managed objects;

FIG. 22 is a diagram of nodes of the system with processors in an installation;

FIG. 23 is a schematic diagram of a transaction handler of the-system;

FIG. 24 is a block diagram of cache components of the transaction handler;

FIG. 25 is a schematic diagram of participant management for the system;

FIG. 26 is a diagram of domains for participant management;

FIG. 27 is a flow chart for participant management;

FIG. 28 is a diagram of actors associated with patron management;

FIG. 29 is a schematic diagram of components for purse management;

FIG. 30 is a diagram of components for service management;

FIG. 31 is a diagram of the components of the management infrastructure;

FIG. 32 is a diagram of components of a user presentation architecture of the system;

FIG. 33 is a diagram of components of the technical infrastructure;

FIG. 34 is a process schematic for a publish subscribe system (PSS) of the card system;

FIG. 35 is an operation process schematic for a synchronous communication system of the card system;

FIG. 36 is an example of a publish subscribe operation;

FIG. 37 is a schematic diagram of a topic hierarchy for the PSS;

FIG. 38 is a diagram of the hierarchy for topic definition;

FIG. 39 is a schematic diagram of connection of the PSS to a messaging system;

FIG. 40 is a schematic diagram of message queue mappings;

FIG. 41 is a more detailed diagram of the message queue mappings;

FIG. 42 is a diagram of a persistent framework architecture of the card system;

FIG. 43 is a diagram of a persistent application architecture of the system;

FIG. 44 is a schematic diagram of the relationship between the infrastructures and components of the infrastructures of the card system;

FIG. 45 is a further diagram of interfaces used in the system;

FIG. 46 is a message flow diagram for initialisation of devices;

FIG. 47 is a diagram of device adapters;

FIG. 48 is a diagram of the physical and logical relationship between devices;

FIG. 49 is a diagram of virtual devices;

FIG. 50 is a diagram of the relationship between devices and the infrastructures;

FIG. 51 is a schematic diagram of a scheduler service of the system;

FIG. 52 is a diagram of the relationship between objects of the system;

FIG. 53 is a screen of a card management interface;

FIG. 54 is a diagram of classes derived from an managed object;

FIG. 55 is a diagram of a collection package of the system;

FIG. 56 is a diagram of collection and object collection classes of the system;

FIG. 57 is a diagram of map class relationships to the system;

FIG. 58 is a diagram of a map parameterised class;

FIG. 59 is a diagram of time classes of the system;

FIG. 60 is a diagram of a byte array class of the system;

FIG. 61 is a diagram of the relationship between attributes of an object; and

FIG. 62 is a diagram illustrating serialisation of an object.

### DETAILED DESCRIPTION OF PREFERRED EMBODIMENTS OF THE INVENTION

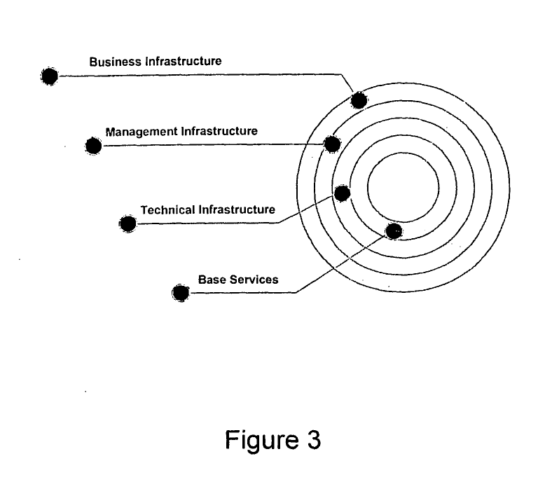

A card system, as shown in FIG. 3, includes core system components which provide the core functionality for any card based transaction processing system, including those used for automatic fare collection (AFC) in transit systems. A transaction processing system based on the card system can be built with the core components by adding additional functional components or customising existing functionality of the core components to suit the needs of the transaction system to be deployed. The transaction system may be for a one or more different applications supported by the cards of the system, such as AFC, one or more loyalty programs, user authentication or identification, access to medical records, etc.

The core components of the card system, hereinafter referred to as MASS, are divided into four layers, as shown in FIG. 3, being the Business Infrastructure, the Management Infrastructure, the Technical Infrastructure and the Base Services. The layers are hierarchical with upper layers, such as the Business Infrastructure, depending on elements of the lower layers to operate. The components are, as described hereinafter, implemented in software, but it will be understood by those skilled in the art that the components can also be implemented at least in part by dedicated hardware circuits.

The Business Infrastructure includes packages which can be configured or omitted depending on the requirements for the deployed system. The remaining three layers are configured for the deployed system on the basis of configuration data before delivery and installation. All of the infrastructure layers include application programmable interfaces (APIs) which allow procedure calls to be made to different operating systems, thereby ensuring MASS is platform independent. The components of the infrastructure layers include core software classes with a number of global variables that exist amongst the layers. All procedure calls from a component of a infrastructure layer are made to lower layers.

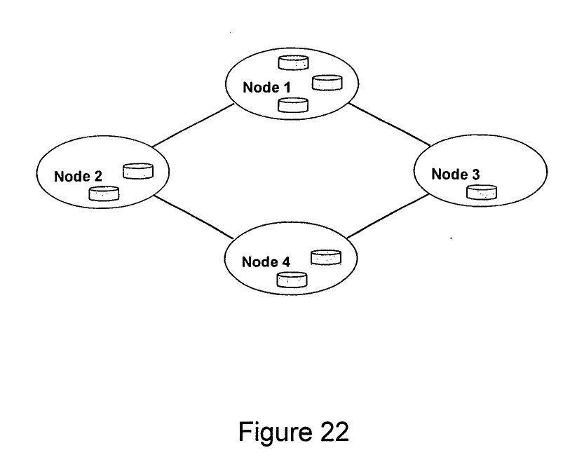

The components of the different layers are installed on discrete processors of the system provided by computer devices to execute the components. The computer devices may be standard networked computer systems, such as PC servers and workstations running a Windows or Unix OS, or hardware devices for communicating with the cards, as described below. One or more of the processors may form a node of the system and the nodes are connected to establish a communications network of the system, as shown in FIG. 22. A node may also be a stand alone machine not connected to the network. The components that are installed on a node or processor will depend on the functionality prescribed for the node or processor, but some components are required on all nodes, such as a Transaction Handler of the Management Infrastructure. A node may have a set of processors that use cooperative management to present as a single active processor. A primary processor within a node can act as the controlling (or active) processor. A node may be a device for receiving and communicating with a card.

MASS operates with a variety of ticketing and point of sale (POS) hardware. If a particular device is not supported by MASS and is needed for the transaction system, i.e. the project, the project team is able to create an adaptor that can translate communication protocols between the device and the standard MASS device interface.

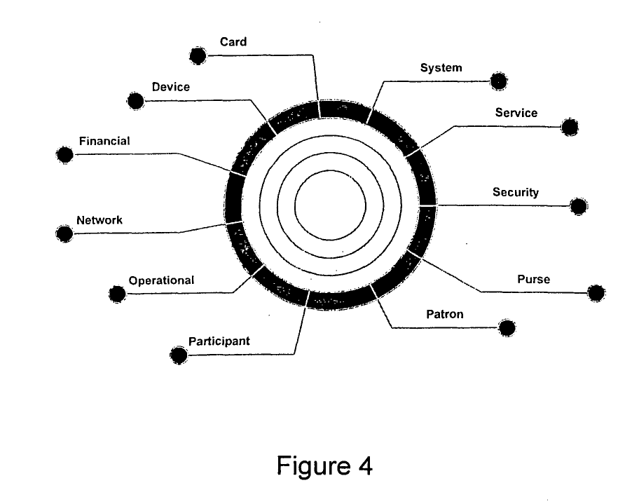

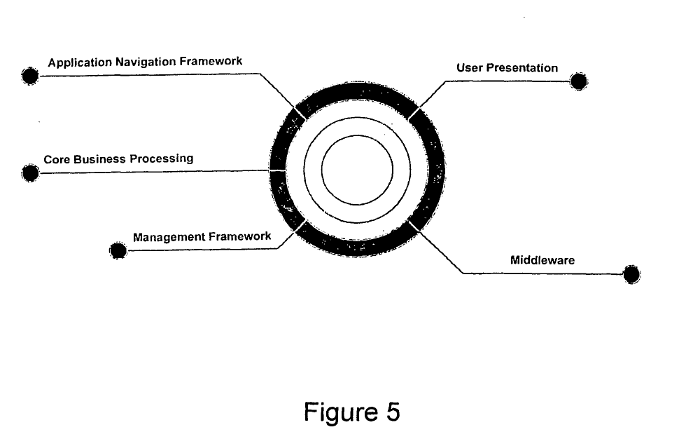

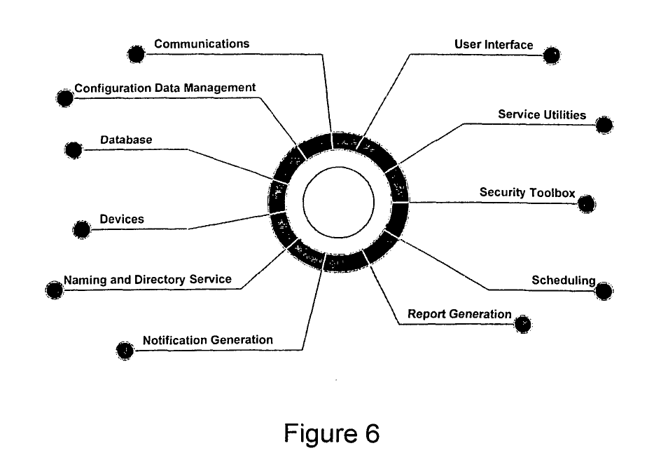

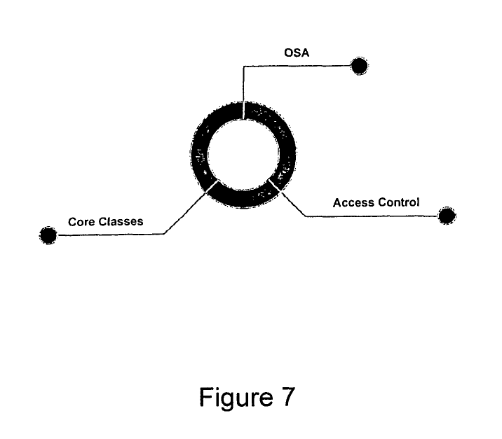

The Business Infrastructure, as shown in FIG. 4, includes packages which handle Card, Device, Financial, Network, Operational, Participant, Patron, Purse, Security, Service and System management. The Business Infrastructure layer is serviced by the Management Infrastructure layer which includes, as shown in FIG. 5, components to handle Application Navigation Framework (ANF), Core Business Processing, and Management Framework, and, if desired, Middleware and User Presentation. Services that are used by most of the software packages are included in the Technical Infrastructure layer. The Technical Infrastructure layer, as shown in FIG. 6, includes, Communications, Configuration Data Management, Database that handles persistence, Devices, Notification Generation, Scheduling, Security Toolbox, Service Utilities and User Interface (UI) components, and, if desired, a Naming and Directory Service and Report Generation packages. The final layer, being the Base Services layer, includes, as shown in FIG. 7, components which handle access control, core classes and operating system abstraction (OSA).

The software packages of the infrastructure layers each include Use Cases which each comprise individual applications that handle specific tasks and message flow and attributes for a given infrastructure. The titles given below for each Use Case describe the function executed by the Use Case. Managers are described which may be processes that generate GUI and/or a party that uses the GUI.

### Business Infrastructure

The Business Infrastructure layer includes the management packages, described below and shown in FIG. 4, that execute the following operations.

Card Management provides services for smartcard management such as smartcard issuing, maintenance of smartcard data, purchase of smartcards and maintenance of a hotlist, being a list of smartcards that are not to be accepted by the system.

The Device Management package provides services to assist the device manager in operating and controlling the devices in a MASS based system. This includes adding and removing devices from the system, remote configuration and monitoring of devices, and so on.

The Financial Management package provides the financial services for participants in a MASS based system. It handles clearing and reconciliation of transactions between participants as well as local settlement clearing.

The Network Management package enables the network manager to maintain and optimise the network of machines and devices (nodes) which comprise the MASS based system. Network Management monitors status, faults, performance, accounting transactions and controls network management resource configuration.

A participant is a service provider who participates in transactions conducted over a given network. Participant Management provides services for the participants. It assigns roles and services to participants and maintains agreements between them. For instance, it has validation rules, used to validate transactions received by a participant, and provides configuration data used to summarise transactions processed by a participant.

Participants can monitor and control their business operations using functions provided by Operations Management. Business events are used to trigger action by Operations Management. A business event is defined as a reported change of state of a business operation. The participant nominates which business operations will be monitored.

The Patron Management package provides services to maintain a patron's details, such as name, address, patron ID, and so on. Certain transaction details are also managed, such as autoload approvals, bad debts, refund history, and so on.

Purse Management manages funds stored on a card in an electronic purse. There may be multiple purses on a card; each purse related to a particular purse issuer (e.g. public transport, telephone, etc.). An autoload function is provided so that finds from the patron's bank account can be automatically loaded into the purse when the purse funds fall below a present threshold. A Purse can be considered as a product supported by an application of the system. A purse provides the electronic representation of Value on a card, and a transaction is normally an atomic unit of work that results in the transfer of Value between Participants or a Participant and a Patron.

The Security Management package provides functions that allow data to be exchanged securely over a network. It allows digital signatures to be used for authentication, and provides management functions to control user access and provide key management. The security package also manages Security key certificates. These certificates are required to ensure that public keys are distributed and used in a trusted manner.

Service Management provides management of software services on a MASS process. The service manager is the software package that coordinates software services (at boot time, processing and shutdown) and allows graphical representation of these services.

System Management provides administration services for a MASS based system. Functions include monitoring of nominated hardware components and databases, detection of code modification (including viruses), and display of management information.

The packages of the Business Infrastructure are described below in detail.

Card Management

Card Management represents a group of system services which aid the distribution and ongoing operational use of cards in a smart card system where goods and services are bought and sold. Automated fare collection systems range from a single computing machine communicating with one or more fare collection devices though to a large networked system involving numerous fare collection bodies, financial services, and redundant back-end servers interacting with high performance databases.

System Roles

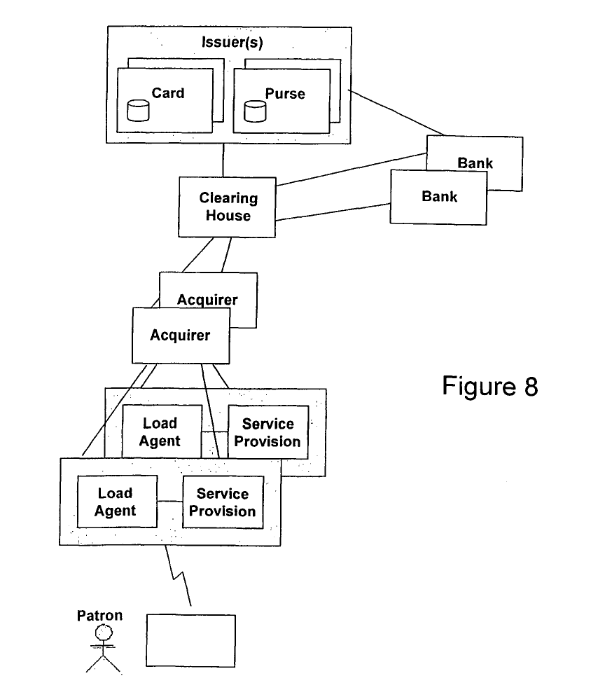

FIG. 8 and the associated role descriptions below put the system roles into context. These roles are not necessarily associated with any physical layout. They could all be running on one machine or on separate machines networked together. Card Management activity operates at the Issuer and Provider levels.

An issuer is a central controlling entity within the system. A Card Issuer is responsible for maintaining a card database that keeps in step with individual cards held by patrons. Cards drive the view held in the card database, not the database driving the contents of the cards. A Purse Issuer is responsible for managing financial activity pertaining to a stored value purse. This includes loading, deducting and fund management. A Card Issuer interacts with a Purse Issuer. A card may support one or more purse.

Banks play a role in supporting financial activity reconciliation services. Although not directly affiliated with Card Management, banks support a facility referred to herein as Autoload. Autoload represents a service where the value of a purse on a card is automatically topped-up (from a nominated bank account) if it drops below a certain value. Autoload is affiliated with Purse Management. Banks also support the concept of adding value to a nurse through electronic find transfers (EFT).

The role of a Clearing House is to interact with Service Providers, Acquirers, Banks, and Issuers in order to reconcile financial activity.

An Acquirer facilitates the clearing of transactions acquired from Providers, Merchants and Load Agents.

A Provider provides Patrons with goods or services through the use of cards.

A Load Agent provides card services on behalf of the Issuer (e.g. sell Card, add Value to Card, refund Card). Essentially a Load Agent represents a Card Management front office.

A card is a medium capable of storing information that can be used to perform at least one function, including purchase a good or service, cash, funds transfer, loyalty, identification or authentication. A card is able to communicate with a device and may take any convenient shape or form, provided it is portable and can be carried by a user. A card can also be embedded in other articles, such clothing or jewellery

A purse is the representation of Value on a Card.

A patron is an entity or person holds or uses at least on card

Service Provider

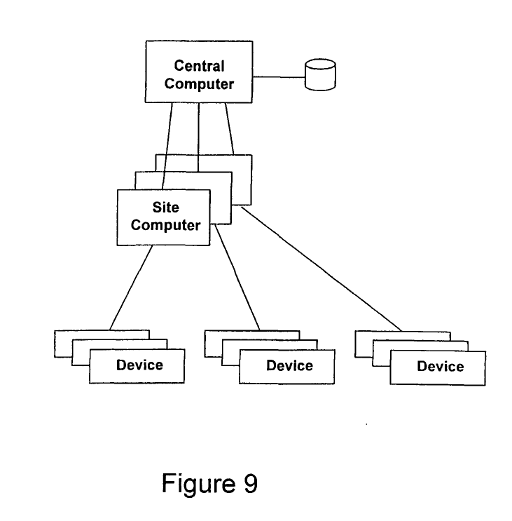

FIG. 9 illustrates, for example, the equipment requires to support a Service Provider. A central computer provides Service Provider specific processing as well as management of data from site computers. In a small system, site computers may not exist. In this case the central computer would interact with devices directly. A site computer is a managing computer located at a Site. Site computers are typically responsible for local device network management and providing data concentration and distribution services for the devices located at that Site. A Device is a computer (or embedded computer) that can communicate with a card. A device is typically used by a Patron, and may contain one (or more) Device Control Boards (DCBs). DCBs are supporting computers that exist only as an adjunct to one or more devices yet have no direct card interface of their own.

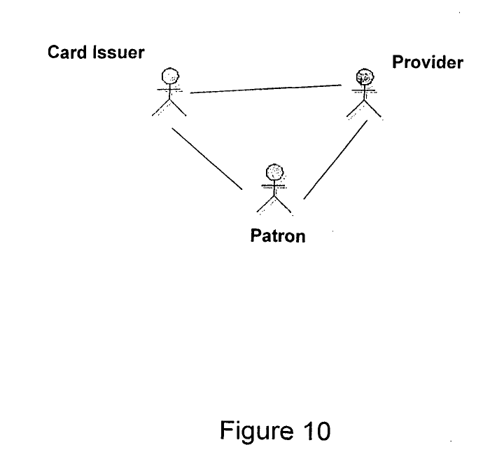

FIG. 10 shows interaction between from a Card Management perspective for a Provider, Issuer an Patron. The key entity interaction takes place between a Provider and Card Issuer. Within the boundaries of the Provider, key entity interaction takes place between the site computer and devices. As well, key entity interaction takes place between site computers and the central computer. There is also potential interaction between the issuer and central database engines.

Package Logistics

The Card Management package is separated into the following functional units (sub-packages):

(a) Card Management Core—contains all the back office functionality for the card package;

(b) Card Facility Management—facilitates the front office operations on the card;

(c) Application Facility Management—contains the front office functionality for the handling of applications on cards; and

(d) Product Facility Management—contains the front office functionality for the handling of product within applications on cards.

TABLE 1
Card Management Use Cases

Title
Process Card Transactions at Back Office
Perform Issuer End of Day
Perform Issuer Start of Day
Close Off Card at Back Office

TABLE 2
Card Facility Management Use Cases

Title
Purchase Card
Enquire Card Details at Back Office
Refund Card
Report Card Lost or Stolen
Return Card
Replace Card
Unblock Card
Initialise Card
Block Card
Verify Card Validity at Device
Process Blocked Card
Purchase Personalised Card
Process Faulty Card
Maintain Card Specific Details on Card
Retain Card

TABLE 3
Application Facility Management Use Cases

Title
Add Application to Card
Delete Application from Card
Maintain Application on Card

TABLE 4
Product Facility Management Use Cases

Title
Add Product to Card Application
Delete Product from Card Application
Maintain Application product on Card

Card Management Services

This section describes Card Management services from a business activity perspective. It is convenient to categorise these services on a sub-system basis.

Card Management Core

The Card Management Core sub-system consists of vital back office functionality for the Card Management package. This includes both processing transactions performed by patrons and handling enquiries.

The business services provided by the Card Management Core sub-package include:

(i) processing of card management transactions;

(ii) end of day processing;

(iii) start of day processing; and

(iv) close off card accounts.

Card Facility Management

The Card Facility Management sub-system deals with operations on cards, and creating transactions used to inform the card issuer of the operations conducted on the card.

The business services provided by the Card Facility Management sub-package include:

(i) card recovery;

(ii) blocking management;

(iii) card personalisation;

(iv) card validation; and

(v) card initialisation.

Application Facility Management

The application sub-package contains all classes and diagrams needed for the manipulation of applications on a patrons' card. The operations within an application requires a card to be placed on the reader/writer during the execution of the operations.

An application is normally represented by a grouping of similar purses and providers. Organisations such as telecommunications carrier or a Public Transport Corporation (PTC) are examples of what can be considered to represent or define an application. Using PTC as an example; there may be multiple providers associated with the application which may include groups—Buses, Trains and Ferries. Each application may also contain one or more purses. A purse holds the value (money) associated with the application (or the provider). Ride, Pass or Common Purse are examples of purse types. Applications may contain concessions which may apply to all providers and purses contained within. An application may contain: zero or more providers, one or more purses, and a single concession.

Provider Facility Management

The Provider sub-system deals with adding, updating and deleting providers to applications on a physical card. This system works only when a card is placed by a reader. A Provider is a specific service provider. A PTC and a taxi company are examples of Providers.

A card may be structured in different ways using the application and provider components. Consequently, a card may reference a set of applications. Each application may reference a set of Providers.

Device Management

MASS systems require devices that process patron transactions and connect to equipment such as smartcard readers, ticket readers, barrier gates, turnstiles, and door latches. Services are needed by the Device Manager to allow efficient control of devices in the MASS-based system. The Device Manager can:

(i) add and remove devices from the system including the authentication and registration of the devices;

(ii) maintain individual device details and device hot-lists;

(iii) remotely monitor and control devices connected to the system;

(iv) remotely configure devices connected to the system in a timely manner;

(v) request transfer of usage data and audit registers from devices connected to the system;

(vi) perform operational reporting;

(vii) maintain device stock information.

The functionality provided by Device Management is similar to that found in Network Management and System Management. Device Management is often located in stations, depots or terminals that have devices, but it is also possible to have a central Device Management system managing remote devices. Device Management Use Cases refer to a Device Manager Central Controller (DMCC) and a Device Manager Site Controller (DMSC). A list of Device Management use cases is given in the table below.

TABLE 5
Device Management Use Cases

Title
Configure Device
Commission Device
De-commission Device
Configure Device Manager Site Controller
Monitor Device Manager Site Controller
Transfer Device Usage Data
Establish Device Connection
Perform Station-Depot End of Day
Perform Station-Depot Start of Day
Commission Device Manager Site Controller
Decommission Device Manager Site Controller
Control Device Manager Site Controller
Maintain Device Details
Maintain Site
Maintain Audit Register Sampling Period
Process Device Events
Monitor and Control Device
Process Roaming Device
Commission Roaming Device

Device Manager Site Controller

The Device Manager Site Controller (DMSC) with its associated MASS functions enables transaction system developers to customise and extend the Device Manager for projects.

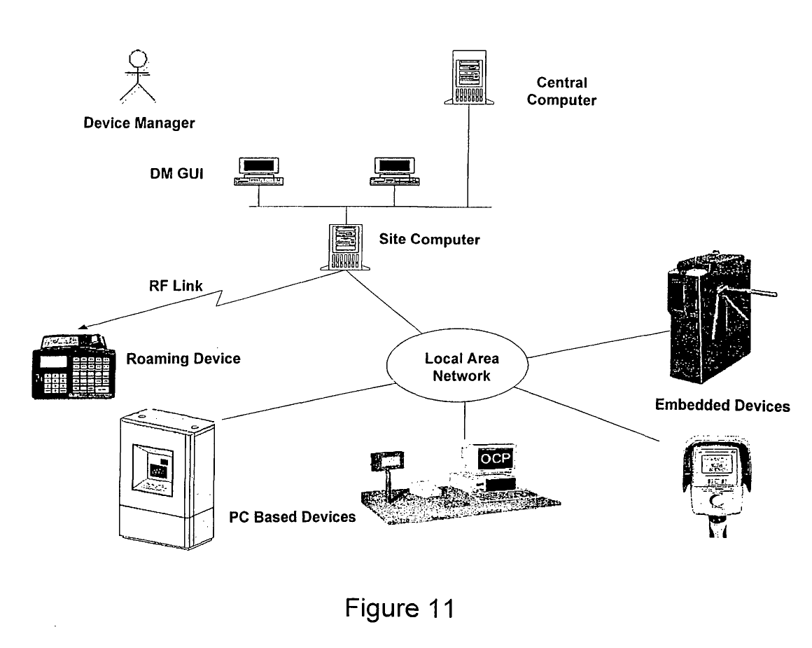

FIG. 11 illustrates the following items that the DMSC operates with:

(i) Device Manager—The actor responsible for managing devices in stations and depots.

(ii) DM GUI—A client application the Device Manager uses to perform device management tasks.

(iii) Central Computer—The Device Manager Central Controller (DMCC) functionality is deployed here.

(iv) Site Computer—The Device Manager Site Controller (DMSC) functionality is deployed here.

(v) Roaming Device—Mobile Devices mounted on buses or other vehicles.

(vi) PC Based Device—Devices implemented with standard personal computer components.

(vii) Embedded Device—Devices implemented with dedicated computing components.

Device Manager GUI

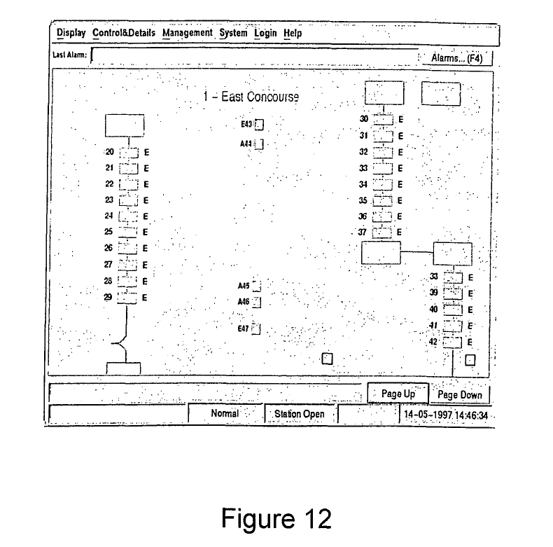

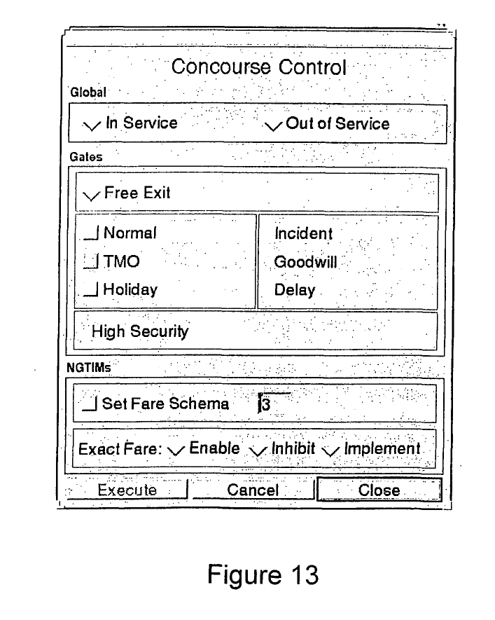

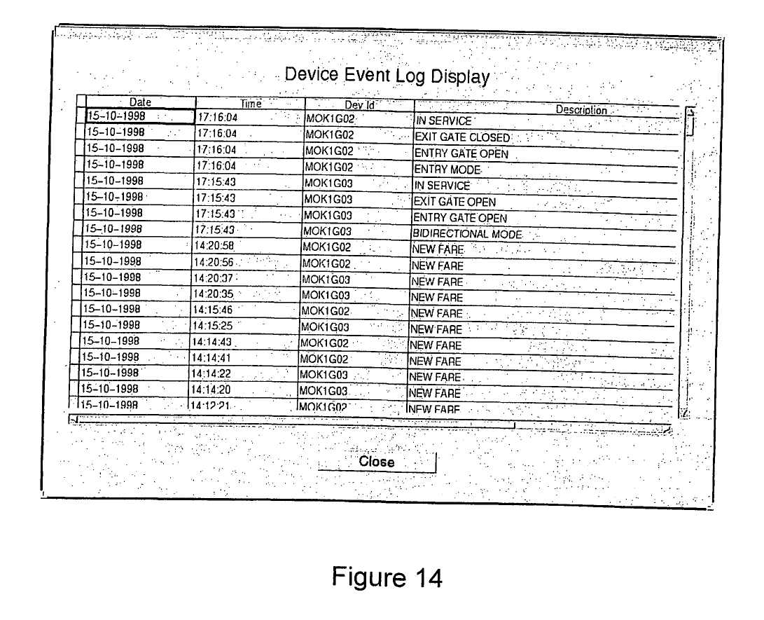

The DM GUI is a client application that provides a Human Machine Interface (HMI) between the Device Manager and the DMSC. The DM GUI provides status screens that display the real-time status of station and depot equipment; it also allows the Device Manager to perform control functions on station and depot equipment. Monitoring screens can be reconfigured to meet the required station or site layout. Device widgets can also be created and removed to reflect the current station or concourse configuration. Device status colours are also configurable. Screen configuration is done by the Project Developer or a Device Manager with appropriate privileges. Most of the time the GUI would be in ‘view’ mode. Sample MASS screens are provided to demonstrate the type of data presented in FIGS. 12 to 14.

The DMSC overview screens allow navigation to different sites. A control panel displays specific status details and control functions for the selected device.

The DM GUI can also display current device events and alarms detected by the DMSC. The DM GUI provides functions to filter and group events or alarms by criteria such as station area, time and priority.

Device Manager Site Controller Services

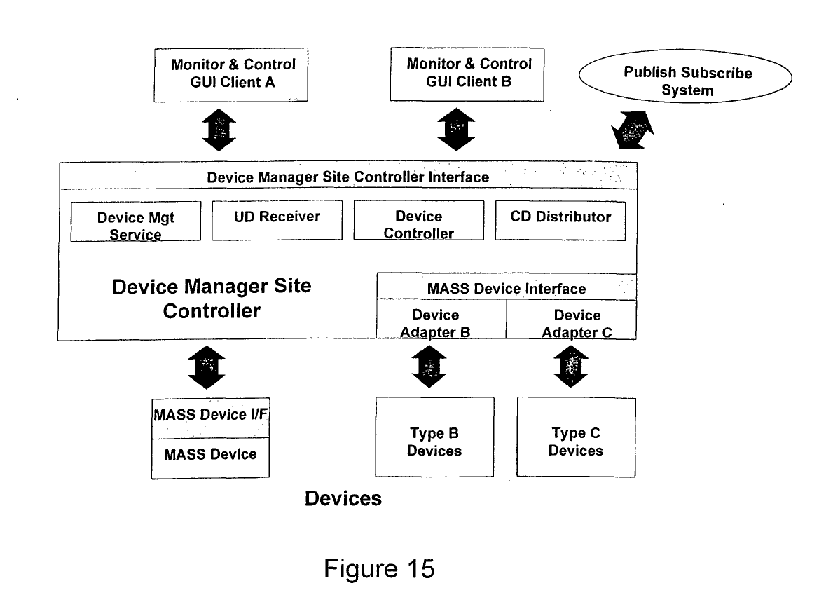

Device management processing at a site, as shown in FIG. 15, is performed by a DMSC and this section describes the distribution of functionality across services hosted by a DMSC to perform tasks executed by the Use Cases.

TABLE 6
DMSC Services Use Cases

Title
Configure Device
Commission Device
Decommission Device
Configure DMSC
Transfer Usage Data (UD)
Establish Device Connection
Process Device Events
Monitor & Control Device

Device Adapter

A device adapter translates the behaviour and protocol of a third-party device so that it can connect to a MASS device interface of the DMSC. A single adapter service would usually handle all the devices of a particular type. The creation of device adapters is the responsibility of each project team. Device adapters are usually needed because of:

(i) limitations of device specifications;

(ii) limitations of device to DMSC networking links;

(iii) geographical requirements of the device (i.e. roaming);

(iv) contractual specifications for device connection protocols;

(v) security issues concerning device authentication and key management.

Although the remainder of this section describes interactions between DMSC services and Devices, it should be understood that the ‘Device’ may actually be a Virtual Device. A Virtual Device is the combination of an Adapter and a real Device that requires adaptation. Together the combination presents the MASS Device Interface to the system.

Usage Data Receiver Service

This service interacts with devices to accept and store Usage Data. The UD Receiver also interacts with other elements within MASS via the Publish Subscribe System, described below. A UD Transfer system is able to re-read old UD records from the Device's UD log if requested, for instance if the messaging system lost data and needed to re-acquire UD from a particular period.

Configuration Data Distributor Service

The DMSC receives Configuration Data (CD) from other elements within MASS that publish CD (such as fare tables and hot-lists). The CD Distributor Service is responsible for storing the CD and making it available to devices at the appropriate time. The CD Distributor Service will notify Devices when new CD arrives and what its location is.

MASS uses a concept of future or inactive CD found especially in roaming devices. Such devices have two editions of the same CD, one is active, and the other will become active at some future time. This is so that the change over can occur simultaneously even though the devices may not be in contact with the system at the time.

Device Controller Service

This service maintains the current state of the Devices that are connected to the system. It is responsible for maintaining this state information for services such as GUI clients. In addition Device status, this service will be responsible for maintaining Alarms, both Device originated and also from other parts of the system.

Device Management Service

This service handles the maintenance of the Device database. Almost all DMSC services will require information about the list of devices at this location and their attributes. This service collaborates with the Device to support the automatic Device registration MASS requirement. If the Device is not in the database, then the Device Manager will add the Device provisionally and send an event to the Device Controller service to alert an operator that a Device needs configuration. Until configured, the Device will not be able to connect fully to the MASS system because some commissioning data may need to accompany the UD, such Device logical name for example.

Monitor and Control GUI

This is a configurable GUI client application that interacts, through the DMSC Client Interface, with the business logic in the Device Controller service to present the current state of some devices and to allow those devices to be controlled. There could be several instances of this client connected and running throughout the system.

Device Manager Site Controller Interfaces

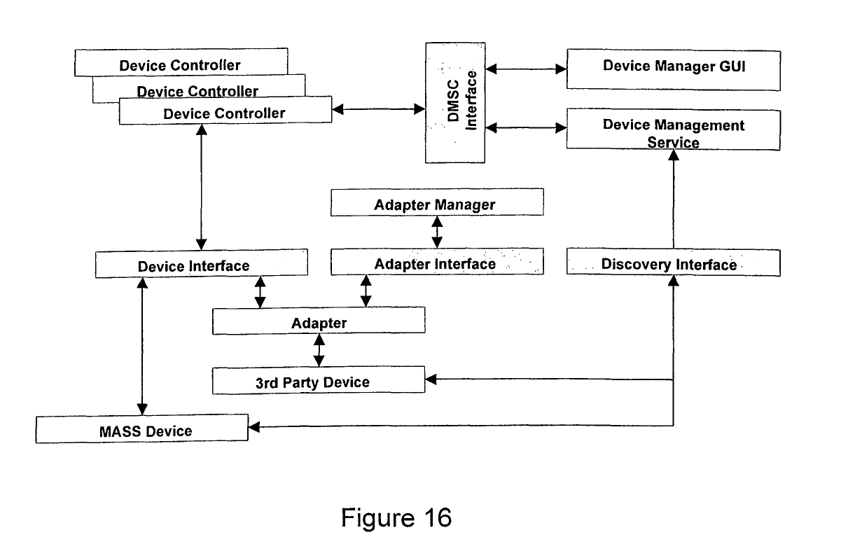

Since the DMSC interface to various client applications, such as the DM GUI and the DMCC supervisory system, it is desirable to present a consistent interface for all client applications. This interface is defined as the DMSC Interface. FIG. 16 illustrates the main elements of the DMSC and the main interfaces to the DMSC.

Device Manager Site Controller Interface

To allow client applications to perform monitoring and control actions with the DMSC, an API is defined that presents a consistent interface for all client applications that connect to the DMSC. Client applications include:

(a) Graphical User Interfaces such as the DM GUI.

(b) Supervisory applications running at a central tier such as the DMCC.

(c) Command line driven debugging tools such as DM CLI.

Device Interface

The DMSC interacts directly with MASS Devices. The DMSC will interact with non-MASS devices via a Device Adapter. Adapters implement the DMSC Device Interface just as the actual MASS Devices do.

Adapter Interface

Components of the DMSC interact with Adapters directly. This interface has operations needed to control the Adapter itself rather than the adapted Device.

Discovery Interface

Used to enable the Device to ‘discover’ its DMSC before it can connect.

Device Categories

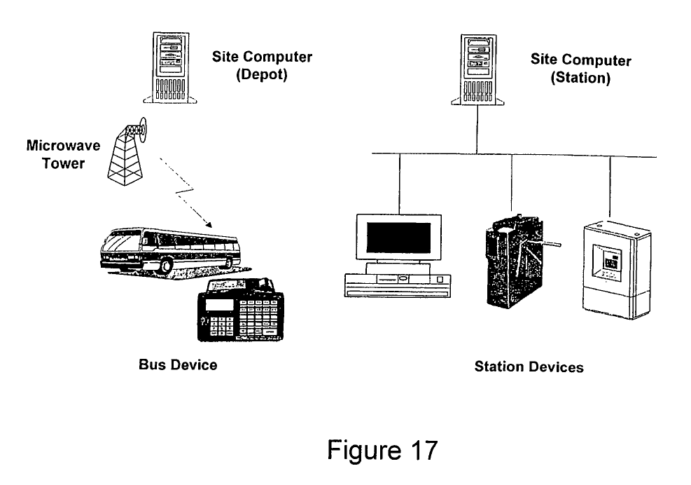

From a Device Management perspective, there are two broad categories of devices, static and roaming, examples of which are shown in FIG. 17. A static device is always associated with a physical location and tends to be in constant communication with the rest of the system. Examples of static devices are station barrier gates and add value machines. These devices are monitored continuously, alarms are generated if an operator needs to be informed of a problem, and an operator can control each Device (or group of Devices).

A roaming device moves from location to location and communicates intermittently with the system. Examples of roaming devices are buses, portable card analysers (as used by inspectors). Roaming devices tend to be processed automatically by the system when they connect and there is no need for an operator to control them. It tends to be important that problems with roaming devices are summarized for later action but this can not be assumed to be always the case.

A dial-up device is like a roaming device in that it communicates intermittently with the system but is like a static Device in that it is associated with a fixed Site and that it requires monitoring and control. The communications could be initiated by either end. A typical example would be a small Point of Sale Device on a newsagent's front counter.

In addition, device behaviour and interface protocols can vary widely from vendor to vendor. Also, a typical MASS system may have devices from several vendors. For the MASS Device Manager to successfully operate with all devices required, it an abstraction layer is implemented with an appropriate interface for devices to communicate through.

Device Architectural Constraints

At the station level the embedded devices dominate the computing environment. Such devices typically have Motorola 68 k processors running at 25 MHz to 50 Mhz with 1.5 M to 4 M of FLASH, and 256 k to 1 M of RAM. They may have 10 M Ethernet interfaces and small LCD displays.

More capable devices with sophisticated GUIs and operator interaction are found in ticket office environments and are typically PC based. Card vending machines and automated card processing machines are also PC based running Unix or Windows operating systems.

It is not possible for all devices to be capable of interacting directly with a DMSC without some translation of protocol or behaviour taking place. It is intended that such translations take place via a Device Adapter where all adapters implement a pre-defined interface to ensure that the DMSC can successfully interact with them.

Device Functional Categories

Devices not only differ by spatial and architectural capabilities, but also functional capabilities based on the task they perform. For example, a gate in a station does not have a Bank Note Collector (BNC) or an Electronic Funds Transfer (EFT) module but an Add Value Machine (AVM) does, conversely an AVM machine does not have the concept of Direction but a gate does. Therefore, when a Device Manager is interacting with an AVM, they expect to be able to perform a different (but intersecting) set of functions than if they were interacting with a Gate. This has an impact on the design of the DMSC and the adapter interface, as the DMSC is extensible so that it can support a variety of device types, regardless of the device's functional capabilities. Special considerations are taken into account when the DMSC is controlling a group of dissimilar devices as an atomic unit. For example, a GUI icon may represent a whole platform at a station. That ‘Device Group’ entity would contain several types of device.

Table 7 shows an example functional capability matrix for selected devices. This matrix is not exhaustive; it is merely used to illustrate that there is a set of common functionality across devices. However there is also functionality that is unique to a specific device category. An MPR is a multiple purse reader device. An OCP is Office Card Processor that is normally PC-based generally used for back-office processing.

TABLE 7
Example Functional Capability Matrix

| Functionality | MPR | Gate | AVM | OCP |
|---|---|---|---|---|
| Auto Device Detection | yes | yes | yes | yes |
| Authenticate Device | yes | yes | yes | yes |
| Set/Get Device Mode | yes | yes | yes | yes |
| Get Device Details | yes | yes | yes | yes |
| Get CSC Status | yes | yes | yes | yes |
| Synchronise Time | yes | yes | yes | yes |
| Get New Configuration Data | yes | yes | yes | yes |
| Take AR Snapshot | yes | yes | yes | yes |
| Drain UD | yes | yes | yes | yes |
| Get/Set Fare Mode | — | yes | — | — |
| Get/Set Gate Direction | — | yes | — | — |
| Get/Set Gate Special Operation | — | yes | — | — |
| Get BNC Status | — | — | yes | — |
| Get Vault Status | — | — | yes | — |
| Get Operator PIN | — | — | — | yes |

Device Adapter Strategy

As discussed, a DMSC may be required to support multiple types of devices that support various protocols. A standard interface to all device types is the motivation for using device adapters.

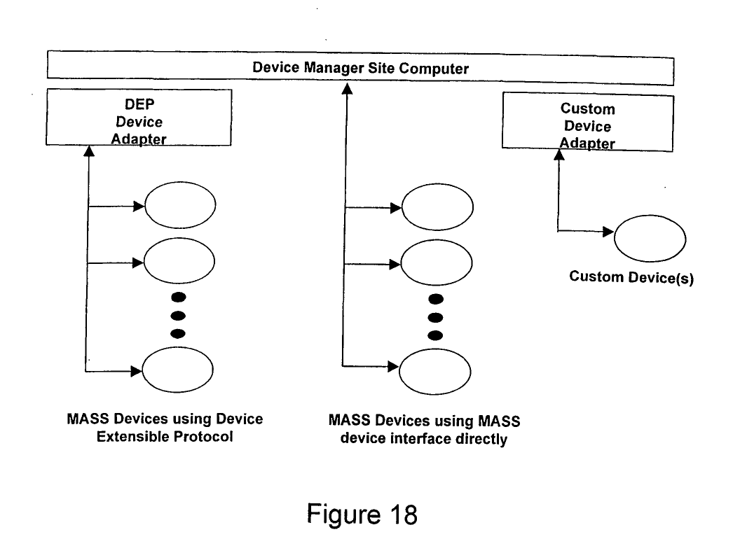

The concept is that if a third party device is to be used with MASS, a device adapter is written to translate the MASS device interface into the native interface protocol used by the specific third party device. A specific project implementation may use one device adapter to communicate with a number of devices conforming to another device interface protocol standard and another device adapter for communicating to a custom designed third party device, as shown in FIG. 18.

Financial Management

A participant can perform one or more roles within the system (i.e. transit provider, acquirer, clearing house, issuer). Any two participants can have a financial relationship or service agreement in a MASS-based system. This relationship may be direct or via an intermediary (e.g. a clearing house). The service agreement provides the service details that a participant requires to operate in the MASS environment (e.g. Fee, Clearing, Reconciliation). Subpackages provide a level of functional decomposition and allow the financial management package to be visualised in the system as a hierarchy of package, subpackage, service. The following list provides a brief description of the responsibility of each subpackage.

TABLE 8
Financial Management Subpackages

| Subpackage | Description |
|---|---|
| Financial Core | describes the core system of financial management |
| Clear | describes the clearing of transactions for settlement |
| Reconcile | describes the reconciliation of a cleared settlement |
| Fee | describes calculation of fees |
| Cash Management | describes the managing of cash register |

TABLE 9
Financial Management Use Cases

Title
Calculate Fee
Reconcile Audit Register
Process Audit Register
Clear Between Participants
Reconcile Between Participants
Reconcile Cash Transactions
Distribute Settlement Data
Perform Financial End Of Day

Financial Core

Financial Core is the core system for financial management; all financial participants in a MASS based system use this subsystem. It incorporates the following services:

(a) distribution of settlement data;

(b) initiation of financial end of day processing.

Distribution of Settlement Data

All financial participants settle on the basis of transactions exchanged between them. The clearing and reconciliation of a settlement is described in other sections. Both these operations may require settlement data to be exchanged between the participants.

Distribution is controlled by configuration data stored in the system as defined in the service agreements relating to settlement. Settlement may involve two distinct configurations of participants, which require settlement data to be distributed differently:

1) Settlements are cleared and reconciled by a clearing house.

a) Transaction summary data for the business day to be settled are sent by each participant to the clearing house.

b) The cleared settlement is sent to both participants by the clearing house.

c) The reconciled settlement is sent by the clearing house to the participant which sends transactions.

2) Settlements are cleared by the participant which receives transactions and is reconciled by the participant which sends transactions.

a) The cleared settlement is sent to the reconciler by the clearer.

b) Whenever settlement data is sent to a participant, the data is collected and persisted as it arrives. Arrival may invoke the process which uses the data, e.g., arrival of summary data at a clearing house will invoke clearing or reconciliation depending on which participant the data was sent by.

End of Day Process

Participant end of day rollover is processed in a Core Business Processing package described below. The Financial Management package includes processes which may be initiated by the end of a business day:

(a) settlement clearing, when performed locally rather than by a clearing house;

(b) reconciling audit registers to transactions.

Financial Core End Of Day provides an interface to the Core Business Processing subsystem, and determines from a financial participant's configuration which processes in Financial Management subsystems to invoke.

Clear

The clear subsystem provides the functionality to clear and settle accounts from one participant (the payer) to another participant (the payee). This is an optional subsystem for a participant.

Settlement Configuration

Settlement is configured based on a settlement agreement, which defines:

(i) what transactions are to be settled;

(ii) the payer participant;

(iii) the payee participant;

(iv) the participant which sends transactions;

(v) the participant which receives transactions.

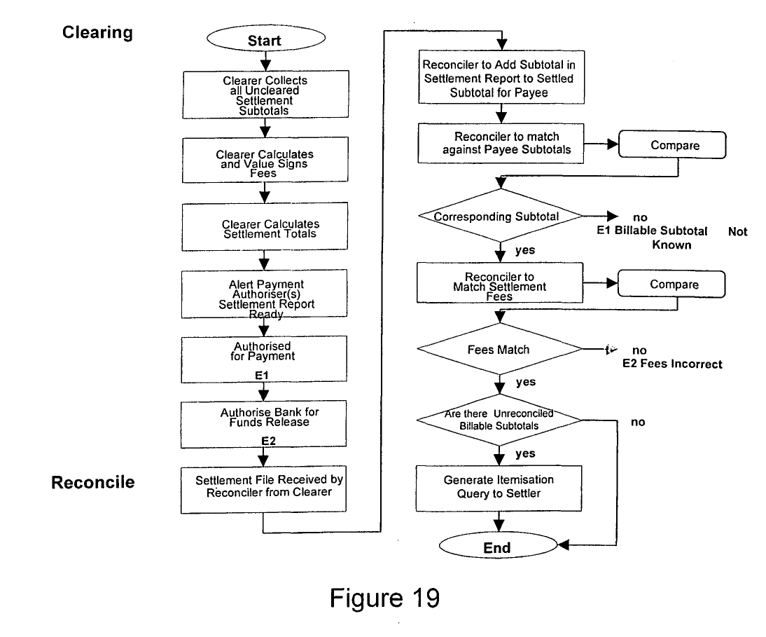

Clearing Settlements Between Participants is executed as shown in FIG. 19. Clearing determines the items that should be paid for in a settlement, and produces a settlement report which summarises the payment required by the payer to the payee. Clearing is performed by the transaction receiver or by a clearing house on behalf of the receiver. The transaction summaries calculated by the receiver include the business dates of both participants; this enables a receiver to produce a settlement report with subtotals for both participants' business days.

Clearing is configured based on a clearing agreement, and related fee agreements. Clearing begins with the acquisition of settlement transaction summaries, which are produced by the transaction processor of the Core Business Processing subsystem. The clearer sums the amounts to be settled, calculates fees payable by the payee to the payer, and fees payable by the payer to the clearer and calculates a final settlement amount. Where necessary the amounts are converted to the currency preferred by the payee (the settlement payee and clearer). These summaries, totals and fees are combined to produce a settlement report. The report is persisted. The settlement report is then authorised and funds released for settlement. Settlement itself, that is the exchange of funds, is assumed to be done on the basis of information exported to the participants' general ledgers. Settlement may be done partially, on the basis of summary total amounts, during the business day. The cleared settlement is distributed.

Reconcile

This subsystem provides the functionality for a participant (the sender) to reconcile a settlement report it received from another participant (the payer). If there is an inconsistency, the participant can raise a dispute, this is covered by claims management, which manually resolves issues.

Reconciliation Between Participants is executed as shown in FIG. 19. Reconciliation is signalled when a cleared settlement has been received by the sender (the reconciler) from the receiver (the Clearer). Reconciliation may be performed by an intermediary (e.g. a clearing house) or directly between the participants. Reconciliation is based on the Transactions processed on the business days of the participants. The reconciler compares each receiver transaction summary subtotal in the cleared Settlement with the appropriate sender transaction summary subtotal. If they match, within configurable limits, then that subtotal will be marked as reconciled.

If a subtotal cannot be reconciled after a configurable period of days a reconciler sends an itemisation query to both participants for each unreconciled billable subtotal. The query, once satisfied, enables the reconciler to identify the transactions which are missing from one participant's summary. The reconciler can arrange for these transactions to be sent again. If a subtotal cannot be reconciled a configurable period after an itemisation query has been sent, reconciliation is abandoned. The settlement is disputed and the participant must resort to claims management.

If a settlement is fully reconciled the fees which apply to it are calculated, so that the fee amounts that pertain to the sender's business day are known.

Fee

The purpose of this subsystem is to provide the functionality for a participant to calculate the appropriate fees when clearing or reconciling a settlement. Fees are configured based on a Fee Agreement attached to a Business Agreement under which settlement is being done. Fees are based on the totals of transactions, as calculated in transaction summaries. A Fee Agreement nominates a transaction summary and a formula to apply to the summary to calculate the fee.

Calculating Fees

Fee calculation is invoked by a clearer or reconciler. The fee calculator locates the transaction summary nominated in the fee agreement; this is attached to the settlement for which the fee is being calculated. The formula is applied to derive a fee amount; this may be rounded. The fee is then attached to the settlement.

Cash Management

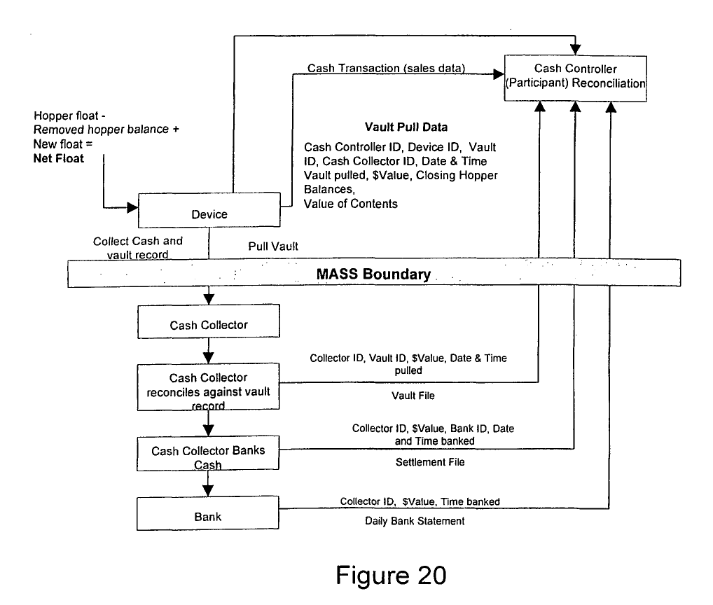

Cash Management provides the functionality for the reconciliation of cash collected from devices to a vault pull transaction generated at the time the cash was collected. Devices can be ticket vending machines including change hoppers and other machines that accept cash. Collection and reconciliation of cash as executed by the Cash Management subsystem is shown in FIG. 20 and described below.

Cash Collection

A cash collector pulls a vault or removes a hopper from a cash device having arranged for access via a PIN at the participant site. When the vault is removed the device generates a vault pull transaction, which identifies the collector and the amount which the device has taken since the vault was last replaced. The vault pull transaction is validated and persisted by the transaction processor. The cash collector counts the cash and deposits it in a bank account, as arranged with the provider.

Cash Reconciliation

Periodically a cash collector provides a statement to the participant detailing the amounts removed from devices. The statement contains information that enables the cash controller to reconcile the statement to the vault pull transactions.

Audit Registers

Audit Registers provides the functionality for the reconciliation of device audit registers to transactions processed by a participant. This subsystem is of use to a participant that processes all transactions from a device.

Device Audit Registers

Devices contain registers which maintain counts and amount totals for transactions of configured types for audit purposes. The registers are separately powered and should maintain the integrity of their data when the device malfunctions or loses power. The count and amount should never be reset but should ‘wrap-around’ when the storage area reaches it's maximum value.

An audit register may be read periodically or on an ad hoc basis, via the site computer, to produce an audit register read (AR Read) transaction. The AR Read contains a transaction type, a transaction count, perhaps a total transaction amount depending on the transaction type, and a timestamp and sequence number. AR Read transactions are validated and persisted by the transaction processor.

Audit Register Reconciliation

A participant may wish to reconcile audit registers to transactions processed. This may be done as for an audit register as a read is received, for selected audit registers ad hoc, or, most likely, for all audit registers at end of day. If reconciliation is done at end of day the participant must arrange for AR Reads to be collected from all devices at end of day. The participant would also be configured to calculate transaction summaries to match the audit registers; that is, their instance of the transaction processor maintains a transaction summary for each transaction type and each device.

Reconciliation involves:

(i) calculating the number and amount of transactions in an audit register, allowing for ‘wrap-around’;

(ii) calculating similar totals for processed transactions from the same device and of the same type;

(iii) calculating similar totals for transactions which have not been processed because of validation exceptions;

(iv) comparing the totals;

(v) alerting the system administrator to any inconsistency;

(vi) persisting the reconciliation data.

Operations Management

The Operations package allows participants to monitor and control their business operations (as opposed to their business finances). Typical business operations can involve merchants and service providers monitoring the services that they provide to their patrons, but it is not restricted to this activity and includes any participant monitoring, including the behaviour of operators. The information gathered from monitoring business operations can be used by the participant to improve their services.

The Operations Management subsystem provides facilities for selecting business operations and events that are of interest; it also provides support for monitoring selected events and analysing them. Interactions with the operations manager are described below.

TABLE 12
Operations Management Use Cases

Title
Select Operational Event
Generate Operational Event
Monitor Operations
Analyse Operations
Maintain Business Operations and Business Event Configuration
Data
Create and Destroy Business Operation
Maintain Business Event Log

Selecting Business Events

Participants can select events they wish to record. There are groups of events for each service (MASS subsystem) organised according to the initiating actor. A selection of actors and typical operational events they can generate is shown in Table 13.

TABLE 13
Selected Actors and Typical
Operational Events they can Generate

| Actors | Operational Events |
|---|---|
| Patrons | Boarding and alighting from a vehicle |
| Vehicles | Changing locations, service interval |
| | reached (from an odometer reading), |
| | starting/ending trips |
| Timers | Any scheduled event |
| Participants | One participant may ask another to do |
| | something, such as start clearing |

Monitoring Business Operations

Operational data reported by devices allows real-time monitoring of business operations (depending on the communications latency). User interfaces allow system operators access to this information to allow, for example, a service provider to take immediate action to remedy problems such as congestion. The use case allows an operator to initiate real-time reporting which continues until the operator stops it. The level and type of real-time monitoring is project-specific. Examples are:

(a) Vehicle Position. One scenario is that vehicles report their position along a route. This information could be gathered and presented as a geographical display of vehicle location, to allow operators to identify delays and reschedule routes accordingly. Patron information could also be gathered to develop a profile of the number of patrons carried on each vehicle. This information would allow management to fine tune the fleet requirements.

(b) On Demand Services. Another scenario is to install devices at selected locations, that allow patrons to request rides. In this way services would only be provided when requested rather than providing a service according to a timetable regardless of the patronage. This means that resources would not need to be wasted by services being provided on empty routes.

Analysing Business Operations

By using data recorded over an interval business operations can be analysed and trends determined. These trends allow service providers to improve their business, for example, by determining usage profiles of bus routes schedules can be optimised. The requirements for analysis vary among participants; it is for this reason that it is the responsibility of each project team to determine and design a solution. Examples of analysis are:

(a) Fare Defrauders. In a bus fare collection system requiring entry and exit card tagging (refund on exit), patrons, after they had registered their card on boarding the bus, could defraud the service provider by registering their card at the exit processor after the bus had travelled one stop even though they remained on the bus. In this way they can complete their journey and the total cost is only that for a single stop. Irregular travel profiles highlight potential fraud, and the transit company can send out inspectors to investigate the situation.

(b) Service Improvement. By being able to monitor patronage on transport routes busy times can be identified and extra services can be scheduled; conversely, where there are unused services they could be cancelled. Patterns of travel can be detected to determine potential new routes, including special peak travel routes; for example, students at a university may travel a particular route between the university and student residences and analysis indicates that there is potentially sufficient patronage at certain times of day to justify an express service.

(c) Employee Monitoring. If operators are identifed by the system, their performance can be monitored. This data can be used to see if service timetables are being followed by the operators.

Maintain Business Event Types and Business Operation Types

An operations manager can maintain (i.e. modify and update) configuration data pertaining to the Operations Management system. This configuration data includes the configuration of business event types and business operation types.

Maintaining Business Event Logs

An operations manager can maintain and manage any of the business event data being logged to persistent storage. Business logs need to be created, archived and deleted. Business event log entries consist of business event data.

Creating and Destroying Business Operations

A user of the Operations Management package needs to create a new business operation, or remove an existing one from the system.

Generation of Business Events

The first stage of monitoring business operations is to gather the raw data. This will occur every time that an actor interacts with the participant, such as a patron purchasing a ticket, or a bus progressing along a route. The particular type of data to be collected depends upon the analysis required, and is therefore project specific. However you would expect to provide a timestamp and interaction type for this data. This is an abstract Use Case which only defines generic operational information. For projects data related to the specific event is defined in concrete Use Cases many of which will be project-specific Use Cases. Once a business event is generated it is validated and recorded in persistent storage for subsequent analysis. Some data may need immediate data processing, such as updating of a bus location could used for real-time operational monitoring.

This Use Case only provides hooks for immediate data processing; the rest of the design is done at project level since the type of real-time information desired will vary between the types of events in different projects.

Participant Management

Participant Management is the configuration of a participant's representation within a MASS system. A participant's representation in the system is defined through the management roles they perform within their domain, through the resources they manage, through the relationships with other participants and through the rules of their participation in the system. Participant Management is also responsible for executing the business arrangements between participants that allow the sharing of information between different business entities.

TABLE 14
Participant Management Use Cases

Title
Maintain Fee Agreement
Maintain Participant Details
Maintain Financial Exception Details
Maintain System Transaction
Maintain Financial Institution
Maintain Transaction Summary Configuration Data
Maintain Validation Rules
Maintain Participant Agreement
Maintain Participant Role
Maintain Transaction Processing Configuration Data
Maintain Transaction Forwarding Rule

Participant Management Model

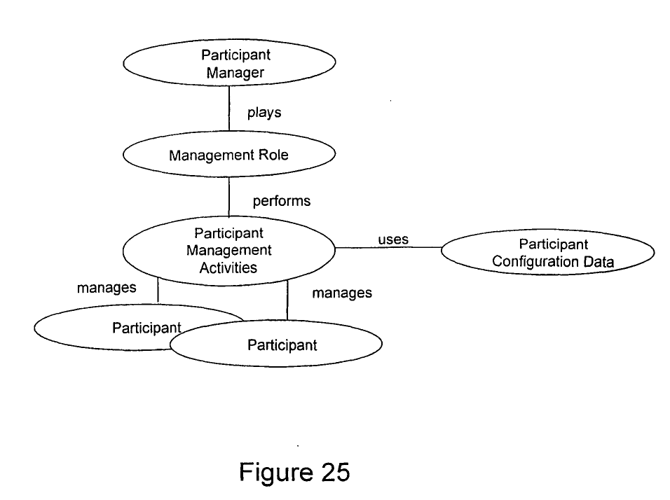

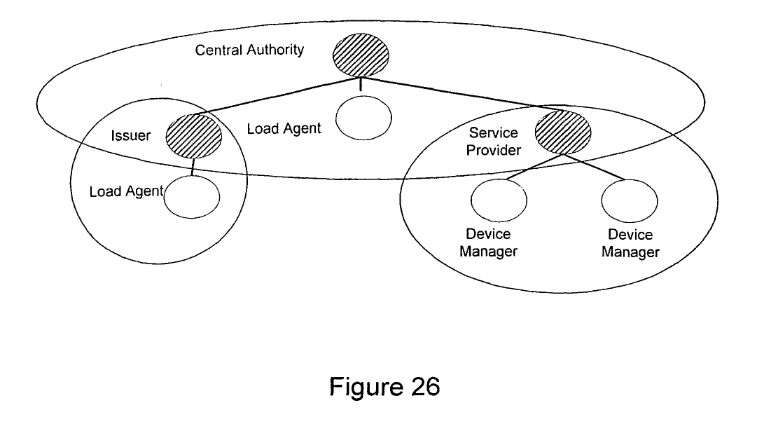

The Participant Management model is based on the management meta-model. The meta-model provides a unified method for managing resources within the system. FIG. 25 shows how the meta-model is applied in Participant Management. Participant Management is the management of the participant's domain resources. Each participant manager has it's own domain. Some domains can span other domains; e.g. all participants can be in the domain of Central Authority. Management domains are defined by management agreements. A management agreement between participants specifies the participant manager, its role and management activities and the participants being managed. Participants are the resources in the Participant Management. A participant that is a managed resource in one domain may be a participant manager in another domain. FIG. 26 shows an example of the participant configuration. The shaded circles represent participant managers. The lines between circles represent management agreements between participant managers and participants they manage. The ellipses around participants represent management domains.

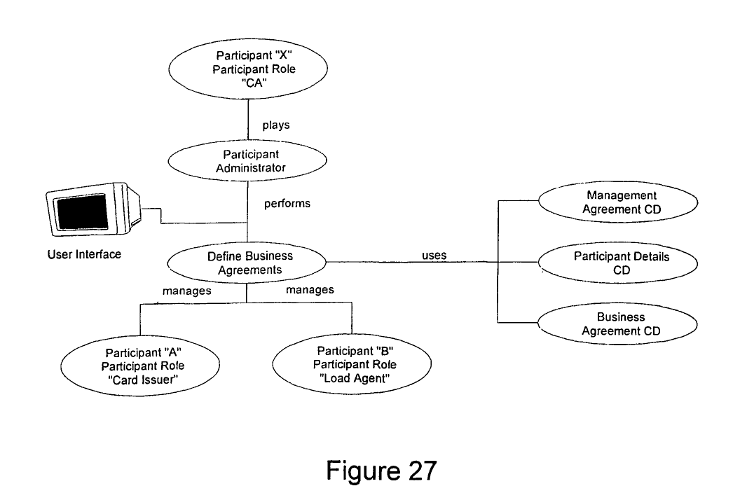

Participant Management defines the relationships between the participants, their roles and services they provide and use. A participant manager will approve new participants, define their roles and services associated with the roles and business agreements between them. A participant can take on one or more roles. There will be a pre-defined set of roles with a core set of services attached to them. The set contains the services that are usually performed by a particular participant role. Participant management will allow reassignment of one or more services to other participant roles. Each service is defined on the basis of an associated service agreement defining the interested parties, i.e. supplier and user of the service. Additionally, each service agreement may have a corresponding fee agreement defining fees and fee charging methods for the services performed. FIG. 27 shows how a participant manager can define a business agreement between two participants in the system.

As part of the management of the overall system, Participant Management is responsible for the navigation of the management system to allow the identification of services available to a role whether it is across a domain or a single node. Once Participant Management has allowed navigation to a service, then the System Management component establishes a connection to the service.

Manager

The participant manager is the actor responsible for the management of participants within a domain.

Roles

Participant Manager plays the roles of participant administrator and participant monitor.

Management Activities

Monitoring

The aim of monitoring is to ensure that participants are adhering to defined business standards. As a result of the monitoring process a participant can be reported to the Central Authority for hotlisting. A hotlisted participant is excluded from participation. If their role is essential to the system then the other participants are reconfigured to accommodate for the hotlisting. For example, if a participant in a role of Clearing House is hotlisted then the activity of clearing has to be assigned to another participant. The Central Authority normally cannot be hotlisted.

Control activities are concerned with configuration of participants' representation and relationships in the system. This involves maintenance of participant details, their roles and services assigned to the roles. The management activities also include defining the management domains in the system. Participant management activities are:

(i) maintenance of management agreements;

(ii) maintenance of business agreements;

(iii) maintenance of participants details;

(iv) distribution of configuration data to the participants in the management domain.

Reporting

Reporting in Participant Management consists of creation and distribution of summaries of participant activities in the system.

Configuration Data

Configuration data (CD) defines the relationships between the participants, their roles in the system, the rules of their representation in the system, and their domain of management and influence. Participant CD includes

(i) Participant Details. Holds the information about a participant as a physical business entity and identifies the roles they play in the system.

(ii) Participant Activities. Defines a set of activities which a participant playing a role will perform in the system.

(iii) Participant Agreements. Holds information about relationships between the participants in the system. The agreements define the type of relationship, the roles participants play in the relationship and activities involved in managing them. Management agreement and business agreement are examples of such agreements. Management agreement identifies management relationships between participants. Business agreement identifies business relationships between participants and services that participants provide and use.

### Table 15: Participant Management Example

| Management | Management | | |
|---|---|---|---|
| Role | Activity | Resource | Configuration Data |
| Participant | Maintain | Participants | Management |
| Administrator | Management | | Agreement |
| | Agreements | | Management Roles |
| | | | Participant Details |
| Participant | Distribute | Participants | Management |
| Administrator | Management | | Agreement |
| | Agreement | | Participant Details |
| Participant | Maintain Participant | Participants | Participant Details |
| Administrator | | | |

User Interface

Participant Management will provide the user interface for the maintenance of participant details, participants' roles and activities associated with them, and relevant agreements.

Management Interface

Configuration data detailing agreements between the participants forms the interface between the participant manager and the participants.

Resources

Participants are the resources relevant to Participant Management.

Patron Management

The Patron Management package provides the functionality to maintain patron-specific details at the back office. The data stored for each patron can be divided in to four categories:

(i) main patron details

(ii) refund history

(iii) bad debt

(iv) autoload details

Patron Management consists of nine use cases that can be divided into four subsystems.

TABLE 16
Patron Management Use Cases

Title
Maintain Non-Card Patron Details
Maintain Patron Type Configuration Data
Maintain Patron Details at Back Office
Maintain Patron Refund History at Back Office
Enquire Autoload Bad Debt at Back Office
Process Autoload Bad Debt Event
Process Autoload Bad Debt Settlement
Process Autoload Application at Back Office
Process Autoload Approval at Back Office

Patron Management activity can operate at different levels within a scheme, from one central patron system administered by a scheme operator to many separate patron systems administered by card issuers or purse issuers. There are many possible configurations for a patron system. For example, a purse issuer will want a bad debt history; a scheme operator may only want to maintain patron details. Information regarding patron details and history will be drawn directly from GUIs supplied by Patron Management use cases or from transactions and events generated by Card Management and Purse Management.

Key Interaction

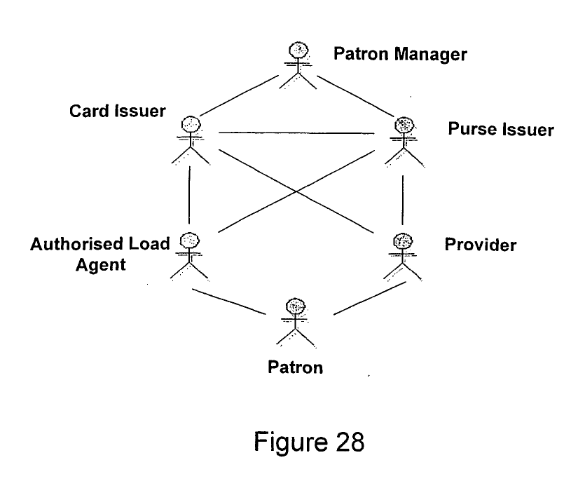

The interaction between the various actors depends on the configuration of the Patron Management system at deployment. However, the key actors and the possible interactions can be seen in FIG. 28. In addition to these interactions the Patron may contact the holder of the main patron details directly to maintain personal details.

Patron Management Services

This section describes Patron Management services from a business activity perspective.

Patron Maintenance

Patron Maintenance is responsible for the core patron details such as name, address, D.O.B. and patron ID. A patron can be associated with a patron type. A patron type will typically identify the patron as being a child or old age pensioner; which allows various concession schemes to identify certain patrons as eligible for a concession fare. An authorised participant may update a patron's record. However, where a patron holds a personalised card the card may need to be present to update the details stored on the card. Otherwise details stored at the back end will be out of synchronisation with the details stored on the card itself. Business services provided within Patron Maintenance include:

(i) creating patron types;

(ii) creating patron records;

(iii) reading patron records;

(iv) updating patron records;

(v) persisting card stored details to a back end data store;

(vi) persisting non-card details to a back end data store.

Refund Maintenance

When either a card or purse refund transaction is generated it creates a refund history record for a patron. A refund transaction can be of the following types:

(a) refund transaction

(b) delayed refund transaction

(c) card retention voucher transaction.

Either Purse Management or Card Management produces the transactions at the front end. Refund management business services provided within Refund Maintenance include:

(a) logging card refunds against a patron record;

(b) logging purse refunds against a patron record;

(c) querying the refund history of a patron.

Patron Bad Debt Maintenance

Bad debt occurs when an autoload to a purse fails and the purse has already been credited. The system tracks how a bad debt is progressing to the point where it is settled because it is possible that a purse autoload facility is serviced by a financial institution account belonging to a patron who does not hold a card. For example, a father may provide autoloads for his children but not operate a card himself. When an autoload fails and a financial institution notifies the system of the failure, a bad debt history is created. The history will include (at least) the patron ID, financial institution account holder details and the amount of the debt to be settled. When the patron or account holder attempts to settle the bad debt at an authorised load agent the load agent will be able to search the system and recall all the bad debts associated with that patron or account holder. The patron will not need to know their patron ID or the purse IDs they are responsible for because the system stores all the personal details for the patron as well as which purses they have an autoload relationship with. In practice the load agent could search on name and address or on a financial institution account number or name. Business services provided within bad debt maintenance include:

(i) creating patron records for non-cardholders where they are responsible for an autoload facility;

(ii) updating patron records for cardholders where they are responsible for an autoload financial institution facility;

(iii) marking a bad debt against a patron responsible for the debt when an autoload fails;

(iv) marking the partial settlement of a bad debt;

(v) marking the full settlement of a bad debt;

(vi) blocking and unblocking purses.

Autoload Management

Autoload Management consists of the back office functionality required to support the autoload facility on the purse. Business services provided within Autoload Management include:

(a) loading autoload facility details from an applicatio;

(b) approving an autoload application;

(c) linking an autoload facility to a purse or purses;

(d) creating a patron record for the applicant.

Process Autoload Application

The process autoload application service processes a request for the autoload application to be enabled on a purse. When an autoload application is processed the system checks to see whether the financial institution account holder has an existing autoload facility. If no matching account details are found then a new financial institution account record is created for the account holder. The financial institution account record includes the account number, account name and the purse ID (if known at this stage). If the account holder is not an existing patron within the system a new patron record is created and a patron unique reference is returned. The purse account manager submits the application to the financial institution nominated by the patron in the autoload application (if the purse in the application has not been hotlisted).

Process Autoload Approval

When the purse account manager receives approval from a financial institution in the form of a service agreement, then the autoload functionality is ready to be enabled. The purse ID and a purse relationship (for a new card) is added to the financial institution account details highlighting that they are responsible for the autoload facility. The status of the facility is set to approved. The patron is notified, including a voucher for presentation when requesting the autoload facility be enabled for the purse. The patron takes the voucher to a load agent where the details are loaded onto the card and the facility enabled.

Purse Management

The Purse Management package administers the use of purses. Purses are physically located on a card. A card can contain multiple purses and each purse will relate to a particular purse. The provision of multiple purse issuers on a single card, requires the Purse Management package to exist separately from Card Management, as it is possible for the card issuer and multiple purse issuers to be independent entities. A patron uses their purse by presenting their card at a device (e.g. ticket machine, vending machine, etc.). A device reads the purse on the smartcard, validates it and provides access to it. Purse Management provides the following services to the purse issuer and the patron:

(i) Managing a facility by which patrons can setup and use a purse to purchase services.

(ii) Monitoring the purse issuer's overall liability by managing information about individual purse accounts. This includes recording a history of all purse usage at a transaction level.

(iii) Autoload facility management. The autoload facility eliminates the need for patrons to manually add value to a purse on their card. The system automatically adds value to a purse on their card when the balance of funds on the purse falls below a predetermined value. The amount added to the purse is subsequently recovered from the patrons bank account. A patron sets the autoload feature up by providing a bank account from which funds added to their purse may be recovered.

Purse Management functionality is found at two distinct locations. Firstly the back office which is the central repository for information about all issued purses. Back office functionality includes:

(a) Processing data about transactions performed by patrons using their purses. This data allows the maintenance of individual purse account balances and transaction histories.

(b) Calculating and reporting on the purse issuer's outstanding liability to service providers by detecting and managing missing transactions.

(c) Recovering autoloaded funds from a bank (or other financial institution).

Secondly the Front office, which is represented by the individual purse on a smart card. Front office functions include:

(a) Capturing transactions performed by a patron such as setting up a purse, buying a transit ticket, adding value to a purse, and requesting a refund on the purse.

(b) Capturing autoload transactions that automatically add value to a purse.

(c) Maintaining purse information (such as the owner and the current balances) that is stored on a patron's smart card.

Consistency is maintained between the information recorded about a purse on the patron's smart card and the information recorded about a purse in the central repository. As a patron may only use their purse by presenting their card at a device, the use cases defined for the Purse Management package that cover front office activity are all abstract use cases that are ‘included’ by Card management use cases. A Publish-Subscribe Subsystem is used to transfer data between the front office (device) and back office (central repository). The most commonly transferred data is:

(a) Data about transactions performed by a patron using their card at a device. This data is transferred from the front office (device) to the back office (central repository).

(b) Information about hotlisted purses. This data is transferred from the back office (central repository) to the front office (device).

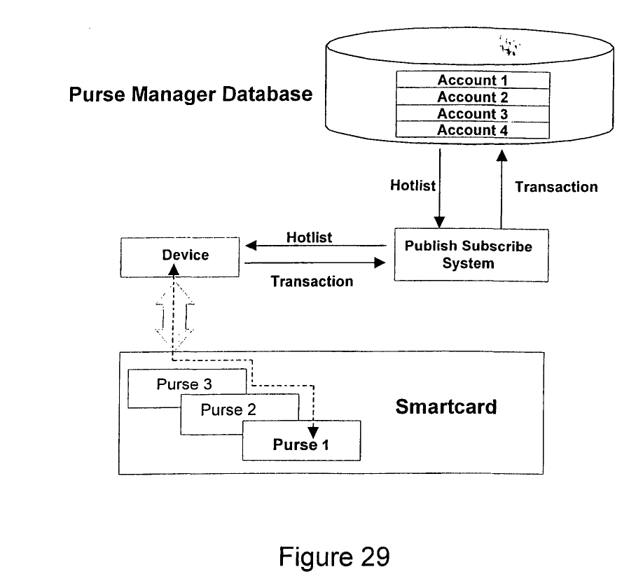

FIG. 29 gives an overview of the role of the Purse Management package within MASS. The Purse Management package includes the following functional units:

(a) Purse Management Core—contains the back office functionality.

(b) Purse Facility Management—contains the front office functionality.

(c) Autoload Facility Management.—contains the front office functionality for the autoload facility. This includes automatically generating the add value transaction when the patron uses their purse at a device.

(d) Autoload Management—contains the back office functionality for the autoload facility.

This includes processing autoload applications from patrons and recovering autoload finds from a bank. Table 17 shows the use cases identified in Purse Management.

TABLE 17
Purse Management Use Cases

Title
Reconcile with Financial Institution
Manage Fund Limit
Write-Off Purse Balances
Recreate Missing Transactions
Write-Off Missing Transactions
Process Purse Transactions at Back Office
Process Missing Transactions
Add Value to Purse at Device
Add Purse to Card
Maintain Purse Details on Card
Delete Purse on Card
Enable Purse at Device
Enquire Purse Details from Back Office
Validate Purse Details on Card
Block Purse on Card
Unblock Purse on Card
Refund Purse at Device
Deduct Value from Purse at Device
Process Blocked Purse on Card
Maintain Autoload Facility on Purse at Device
Autoload Purse at Device
Recover Autoload Funds from Financial Institution

Purse Management Core

All Purse Management Core functionality is back-office processing by the purse account manager. This primarily involves:

(a) Processing data about transactions performed by patrons using their purse. The data allows the maintenance of individual purse account balances and transaction histories.

(b) Calculating and reporting on the purse issuer's outstanding liability to service providers by detecting and managing missing transactions.

Process Purse Transactions

Patrons perform transactions with their purse by using their smartcard (that holds their purse) at a device. For example fare purchase, add value, and refund purse. In some circumstances (such as for a purse refund) patron device usage may be under the supervision of a load agent. Some transactions are performed automatically at a device, such as autoload—where value is added to the purse automatically, and block purse—if the purse is hotlisted with the required action set to ‘block purse’. When a transaction is performed the effect on the purse is recorded on the patron's smart card. The details of the transaction must be made available to the purse account manager to process. Processing transaction data involves one or more of the following:

(i) Update the purse account manager's record of the patron's purse so it is consistent with the record on the smart card. This may involve such functions as increasing or reducing the balance of the purse for the transaction amount, or recording that the purse is now blocked.

(ii) Reimburse a participant with the transaction amount. This is for the case where the patron performed a transaction involving purchasing a good or service with their purse.

(iii) Reconcile amounts paid to the purse account manager with amounts due. This is for the case where the patron performed a transaction involving adding value to their purse.

(iv) claiming funds from a bank, for autoload transactions.

(v) Removing a purse from a hotlist. This for the case where a purse is hotlisted and the transaction data indicate that the appropriate action has now been taken. This will happen because the patron has attempted to perform a transaction using the purse at a device and the device has found the purse on a hotlist and has taken the appropriate action.

Process Missing Transactions

The process is initiated when the purse account manager end-of-day has been notified and will manage missing transaction information. Purse transactions are transactions initiated by a patron that affect a purse. Purse transactions are sent to and processed by the purse account manager to update the patron purse. A missing transaction is a purse transaction that should have been received and processed by the purse account manager. The purse account manager maintains information about missing transactions and acts upon the information to correct the persisted transaction and purse data, and enables the purse issuer's liability to be monitored. The purse account manager must process missing transaction information on a daily basis because the set of missing transactions can change every day as a result of processing transactions.

Purse Facility Management

All Purse Facility Management functionality covers ‘front-office’ type processing by the Purse Account Manager. This primarily involves capturing transactions performed by patron using a purse such as setting up a purse, buying a transit ticket, adding value to a purse, requesting a refund on the purse etc. As part of this, Purse Facility Management functionality is responsible for maintaining purse information (such as the owner and the current balances) that is stored on a Patron's card. Purse Facility Management provides the following functionality executed by the use cases.

Add Value to Purse

Patrons can add value to a purse on their card by using an add value device. Value can be added by way of cash, debit card, credit card or purse funds transfer. Before any value is added to a purse, the purse is checked to confirm that it is not blocked and has not exceeded the revaluation date. A transaction is created containing the details of the add value performed by the patron, to transmit to the Back Office.

Deduct Value from Purse

When a patron purchases goods or services from a service provider, the funds are deducted from the purse at the device. The process determines if the purse is valid (ie. not hotlisted, blocked or short of funds) before deducting the value from the purse. If the deduct value has reduced the balance below the autoload threshold, then an autoload of the purse is triggered. A deduct value transaction is created, to transmit to the Back Office.

Add Purse

This process is provided to dynamically add purses to a card. The Add Purse process or facility adds the purse at the device and then sends a transaction to the Back Office to indicate that a new purse has been added, along with the details. The Back Office creates a master record for the identified purse. The add purse process can include the enabling of the card, if the purse is added when the patron is present, however, a batch of purses could be added to cards, with the blocking status set to blocked, then the card can be enabled when sold.

Maintain Purse Details

The Maintain Purse Details process provides the facility to read purse details from a card and to update specified parameters on the card. An update purse transaction is created which indicates that the purse master record should be changed to reflect any changes.

Delete Purse

The Delete Purse function deletes the identified purse from the card and frees up memory space to add other purses. Any value remaining on the purse is then be refunded to the patron and the master record for the purse at the Back Office marked as the purse has been deleted.

Enquire Purse Details

Provides the facilities for accessing the Purse Account Manager's database from a remote location, such as a device with the facility enabled. The enquiries that can be performed include:

(i) purse details—displays all purse details, excluding the purse balances;

(ii) purse balances—displays the remaining value on the purse;

(iii) purse refund—determines if the purse is refundable;

(iv) purse transaction history—returns the last n transactions on the purse.

Validate Purse Details

Provides the facility for processes to obtain the status of a purse. The validation which can be performed on a purse includes:

(i) blocking status—returns the current blocking status, with a reason if blocked;

(ii) hotlists—determines if purse is currently hotlisted;

(iii) usage data—checks initialisation date has been reached, expiry date has not expired or the purse has not been used within a configurable ‘non-use’ period (i.e. the number of days of non-use before the purse is regarded as expired);

(iv) revaluation period expired—checks to see if period expired;

(v) within value limits—checks to see if remaining value is above or below configured limits.

Purse Blocking

On presentation of a purse, the purse can be blocked and cannot be used for any future transactions until the purse is unblocked. The patron is able to address the blocking status by approaching a device and querying the status. The following processes can be instigated, dependent on the blocking reason for the purse:

(a) Unblock purse and settle bad debt—outstanding autoload bad debt is cleared before the purse is unblocked.

(b) Unblock purse used at hotlisted Add Value Machine—if the purse has added value added at a stolen machine, then the purse value is corrected before being unblocked.

Purse Refunds

Checks to see if a purse is valid and is refundable, and then determines if an immediate, delayed or voucher refund is applicable to the particular purse. An immediate refund can be initiated when the amount to be received/paid has been agreed on. A delayed refund may occur because:

(i) The refund value is above immediate refund limit.

(ii) The patron disagrees with the refund amount.

(iii) The purse issuer does not permit immediate refunds.

(iv) The purse remaining balance and the purse ledger balance differ.

(v) The purse has autoload enabled.

Autoload Facility Management

Autoload Facility Management functionality contains the front office functionality for the autoload facility. This includes automatically generating the add value transaction when the patron uses their purse at a device.

Maintain Autoload Facility

The maintain autoload facility is initiated at a device, when the patron's smartcard can be enabled, updated or disabled. The processes performed by the maintenance function include:

(i) enable autoload—enables autoload facility and sets the value to be added;

(ii) update autoload value—checks that the autoload facility is enabled and then sets the new autoload value;

(iii) disable autoload—changes the autoload status to disabled;

(iv) suspend autoload—suspension can be temporary, for a specified time interval.

Autoload Purse

Automatically adds value to a purse, when a deduct value transaction causes the purse value to fall below a pre-determined limit. The value added to the purse can only be monetary, but other forms of autoload can be introduced at later stages, for example multi-trips. Checks the previous autoload to determine if the next autoload is within a configured minimum autoload interval, i.e. the autoloads have been too frequent (these are limits which can be applied by the purse issuer or the patron).

Autoload Management

Autoload Management consists of the back office functionality required to support the autoload facility on the purse, and includes a function to Recover Autoload Funds from a Bank. The function operates when a purse issuer needs to recover autoload funds from a bank. The process starts on a daily basis after a purse issuer's end of day processing. Patron bank and account number details are retrieved from the central repository for each autoload transaction processed. A transaction file is created for each bank to an agreed format at a pre-determined time within each settlement day. The generated transaction file is sent to the banks in the agreed format.

Purse Management Terminology

A purse account is the purse account manager's record of a individual patron's purse. The details for each purse account include:

(a) Purse identification information. This will include a unique ID for the purse and may include patron information such as banking details.

(b) The current balances on the purse: remaining value, deposits and bad debts.

(c) A transaction history of transactions performed affecting the purse.

A purse transaction is the effect on a purse as a consequence of a transaction by a patron using their smart card.

A missing transaction is a record of a purse transaction whose effect has been recorded against the purse on the patron's-card but whose associated transaction has not yet been received and processed by the Purse Account Manager. All purse transactions have a purse transaction sequence number that is recorded against the purse. Purse transaction sequence numbers are sequential within a purse. A gap in purse transaction sequence numbers indicates one or more missing purse transactions. A missing transaction has a date. The date is an estimate of the Purse Account Manager's business day that the associated transaction should have arrived for processing.

A late transaction is a financial transaction that has arrived for processing and whose associated purse transaction is recorded as missing. A late financial transaction's associated purse transaction is no longer marked as missing.

An expired transaction is a late transaction that turns up for processing a (configurable) number of days after its associated missing transaction date. No physical reimbursement to the acquirer/service provider will be made for the amount of the transaction because it has been missing for too long.

A Fund Limit is associated with a Purse Account Manager's business day. The fund limit for a day is the net value of:

(a) claims that may be made against the purse issuer (e.g. from service providers), and

(b) claims that the purse issuer may make (e.g. from load agents),

For transactions that should have been processed for that day but have not yet turned up for processing. These missing transactions may turn up at a later date. Therefore, the fund limit represents the amount of funds that the purse account manager must ‘set aside’ to cover these claims. The system maintains n fund limits, one each for n contiguous purse account manager business days.

Fund Limit Maintenance Days (FLMD) is the number of fund limits maintained—typically 30.

Transaction Expiry Days (TED) is the number of days that a missing transaction may be recorded as missing before its associated transaction will be considered expired if it turns up for processing.

TED>FLMD

A recovered transaction is a financial transaction that has been recreated by the purse account manager because the original financial transaction has not turned up for processing. Only add value type financial transactions are recovered. The purse transaction associated with the original financial transaction has been recorded as a missing transaction. The recovered transaction is created a (configurable) number of days after the missing transaction date. Once a financial transaction is recovered its associated purse transaction is no longer marked as missing.

Recovered Transaction Types is the set of financial transaction types that may be recovered. The set will typically comprise Add Value and Autoload.

Transaction Recovery Days (TRD) is the number of days that a missing transaction whose associated transaction type is in the set of Recovered Transaction Types may be recorded as missing before the associated transaction is recovered.

TRD<FLMD

Settled claim Service providers will claim against the purse account manager for amounts considered owing but for which no reimbursement has been made. A claim relates to financial transactions for a specific day. The financial transaction's associated purse transactions will have been recorded as missing transactions by the purse account manager. Typically, a central claim management authority will process all claims. Claims are approved or otherwise based on fund limit information provided by purse managers. Claims approved by the claim management authority are referred to as settled claims. The purse issuer is liable to pay the claimed amount.

Security Management

The intention of the security use case package is to provide the following features of the security framework:

(a) Access control and user management;

(b) Cryptographic services: algorithms;

(c) Cryptographic services: key management;

(d) Data Security Module (DSM) administration.

The security package is divided into a set of sub-packages. Each sub-package is a grouping of use cases with related security functionality and are listed below:

(i) Security Toolbox

(ii) Link

(iii) User Management

(iv) Key Management

(v) Certificate Management

(vi) Configuration Data Services

(vii) Data Security Module Management

Each sub-package is described in detail in the following sections. The Security Management use cases are listed in Table 18 below.

TABLE 18
Security Management Use Cases

Title
Maintain Security Key
Distribute Security Key
Log-On To System
Maintain User Permissions
Log-Off from System
Get User ID
Verify User ID
Maintain User Account
Generate Security Key Certificate
Verify Security Key Certificate
Revoke Security Key Certificate
Archive Security Key
Restore Security Key
Verify User Permissions
Register with Certification Authority
Initialise Data Security Module
Maintain Security Key Table

General Services Sub-Package

This sub-package contains use cases that provide the general purpose cryptographic algorithms. It also provides a number of supporting algorithms necessary to support the other sub-packages. All of the other security sub-packages are dependent on the functionality provided by this package in order to provide their own services. However, any package within MASS may also directly include the use cases provided by this sub-package. This package provides the following functionality:

(i) Data encryption and decryption;

(ii) Message digest generation;

(iii) Digital signature generation and verification;

(iv) Message Authentication Code generation and verification;

Each use case contained in this sub-package is described in detail in the following sections.

Data Encryption and Decryption

The purpose of data encryption is to limit the observation of data messages within the system to a set of trusted parties. The act of encryption transforms a clear-text message into a corresponding cipher-text message. The act of decryption performs the reverse, i.e. transforms a cipher-text message into its associated clear-text (or plain-text) message. Any observer who wishes to decrypt a cipher-text message must have the specific secret key to do so. Data encryption alone does not provide any level of assuredness of the integrity or authenticity of a data message. An adversary can tamper with a cipher-text message to produce an associated unknown, but potentially damaging, plain-text message. The proper use of message digests, message authentication codes, or digital signatures are used in conjunction with encryption if data integrity and authenticity is required in addition to privacy. Data encryption also does not provide any protection against an adversarial replay attack, which involves an adversary capturing a cipher-text message and falsely submitting the message at a later date. MASS uses techniques such as time stamps and sequence numbers to limit the timeliness of messages in the system and prevent replay attack.

Message Digest Generation

A Message Digest is a fixed-length hash of an arbitrary message generated by applying a collision resistant one-way function. Message Digests have the following properties:

(a) It is easy to generate the message digest for any given message.

(b) It is computationally infeasible to generate a message that matches any given message digest.

(c) For any given message it is computationally infeasible to find another message such that both messages share the same message digest.

Message digests are used to generate message authentication codes and digital signatures.

Digital Signature Generation and Verification

The concept of a digital signature provides a level of assuredness of the integrity and the authenticity of an arbitrary data message. Data integrity implies that the message has not been modified since creation. Data authenticity implies that the origin, or creator, of the message can be ascertained. The use of digital signatures limits the modification and injection of data messages within the system. Digital signatures also have a validity period associated with them that limits the replay of captured data messages outside of these bounds. Digital signatures in addition prevents the repudiation (denial of creation) of a data message created by an entity within the system. Digital signatures are implemented in MASS by the use of asymmetric cryptography. The creator of the digital signature signs the data message using the private key of an asymmetric key pair. The private key is created by and known only to the signer. The verifier of a digital signature uses the public key component of an asymmetric key pair to ensure that the attributed author did actually create the message. In order for a verifier to have confidence in a digital signature, the public key component is distributed in a trusted manner. The sub-package Certificate Management includes associated use cases. The verifier does not need to ensure the privacy of the public key component within the system, but ensures its integrity. Digital signatures are relatively slow to create and are large in size compared to Message Authentication Codes.

Message Authentication Code Generation and Verification

A Message Authentication Code (MAC) is used to provide a level of assuredness associated with the integrity of an arbitrary date message. A MAC is generated by symmetrically encrypting the message digest for any given data message. Only the holders of the symmetric key may generate or verify a MAC for a particular message. Failure to verify the MAC implies that the message has been tampered with in transit.

Link Authentication Sub-Package

This sub-package provides a cryptographic algorithm to support mutual authentication. Mutual authentication is required to establish trusted communication between two distributed objects on an authenticated link. The authentication is based on the proof of knowledge of a shared secret. As part of the authentication process, session keys are generated which can subsequently be used to ensure the integrity, authenticity, and privacy of all subsequent messages during the lifetime of the session.

User Management Sub-Package

This sub-package contains use cases that provide support for access control and user management. This package provides the following functionality:

(i) user account management;

(ii) user log-on and log-off;

(iii) user identification;

(iv) user permission management.

User management is associated with a security domain and must cater for a heterogeneous, distributed architecture, rather than a simple localised model. Each use case contained in this sub-package is described in detail in the following sections.

User Account Management

The security framework requires the ability to create, read, update, and delete user accounts in the system. This includes defining the times that the user may access the system.

User Log-On And Log-Off

The security framework requires all users to log on to the system prior to accessing any service. The log-on process enables the user to be authenticated and identified by the system. This allows the system to determine whether to grant requests for services based on the permissions granted to the user. It also allows the system to identify the user in all audit trail log entries. The log-off process either allows a user to gracefully log-off from the system, or forcibly logs-off a user who no longer has access rights to the system.

User Identification

The security framework needs to be able to determine the user associated with all requests for system services. The system then accesses the appropriate permission list to determine whether to grant to request. Criteria are set for access to the system such as whether passwords are required to be entered or other id data needs to be validated.

User Permission Management

The security framework maintains a permission list associated with every system object. A permission list is used to determine what requests for services can be granted to a particular user of the system.

Key Management Sub-Package

This sub-package contains use cases that provide support for the key management facility, except for certificate management. This package provides the following functionality:

(i) key generation;

(ii) key distribution;

(iii) key storage and access;

(iv) key revocation;

(v) key archival and restoration.

Each use case contained in this sub-package is described in detail in the following sections.

Key Generation

Cryptographic keys in the system are managed via sets referred to as tables. The security framework is able to securely create, read, update, and delete security keys tables for all identified key types in the system. This includes both symmetric and asymmetric key types. The security framework currently supports the following key types:

(i) CSC card keys;

(ii) CSC reader-writer keys;

(iii) link authentication keys.

Key Distribution

The security framework is able to distribute all security keys in the system in a secure manner that does not compromise their privacy. Key tables are considered as MASS Configuration Data that has the special requirement of needing to be encrypted during transport.

Key Storage and Access

The security framework is able to store all security keys in the system in a secure manner that does not compromise their privacy. In addition, the framework ensures that only authorised users have access to the services associated with each key in the system.

Key Revocation

The security framework is able to revoke any compromised key in the system. The revocation process is achieved via the distribution of new key tables that explicitly to do not allow compromised keys to be used in the system. The Certificate Management Sub-Package handles revocation of public key certificates.

Key Archival and Restoration

The security framework is able to securely archive and restore all security master keys for the purpose of disaster recovery. Key Verification Codes are used during the restoration process to verify that the content keys have not been corrupted during distribution, storage, or manual entry. Failure to verify this implies that the key has been corrupted.

Certificate Management Sub-Package

This sub-package contains use cases that provide support to manage security key certificates within the system. This package provides the following functionality:

(a) certification authority registration;

(b) certificate generation and verification;

(c) certificate revocation.

Security key certificates are required to ensure that public key components of an asymmetric key pair are distributed and used in a trusted manner. The trusted distribution of public keys between two Key Managers in the system uses a mutually trusted third party known as a Certification Authority. The Certification Authority produces a security key certificate for each public key that is submitted to it from a known Key Manager. Any other Key Manager in the system can then use this certificate to prove that the public key can be trusted to belong to its attributed owner. Each use case contained in this sub-package is described in detail in the following sections.

Certification Authority Registration

A system Key Manager registers with a Certification Authority before the CA generates any certificates on behalf of the Key Manager. This is required to establish a trusted mechanism for the submission of public key components from the Key Manager for certification by the CA.

Certificate Generation and Verification

When a Key Manager Generates a new asymmetric key pair and wishes to distribute the public-key component, the public key is submitted to the CA to have an associated certificate generated. When another Key Manager needs to verify a digital signature using the public-key component, the public-key is first be verified to be authentic by verification against its certificate.

Certificate Revocation

In the advent that the private-key component of an asymmetric key pair has become compromised, the associated public-key is revoked from the system. If this is not done then malicious data can be introduced into the system. The CA revokes the public-key by the CA creating a new entry, and subsequently distributing, its Certificate Revocation List.

Configuration Data Services Sub-Package

This sub-package contains use cases that provide support to securely distribute Configuration Data (CD) within a MASS system. This sub-package provides functionality for certification and verification of configuration data. Each use case in this sub-package is described below.

Certification and Verification of Configuration Data

The MASS system securely distributes CD throughout the system. Certification is the process of ensuring the correctness of the configuration data before generating an associated digital signature. Verification is the process of ensuring on receiving new Configuration Data, that the CD item matches its associated digital signature.

Data Security Module Management

This sub-package contains use cases that provide support to manage Data Security Modules (DSM) in the system. A DSM is a system component that provides secure storage of cryptographic keys and all associated services based on those keys. A DSM should be a physical tamper resistant module, but may be provided as a software component when a project is willing to accept the reduced security.

This package provides the following functionality:

(a) DSM initialisation;

(b) DSM hotlist management.

Each use case contained in this sub-package is described below.

DSM Initialisation

The security framework ensures that a DSM module cannot be initialised and subsequently used by a system adversary.

DSM Hotlist Management

The system is at risk from a DSM being stolen and the adversary may additionally obtain the initialisation password. The security framework prevents data manipulated by the stolen DSM from being able to be accepted in the system. This is achieved by tagging all manipulated data with the unique identifier of the DSM. Whenever a subsystem receives data from another DSM it can ensure that the data was not produced by a hotlisted DSM.

Service Management

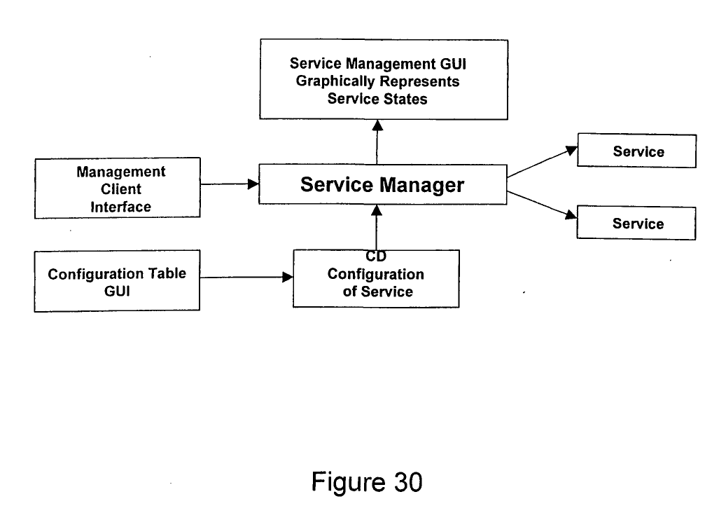

Service Management, as shown in FIG. 30, performs the role of managing software services on a MASS processor. A software service is an execution unit that performs a service role for the MASS processor. This is akin to Unix daemons and Windows NT services. Services provide some form of information (data), capability or support to the MASS processor. The broad categories of support roles that MASS Services perform are:

(a) Business Support Services (e.g. Transaction processing);

(b) Infrastructure Support Services (e.g. Communications, Security, Network Management).

Typically services:

(a) run in a separate process;

(b) are started at boot processor boot time and terminated at system shutdown;

(c) their lifetime is not bound to their GUI representation session.

But services can also exist as a thread set in a process or perform a short term, transitory task and then terminate. A GUI based application is not considered a service, as its lifetime is bound to its GUI session. Services are either started:

(a) at processor boot time;

(b) on request by a GUI;

A Service is able to operate in a number of basic execution states:

(a) Service Running (processing);

(b) Service Thread Suspended;

A service may be required to initiate itself at start-up time but not process until signalled to do so. A service will be instructed to change to different execution states (as detailed above). This mechanism of instructing is co-operative, the service is requested to perform the state changes. There is only one possible instance where the service may be forced to change state and that is on a service stop request where the processor is being shutdown. Service dependencies define how services interact and depend on each other.

TABLE 20
Service Management Use Cases

Title
Stop a Service
Maintain Application Monitoring Configuration Data
Suspend_Resume Services
Monitor a Service
Start Services
Stop Services
Start a Service
Suspend_Resume a Service

Roles and Responsibilities

Service Management:

(i) Performs the actions of starting Services at processor boot time and stoppage at shutdown.

(ii) Determines Service characteristics from a central store.

(iii) Monitors viability of Services and restarts Services on indications of failure.

(iv) Presents the Services graphically for an administrator to manually manage Services.

(v) Provides general access mechanisms for requesting the starting, stopping suspending and resuming of Services.

(vi) Logs Notifications of Service actions and errors.

Service Management separates the responsibilities into two role entities:

(a) The Service Manager, the main control and management agency.

(b) The MService object, is the effector of the Service Managers requests in the Service Process.

The sections below describe the roles of these role entities.

The Service Manager

The Service Manager is in charge of managing Services on its Processor. This role entails:

(i) starting auto-startable services at processor boot time;

(ii) providing status control information to system administrators via a GUI;

(iii) providing interfaces for clients to manage Services;

(iv) stopping services at shutdown time;

(v) logging of significant events.

Services configuration describes:

(a) service execution details;

(b) service handling information: how to handle situations that the service may encounter, such as failure occurrences and heartbeat misses;

(c) service start orders.

The Service is also expected to broadcast regular heartbeats to the Service Agent, to indicate the Services viability.

Security Compliance

Client requests to Service Manager are authenticated.

Audit Trails

The Service Manager generates notification events for Service state changes effected.

Exception Reporting

Both the Service Manager and Service Agent log exceptional events.

### Management Infrastructure

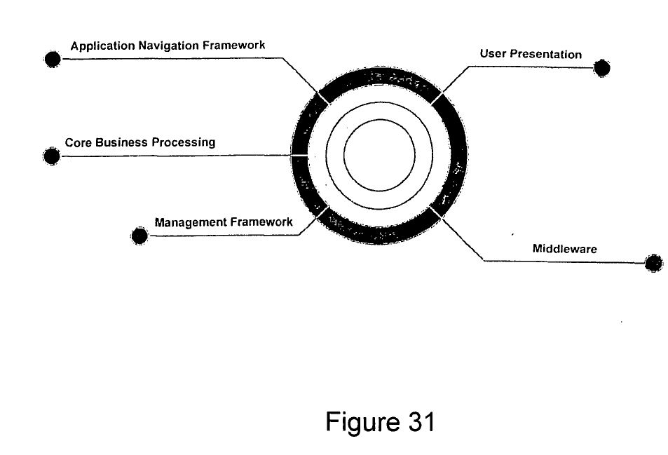

The Business Infrastructure layer is serviced by the Management Infrastructure layer, which, as shown in FIGS. 5 and 31, includes the following packages:

(i) Application Navigation Framework

(ii) Core Business Processing

(iii) Management Framework

(iv) Middleware

(v) User Presentation

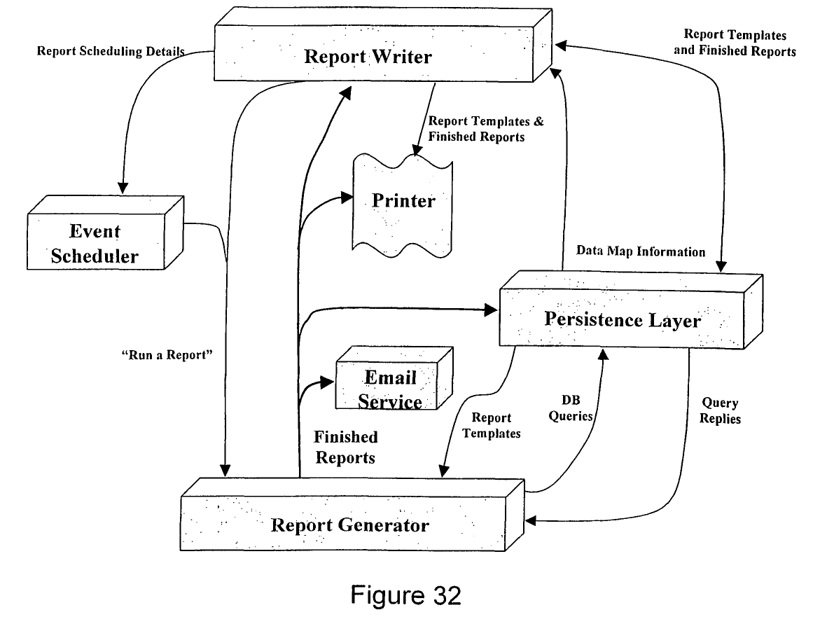

A Report Generator and Writer, as shown in FIG. 32, may also be included.

Application Navigation Framework

The application navigation framework (ANF) is a toolkit for graphical user application development within a MASS based system. This section describes specific elements of this framework, the generic applications relying on this framework and a number of GUI components which have been developed to support the generic components as well as other applications built by project teams.

ANF ensures only authenticated users may access the system. If no current user is logged on ANF will present the user with a login dialog for authentication. ANF also provides a facility for the user to log out. Application profiles are CD based and require the use of the Configuration Data sub-system to store the following:

(i) the Id of the application (unique key);

(ii) name of application (displayable);

(iii) iconic representation (32×32) (displayable);

(iv) ancestor application (displayable) (blank=top-level node in tree+parent nodes are lazily created);

(v) class name (canonical form) e.g. mass.base.core.MTime.class (form suitable for direct reflection);

(vi) Inactivity timeout period (minimum resolution secs).

ANF uses the command framework to launch applications. The system provides the following user interface components:

(i) parent ANF Frame to provide a UI context for managing applications (including basic menu configured using internationalisation package);

(ii) login window for current day (keyed on day name ability to get a MTimeRange specifying the “window” of time available for a session on a particular day.);

(iii) views;

(iv) tree view;

(v) button bar view supplementary clipboard support.

Design Features

A user's username/password is captured via a login dialog. The Authentication and Authorisation Service provides a generic security framework within which to perform this capturing. The framework allows the developer to use ‘pluggable’ object callbacks to request and capture the necessary information to authenticate a user (e.g. fingerprint). Management of the inactivity timeout is done via a separate thread monitoring mouse/key input within the top-level ANF frame (since all mouse events logically delegate through it) and counter resetting. The Framework establishes the initial application context by presenting actions for applications which the user has the permission to run. That is, if the user has the permission to run an application, the application will exist in the tree view, button bar and other UI controls from which the application can be run. The ANF's context is the ancestor for all other application contexts and will always be in focus (unlike individual applications that must handle changes in focus). Each of the views (tree+button bar) back on to the same model of objects utilising the inherent Model-View-Controller aspects of the ANF.

Core Business Processing

Core Business Processing provides services to the Business Infrastructure packages. These services include, but are not limited to:

(i) transaction handling

(ii) transaction validation

(iii) transaction distribution

(iv) transaction history maintenance

(v) action list management

(vi) card handling

(vii) card adapter

All financial participants in a MASS based system require the services provided by the transaction handling service. The following list provides a description of the responsibility of each of the three main sub-packages in the Core Business Processing package:

(a) Transaction Handling. Provides the services that are required to fully process a transaction on behalf of one or more Business Infrastructure packages.

(b) Action List Handling. Provides the facilities for maintaining and distributing action lists.

(c) Card Handling. Provides a middle office device with the ability to rollback any changes or transactions made during the course of a session with the patron, and provides an interface to enable reading and writing to a physical card.

The following section describes the services in each package in more detail.

Transaction Handling

The transaction handling package provides a framework for the processing of transactions received via the Publish and Subscribe System.

The transaction handler framework can be extended to process any type of transaction. This includes any type of validation, any type of processing, and the persistence of any other type of object which needs to be persisted as part of processing the transaction. In addition, this is achieved by without the transaction handling framework having any knowledge of the action objects (transactions or otherwise), which are being processed.

Transaction Handling is implemented by a Transaction Handler subsystem that is ultimately responsible for all aspects of handling a transaction.

The transaction handler has two primary functions:

(a) To start up and oversee other processes involved in the processing of a transaction (transaction unpacker, transaction processor, and transaction packer).

(b) To provide an interface for external subsystems needing to affect the transaction processing, eg. stop processing for a particular participant.

Transactions are moved from node to node using PSS. In order to minimise the overhead involved in transmitting transactions, each transaction destined for the same PSS topic is packed into an envelope so a group of transactions can be transmitted in a single batch.

In order to handle a transaction, the following steps are performed (the subsystem responsible for performing the action is shown in brackets):

1) Retrieve blocks of transactions from PSS (Transaction Unpacking).

2) Unpack transactions and pass each one to a transaction router (Transaction Unpacking).

3) Route the transaction to the correct transaction processor (Transaction Routing)

4) Validate the transaction (Transaction Validation).

5) Ensure the transaction is not a duplicate (Range Management).

6) Perform role specific (purse, card) processing (Role Management), for example a Clearing Role, which is responsible for transaction Summarisation, Forwarding and Packing.

The transaction handler receives a request from a participant to perform transaction processing on its behalf. This request includes the participant's identification and a PSS topic name. The handler searches the list of existing unpackers to determine if one is registered on the PSS topic. If not, it creates a new unpacker, registering it on the new PSS topic. The handler then instructs the unpacker to start processing for the participant.

The transaction handler may receive a request from a participant to suspend business processing on its behalf. In this case, the transaction handler passes the request to all the transaction unpackers.

The Transaction Handler is a MASS “MService” which essentially wakes up and waits for ServiceEvents which trigger the following operations:

(i) startBusinessProcessing

(ii) suspendBusinessProcessing

(iii) stopBusinessProcessing

(iv) resumeBusinessProcessing

(v) registerRole

(vi) unregisterRole

(vii) registerValidationRules

(viii) unregisterValidationRules

(ix) registerForwardingRules

(x) unregisterForwardingRules

The Transaction Handler is passed ServiceEvents which contain the above types of commands. The ServiceEvents are decoded by the Service Management component of the Transaction Handler—which then advises the Transaction Handler via callback.

(i) Transaction Unpacking. Receives blocks of transactions, unpacks them, and passes the transactions to the appropriate transaction router.

(ii) Transaction Routing. Receives a transaction and determines which transaction processor should process it.

(iii) Transaction Processing. Provides a coordination role for the processing of the transaction by other subsystems.

(iv) Transaction Cache. Caches the changes that are to be made to database objects so all changes are made in one atomic action.

(v) Transaction Validation. Uses configurable rules to determine if a transaction is valid or not.

(vi) Range Manager. Determines if a transaction is a duplicate or not.

(vii) Role Management. Performs role based processing, such as purse or card.

(viii) Transaction Forwarding. Uses configurable rules to determine if a transaction needs to be forwarded to another participant and masks out any sensitive information.

(ix) Transaction Packing. Takes transactions to be forwarded and batches them together in order to save network bandwidth.

There is one Transaction Handler per node. Each Transaction Handler consists of one or more Transaction Unpackers and one Transaction Packer. Each Transaction Unpacker consists of one or more Transaction Routers dedicated to a particular participant. There can be one or more Transaction Processors per Transaction Handler; all Transaction Processors are shared amongst all Transaction Routers on all Transaction Unpackers. Each Transaction Processor has zero or more Role Transaction Processors, including a Transaction Forwarder.

When the Transaction Handler receives a startBusinessProcessing service event, it creates an Unpacker which opens a Gateway to the topic specified in the call. startBusinessProcessing can be called many times, to instantiate multiple Unpackers. The TransactionHandler holds unpackers for each topic. The Transaction Handler constructs as many TransactionProcessors as configured in the CD delivered to the TransactionHandler.

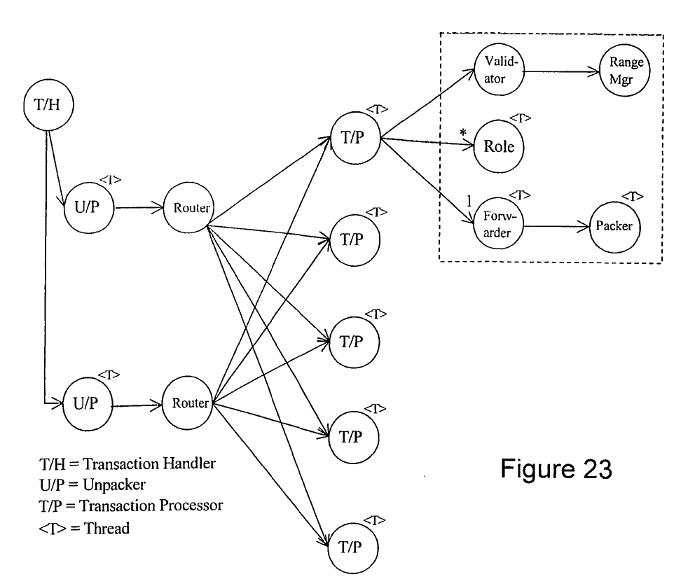

Many of the components run in different threads, as shown in FIG. 23. This is intended to improve performance by allowing processing to occur in parallel. Queues are used to de-couple components running in different threads which need to pass transactions to each other. The queue is implemented as a template with two associated counting semaphores controlling the addition and removal of items. The basic mechanism involves the sender blocking on the input semaphore if the queue is full and adding an item to the queue when possible, and the receiver running in an endless loop which blocks on the output semaphore until new items appear for further processing.

Transaction Unpacking

The transaction unpacker is responsible for:

(a) Registering with the communications Publish-Subscribe System (PSS) to receive envelopes of transactions on a particular topic.

(b) Receiving envelopes of transactions from PSS, unpacking the transactions from the envelopes, and performing simple validation.

(c) Passing transactions on to the Transaction Router.

The Unpacker is the entry point for every transaction to be processed. It receives a block of transactions in an envelope from PSS. It unpacks each transaction from the envelope, performs some initial validation, calls a translate( ) operation (which can be customised to convert raw “usage-data” into a TransactionRecord), and forwards it to the appropriate router based on the transaction's participant ID.

Unpackers are created as required, and each runs in its own thread, listens on one PSS topic, and is capable of handling transactions for one or more participants. When instructed to start processing transactions for a new participant, the Unpacker is given the participant's identification. As each participant has a dedicated router, it checks to see if a router for this participant has already been created. If not, the Unpacker creates one.

When a request to suspend business processing for a participant is received, the Unpacker checks to verify if the participant has a listed router. If so, it forwards the suspension request to the appropriate router. Otherwise, the request is ignored.

Transaction Routing

This subsystem is responsible for stamping transactions with the participant's business date, and passing them on to the appropriate transaction processor. The specific transaction processor to use is determined by a simple hash algorithm based on the transaction's ID, designed to spread the processing load over multiple threads.

Transactions being passed from the Unpacker to the Router are added to a message queue on the Router thread and held there until read. If processing has been suspended for the participant, Transactions are held in the queue until processing is resumed. The Router ensures that the same transaction processor always processes transactions related to a particular component (purse, card). This eliminates the potential for database clashes when two Transaction Processors attempt to access the same database record.

There is one transaction Router for each participant listening on a particular topic, that has registered with the Transaction Handler. When a request is received to suspend transaction processing, the Router finishes routing the current transaction then stops routing until it receives a request to resume.

Transaction Processing

This subsystem is responsible for the processing of a transaction. Although it does very little processing itself, it is responsible for coordinating the subsystems that perform the processing.

When a new transaction is received for processing, the Transaction Processor:

(i) Informs the transaction cache that a new transaction is commencing,

(ii) Validates the transaction, including duplicate checking,

(iii) Stores the transaction,

(iv) Performs any role based processing, such as purse or card management, and forwarding to another destination, and

(v) Stores any updates made by the roles.

Transaction Processors run in their own threads, and are maintained in a pool handled by the Transaction Processor Factory. The same Transaction Processor must be used when processing transactions from the same component (card, purse). The selection of the appropriate Transaction Processor is determined by the Router, based on the hash algorithm.

The Transaction Processor talks to a Validator (and indirectly to the Range Manager), as shown in FIG. 23. The call to the Validator is synchronous, if the transaction is not validated it is discarded. If Roles have been registered with a Transaction Processor, the Transaction Processor “hands” the transaction over to each Role registered.

A “Clearing” Role is typically registered, which may perform summarisation tasks as well as calling the Forwarder and Packer. All Roles receive the transaction at the same time and operate in parallel.

After receiving a callback triggered when all these components have completed their processing, the Transaction Processor persists the Transaction and its associated Cache.

Transaction Cache

The Transaction Cache is responsible for managing the persistence of a transaction and the associated data produced during processing. The types of updates include:

(a) Missing Transaction Ranges, and

(b) Database objects updated by the role transaction processors.

The transaction cache stores information about required database changes. This subsystem stores the changes until it is confirmed that the transaction has been correctly processed by all subsystems. At this point, all the changes are written to the database in a single atomic operation—that is, either all or no changes are made to the database. This avoids the problems associated with having to roll back changes to a partially updated database before a transaction is rejected by a subsystem.

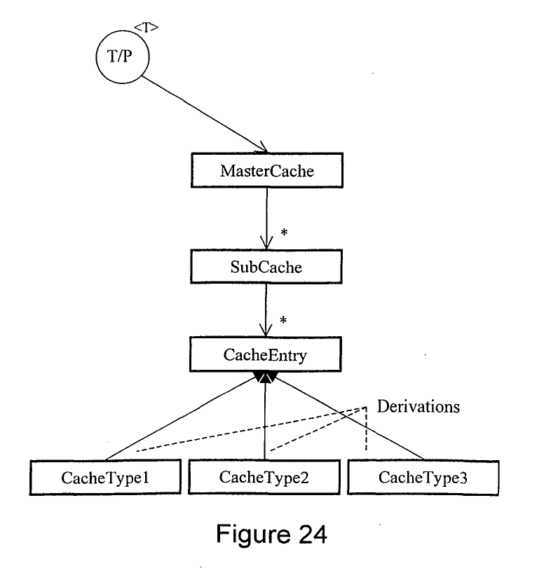

In order to ensure the consistency of transactions within MASS, it is necessary for the transaction to be committed to the database in a synchronous and non-divisible operation. If, for any reason, the transaction cannot be committed, a “roll-back” (undo) the transaction processing is done. In order to retain the details of what “would have been committed”, this information is stored in a cache with CacheEntries specialised for each different section of the transaction. This is illustrated in FIG. 24.

The Cache is created when the Transaction Processor is constructed, and is responsible for processing all of the cache entries and updating its MasterCache. It may or may not persist the transaction to the database, but the Transaction Processor is the process that talks to the database.

When the Transaction Processor is trying to commit a transaction, it goes through the MasterCache and all SubCache entries calling “apply” which all operate on the same IPersistable object. This information is passed in as a parameter to the apply call. If the persistence attempt fails, then an “undo” is called on the MasterCache which trickles through all appropriate SubCache entries to the “undo” operations which undo their work. The sequence of the “undo” calls is reverse to “apply” calls.

Transaction Validation

This subsystem is responsible for validating transactions and raising exceptions when an invalid transaction is detected. Validation of a transaction involves checking the fields of the transaction using configurable rules. If the transaction is valid, the range manager checks that it is not a duplicate—that is, it has not been previously processed.

Range Manager

This subsystem is responsible for rejecting expired or duplicate transactions, and tracking missing transactions. It also supports the persistence and query of missing transaction details upon request from external subsystems.

Each component that can cause transactions to be generated (such as a purse or card) has its own transaction sequence number. This number is incremented each time a transaction is generated. A device that is processing these transactions would normally expect to see the sequence number for a particular component increment each time it receives a transaction from that component. The reasons why this may not occur are:

(a) Transactions may be received in a different order to that in which they were generated (misordered),

(b) Delivery of transactions is not guaranteed (missing), or

(c) The same transaction may be received again (duplicate).

In order to track these transactions with minimum delay, a list is maintained of “missing” transactions for each component in the scheme. The range manager handles the insertion and removal of records indicating missing transactions.

Role Management

This subsystem handles the role-specific processing of a transaction. For example, a purse management role or a card management role or both may process a transaction.

The role transaction processing code is supplied by the business management package currently processing the transaction. For example, the purse role transaction processor is supplied by the purse management package. It is the responsibility of the business management package to determine the processing needs, and it typically involves updating a back-office database record based on the information contained in the transaction.

A Role is a specific set of defined rules which can be registered with the Transaction Processor. A Role is like a “plug-in” where specific actions are defined and are performed (as appropriate—determined by the Role) when a transaction is received by the Role (i.e. the Roles allow external packages to “hook” in to transaction processing).

Roles are allocated on a thread basis, and each Transaction Processor has its own dedicated Role for each different Role registered. (ie. if there were 2 Roles defined, with 5 Transaction Processors created, then there will be a total of 10 Role objects created: 5 of one type and 5 of another. Each Transaction Processor has one of each Role).

Role processing is asynchronous with respect to transaction processing (ie. each Role processes independently of other Roles for the same transaction).

A Role may not modify a transaction record, they just use the transaction in their own processing. Any additional information they need to store is placed in a Sub-Cache which is added to the TransactionCache.

Because Roles may appear or disappear at any time, there is a Role Mediator that is responsible for managing the Role addition/deletion from the Transaction Processors to make sure that the operation is consistent. As the Transaction Processors are independent threads, it is important to ensure that a Role which has just been deleted is not issued a transaction to process, similarly a newly registered Role may not be ready to process transactions yet.

Role Management concerns the processing of transaction records only by the roles that have a responsibility to do so. However, the transaction processors which pass the transaction records to the different roles, neither know what kind of specialisation of a transaction record, nor what kind of specialisation the role is. Hence, a mechanism is required for dispatching transaction records only to roles with an interest in a specific transaction record. This is achieved through the use of a double-dispatch mechanism, explained below.

For the double-dispatching of a transaction record specialisation to a role transaction processor specialisation are, firstly, the transaction record class, and all specialisations of the transaction record class are stereotyped <<transaction>>.

Secondly, each role transaction processor needing to process a particular specialisation of the transaction record class has a dependency to the specialisation of the transaction record class(es) stereotyped <<processes>>.

A MASS code generator uses the <<transaction>> and <<processes>> dependencies to classes stereotyped <<transaction>> to generate extra code.

When a transaction record is stereotyped <<transaction>> the following code is generated:

(i) An interface class.

(ii) A process( ) virtual function operation.

When another object has a dependency stereotyped <<processes>> to a class stereotyped <<transaction>>, the code generator automatically makes the class with the dependency realise the special interface which was created for the specialisation of the transaction record. Finally, classes stereotyped <<transaction>> have a process( ) operation which is filly implemented. When it is called by a transaction processor, a role is passed. This causes the process( ) operation to test the object passed to it and determine whether it realises the special interface generated for the specialisation of the transaction record (using a dynamic_cast operation). If the object passed to the transaction record's process( ) operation realises the generated interface, then the transaction record is passed in its specialised form to the dynamically cast object. This results in calling the role's specialisation of the process( ) operation (which accepts the specialised transaction record).

If the object passed to the process( ) operation of the transaction record does not realise the generated interface used to process the transaction, this indicates that the role does not want to process the specialisation of the transaction record.

Transaction Forwarding

This subsystem is responsible for forwarding transactions to external topics. It determines if the transaction should be forwarded (using an externally supplied interface), creates the new outgoing transaction, masks any sensitive information from the outgoing transaction, determines the topic that the outgoing transaction should be published on, and passes the outgoing transaction on to the transaction packing subsystem.

Transactions may need to be forwarded from one participant to another, for example, from a service provider to a clearing-house. This subsystem uses configurable rules—obtained via the configuration management subsystem—to determine if a transaction should be forwarded to another participant or not. If a transaction is to be forwarded to another participant then a copy of the transaction is made and any sensitive data (defined by configurable rules) is masked out. The new transaction is passed to the Transaction Packer.

The Forwarder is called by a “Clearing” Role and follows a set of predefined rules that relate to the delivery of the transaction to the Packer. The rules defined in the Forwarder may modify the summary information attached to the transaction.

Transaction Packing

Transaction Packing is responsible for packing transactions into an envelope and publishing it to a PSS gateway.

In order to conserve network bandwidth, transactions destined for the same PSS topic are packed together into a single envelope before being published onto the network via PSS. Transactions are packed into an envelope until:

(a) A configurable maximum number of transactions have been packed,

(b) A configurable maximum time limit from when the first transaction was added to the envelope expires (this prevents transactions waiting in an envelope for too long), or

(c) The transaction packer is ordered to flush its envelopes (this typically happens when transaction processing for a participant is suspended).

Action List Handling

The following services are part of the action list handling package:

(a) Action List Maintenance

(b) Action List Distribution

(c) Action List Consolidation

(d) Action List Interrogation

(e) Action List Transaction Processing

The following use cases are implemented by the Hotlists subsystem:

TABLE 22
Hotlists Use Cases

Title
Maintain Action List
Consolidate Action List
Distribute Action List
Interrogate Action List
Action List Transaction Processing

There are several resources in a MASS based system which a participant may wish to Action List. These include, but are not limited to either cards, applications, products (i.e a purses), or devices. The Action List Manager will ‘place resources into an action list for both negative and positive reasons. A Examples of positive reasons for placing a resource into an action list would be bad debt, stolen card or stolen device. Positive reasons would be to automatically enable an approved autoload facility for a purse. A resource is action listed so that appropriate action can be taken the next time the resource is used. In the negative instances, the appropriate action will typically be to block the resource to stops the resource being used in the future. To facilitate this, action lists are made available to all devices. Once a device has the action list, the next time the resource is accessed at that device the device will detect that the resource is in the action list and take the required action specified in the action list entry. Action lists can be categorised in two ways. As either general action lists, or priority action lists. General action lists are published by the Action List Manager throughout the day (typically once per day), at which point day the Action List Manager publishes the most up to date action list to all devices. The general action list comprises all currently list resources which require an action to be performed when it is next detected. During the day the Action List Manager may place additional resources in the action list. At periodic intervals during the day the Action List Manager publishes an priority resource action lists to all devices. The priority resource action list comprises additional resources placed in the action list during the day. Before the next general action list is published, entries in the priority action list are added and the priority action list is discarded. The resource action list are maintained both manually by an operator and automatically by the system. For example an operator may manually add a lost or stolen card to the card action list, or the system may automatically delete a card from the card action list upon receipt of a transaction record indicates that the action list entry has been triggered. In addition, there can be many action list. This allows either different resources to be placed into different list, or multiple lists to exist because they will be distributed to different locations. Action lists can contain a diverse set of resources, or resources of the same type. Business services provided within the Action List Manager sub-system relate to:

(a) maintenance of the action list

(c) distribution of the action list

(d) consolidation of distributed the action lists

(e) interrogation of the distributed action lists

(f) processing of action list activated transactions.

Card Handling

The card handling package provides Card Transaction Handler and Card Adaptor services described below.

Card Transaction Handler

The card transaction handler allows card and purse management to have a rollback facility. The card transaction handler provides an application with the ability to persist:

(a) changes to be made to cards

(b) notifications

(c) transactions

Card Adapter

The card adapter provides card and purse management with a common method for reading and writing to a physical card. The card adapter subsystem is used to write to the physical card and is used by the device transaction handler or any other subsystem when updates need to be made to a physical card. The card adapter is an abstraction layer between the structure of the data stored on the physical card (referred to as the physical layout) and the object oriented structure used to represent the card in the higher layers (referred to as the logical layout). The physical layout of the card is typically very different to the logical layout of the card. The logical layout of the card groups the card data based on what the data is. For example, all of the personalisation information and card specific data items (initialisation dates, expiry dates etc.) are all stored together. The physical layout of the card is based on storing information that is likely to be needed to perform a specific function together. This decreases the number of blocks that need to be read from a card and therefore the overall time spent to extract the required data from the card. This subsystem hides the mapping of logical to physical structure from the higher level layers and allows them to deal solely with the logical structure.

Management Framework

Management Framework Package

Management Framework package holds subsystems concerned with the resource interface and the application of rules.

Resource Subsystem

The MASS Resource Interface (MRI) subsystem provides a common API as a means of communicating managed information (information specific to the resources managed by MASS) over disparate protocols such as SNMP and FTP, without a client having to know which protocol is being used.

Service Description

The subsystem:

(i) Monitors managed information by allowing an agent to ask for it through a get operation.

(ii) Controls managed information by allowing an agent to request a change in managed information through a set operation.

(iii) Acknowledges requests for managed information through an acknowledge operation.

(iv) Reports asynchronous events through a reportEvent operation.

(v) Sends other types of message (including those above) through a send operation.

(vi) Receives messages through a client supplied callback operation.

Rules Subsystem

The Rules subsystem configures an Agent's behaviour, and it employs a set of rules. A rule contains an expression which evaluates to true or false. It will perform a set of commands if the expression evaluates to true, and another set of commands if the expression evaluates to false. Expressions may be built from other expressions which perform arithmetic operations on numbers, expressions which return true and false, and mapping queries which map an object to a list of objects.

Middleware

Middleware provides a set of tools enabling real-time application integration between the Business and Technical Infrastructure layers without requiring changes or additions to the existing system.

It provides:

(i) the separation between transmission hardware and control software;

(ii) availability of open programmable network interfaces;

(iii) accelerated virtualisation of networking infrastructure;

(iv) rapid creation and deployment of new network services and architectures; and

(v) environments for resource partitioning and coexistence of multiple distinct network architectures.

The subsystem is able to populate rule, expression and mapping query Create, Read, Update, Delete (CRUD) screens through setLogicalRule, setlogicalExpression, setArithmeticExpression, and setMappingQuery operations respectively. These rules and expressions are configurable through CRUD screens. It is also used for activating rules, and evaluating expressions and mapping queries through applyLogicalRule, applyLogicalExpression, applyArithmeticExpression, and applyMappingQuery operations respectively.

### Technical Infrastructure

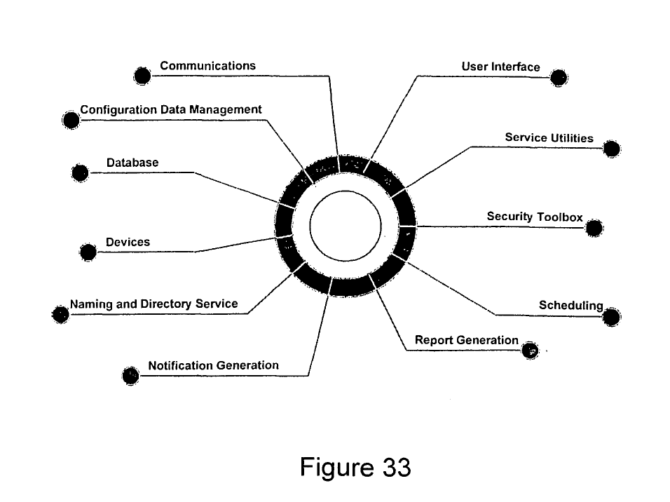

The Technical Instructure layer is treated as a system in its own right, one that defines the operating set of service and component systems as a whole. Services that are used by most of the packages are provided in the Technical Infrastructure layer and, as shown in FIG. 33:

(i) Communications

(ii) Configuration Data Management

(iii) Database

(iv) Devices Overview

(v) Naming and Directory Service

(vi) Notification Generation

(vii) Scheduling

(viii) Security Toolbox

(ix) Service Utiltiy

(x) User Interface

Communications

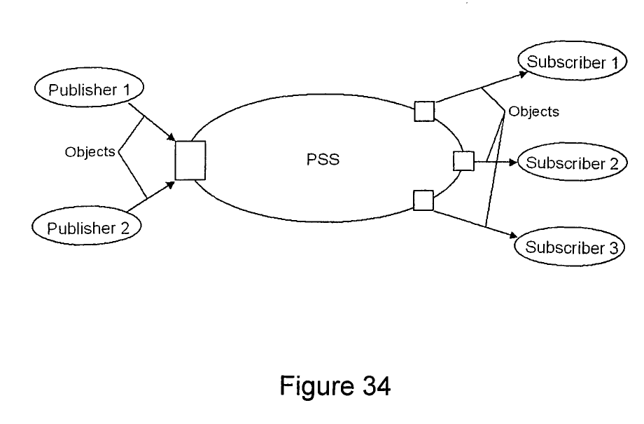

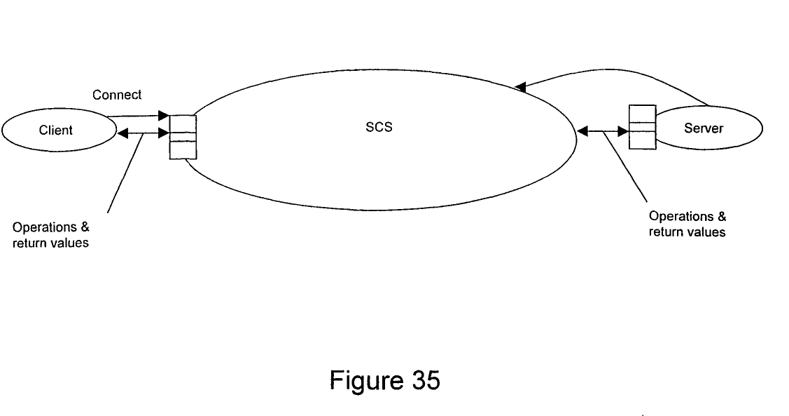

Communications is a package concerned with the transfer of data between clients and the MASS system. It uses several independent processes to communicate in an asynchronous and decoupled manner without needing to directly manipulate an underlying communications mechanism. The package is composed of, as shown in FIGS. 34 and 35:

(a) Publish Subscribe System (PSS): for transmission of bulk data. (e.g. transactions and configuration data) to many consumers which are not identified to the sender.

(b) Synchronous Communication System (SCS): for point to point communications where a client performs operations on a server. CORBA is used to provide the SCS.

Publish-Subscribe System

The Publish Subscribe Subsystem (PSS) provides the primary asynchronous messaging system between clients in the MASS system. PSS exists to achieve the following objectives (the means by which the objective will be achieved is described in parentheses):

(a) provide an interface that separates the client application from the details of data transport;

(b) ensure that subscribers only receive information on the subscribed topic(s);

(c) provide independent mechanisms to:

(i) achieve business objectives by manipulating information availability for subscribers according to information type (topic filters and hierarchies);

(ii) achieve technical objectives by exploiting or compensating for the physical properties of the underlying network (mapping between topic gateways and message queues);

(c) increase the durability of subscribers to the PSS by retaining for playback the most recent information received by that subscriber (playback, persistence); and

(d) allow the PSS client to define the quality of service required. (QOS parameters).

The PSS offers interfaces for clients written in C++ and Java, and the underlying transport mechanism the PSS adopts is an asynchronous messaging system or protocol.

Publish-Subscribe Concepts

The Publish-Subscribe Model

The PSS model defines publishers, subscribers, topics, information and the interactions between each of these constructs. Information exchange is based on the concept of a topic. Publishers produce information and publish it to a topic. Subscribers register interest in a topic and receive information published to that topic. In this way, subscribers only receive information they are interested in. Publishers and subscribers remain anonymous and are thus de-coupled. Because there is no coupling between publishers and subscribers, the participating ‘audience’ for a topic is dynamic—participants in a topic information flow are not obliged to each other. The PSS realises this concept by use of the following constructs:

TABLE 30
Publish-Subscribe Realisation

| Publish-Subscribe Concept | MASS Realisation |
|---|---|
| Topic | Gateways |
| Information | Envelope |
| Publisher | Client |
| Subscriber | Client |

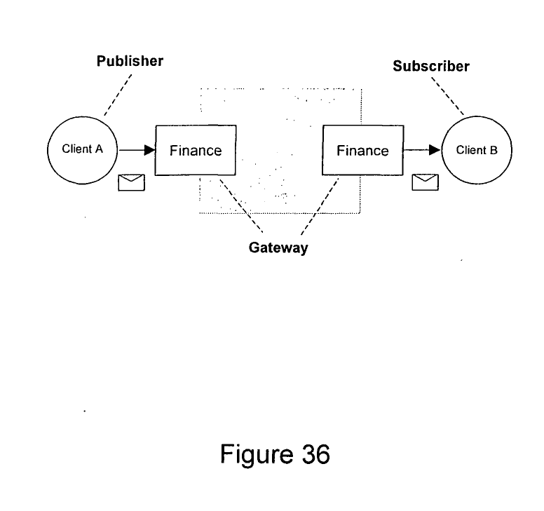

In FIG. 36, Client A and Client B are engaged in an information flow on the topic of ‘Finance’. The publisher, Client A, forms an envelope containing the information it wishes to communicate to all subscribers to the Finance topic. The topic is identified by the gateway that information passes through. Information passing through the Finance gateway is:

(a) expected by the publisher (Client A) to reach subscribers interested in Finance; and

(b) expected by the subscriber (Client B) to be relevant to Finance.

It is the publisher that dictates the relevance of information to a topic.

Gateways are bi-directional, and publishers can be subscribers (and vice versa). Client B could, therefore, use its existing Finance gateway if it decides to publish Finance information in the future.

Hierarchical Topic Definition

One of the basic objectives the PSS meets is to ensure that subscribers only receive relevant information from a gateway. Since the publisher forms the information envelope for issue, it is the publisher's responsibility to publish information on the correct gateway. The topic of an envelope is identified by the topic of the gateway it was published on. The PSS ensures that a subscriber interested in one topic never receives information bound for another. To ensure that there can be no ambiguity with the flow of information through the gateway, a topic identifier is unique in the system. It has already been noted that topics define the information made available to the subscriber. Since the subscriber is a process designed to achieve a business goal, the nature of the information (i.e. the topic) made available to the subscriber is part of a business strategy. The concept of topics can therefore be expanded to achieve a flow of information in order to satisfy a business need. The PSS provides for this objective by allowing for the organisation of topics into hierarchies, where topics towards the leaves of the hierarchy are more specific than those nearer the root

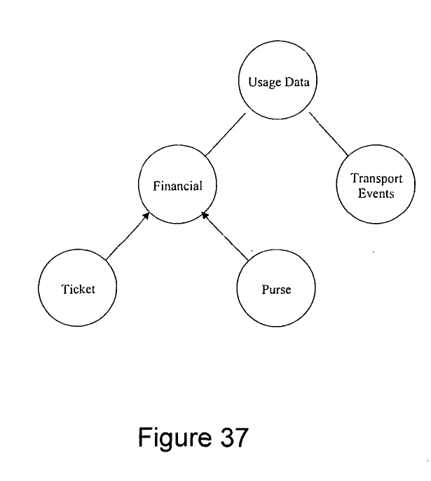

In FIG. 37, the ‘Ticket’ and ‘Purse’ topics have been classified as types of a ‘Financial’ topic and therefore, due to the hierarchy structure, are also a type of ‘Usage Data’ topic. A subscriber interested in Financial topic information would open a Financial gateway and expect to receive Financial, Ticket and Purse information. The subscriber will not receive more general Usage Data information.

The topic hierarchy model does not aim, in itself, to provide a data privacy mechanism for situations where there may be several ‘partners’ each with information flows (i.e. on the same topic) they do not wish public to other partners. The topic hierarchy seeks to group the information flow logically, while privacy will be provided through the topic domain concept.

A new topic may be placed into a hierarchy by identifying its immediate parent. A topic may have only one parent.

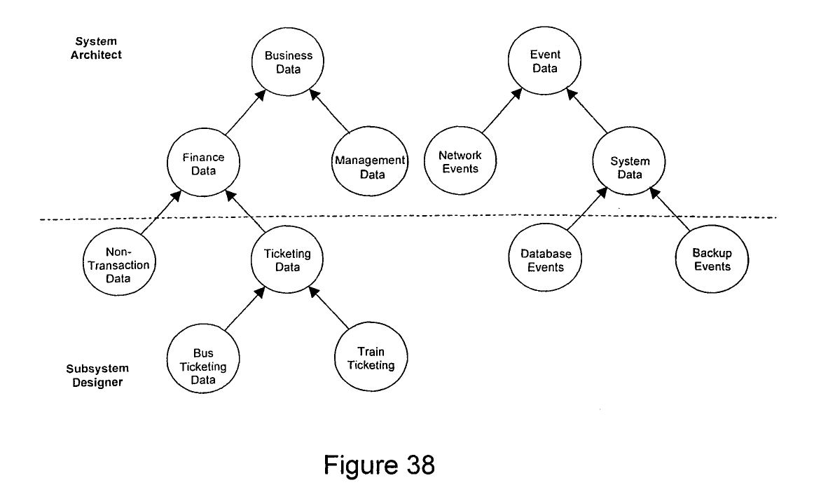

The formation of topic hierarchies is based on achieving business objectives. It is therefore the responsibility of a business domain expert to define the most general topic hierarchies in a project system (i.e. those topics nearer the root). Subsystem architects may then decompose these high-level hierarchies into more specific information topics. In this way, the business domain expert retains control over the basic communications model, but delegates more specific information decomposition to subsystem designers. FIG. 38 illustrates how decision-making about information exchange devolves to subsystem designers in a complex project system.

Topic definition may also involve defining what message security mechanisms (i.e. encryption) might need to be in place in order to satisfy a particular system requirement. Message security systems would quite typically be assigned to particular topics, due to the nature of the information being transferred (i.e. Finance Data). The application of a security level to a particular topic would generally result in the application of that security level to all children of the topic (i.e. also Non-Transaction Data, Ticketing Data, Bus Ticketing and Train Ticketing).

Filtering

Topic hierarchies are useful for defining information availability using business terms. However, individual subscribers may wish to arbitrarily restrict further the information that they receive. In order to allow for this, filters may be attached to topic gateways that ensure only envelopes with a desired property set pass through the gateway.

Where possible, filters defined at a gateway by a subscriber will be propagated to publishers to that topic so filtering can happen before network bandwidth is consumed. The property set filtering mechanism is provided by the messaging system, with the PSS providing an interface through which the filters may be specified. The PSS is responsible for ensuring that only envelopes related to the topic hierarchy will be received by the subscriber.

Topic Domains

In a large system, there may be several stake-holders co-operating in a business relationship. The privacy of their data would naturally be of concern to them, and the MASS system therefore provides mechanisms by which the information flows can be isolated. The topic hierarchy relates to a logical flow of business related information—which may be a common model for each of these stake-holders but their own information needs to be kept segregated, so the topic hierarchy could be logically broken up into topic domains. Each topic domain could be constructed to meet a business need (i.e. data privacy) or a technical need (i.e. where a particular Message Queue could be a bottleneck in the system).

The method by which these topic domains are realised is by providing a mapping operation between Message Queue portals and topic gateways. This mapping allows the PSS to follow the topic hierarchy model yet achieve independent data flows on the same topic.

Mapping of Message Queues to Topic Gateways

The PSS is responsible for ensuring that when a client opens a topic gateway, the right connections are made to the messaging system so that the client receives the information they are expecting. The connections are made to messaging portals, based on a set of rules maintained by the PSS. These rules are the mapping relationships between a topic gateway and the message queue, as a message portal is a directional connection to a message queue. The mapping relationships are able to specify a message queue for a particular client and gateway topic combination (i.e. each gateway connection is recognised as being unique). Mappings between message queues and topics may be defined statically and/or dynamically. Dynamically changing the mappings between message queues and topics can significantly alter the flow of information in the system. In fact, it would be possible to completely isolate a publisher or subscriber from a topic flow by assigning their particular gateway connection to a unique, non-used message queue.

The PSS:

(a) initially assigns a default message queue for each topic in the system;

(b) assigns the default message queue to a gateway if the system administrator deletes all non-default mappings from that gateway; and

(c) prevents deletion of the default message queue mapping to a gateway if it is the only mapping left for that gateway.

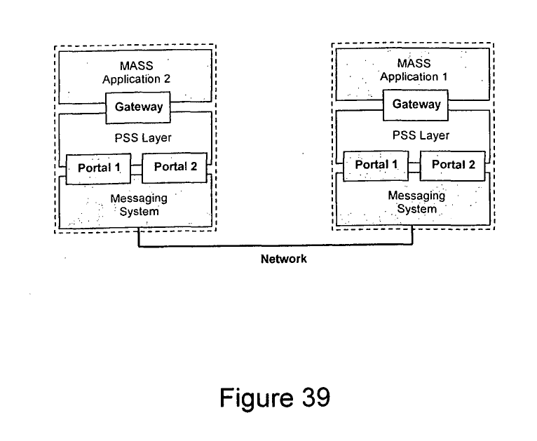

Furthermore, default message queue mappings define a ‘base’ PSS configuration that enables the PSS the moment it is deployed. Explicit initialisation configuration by a system administrator is not required. This illustrated in FIG. 39.

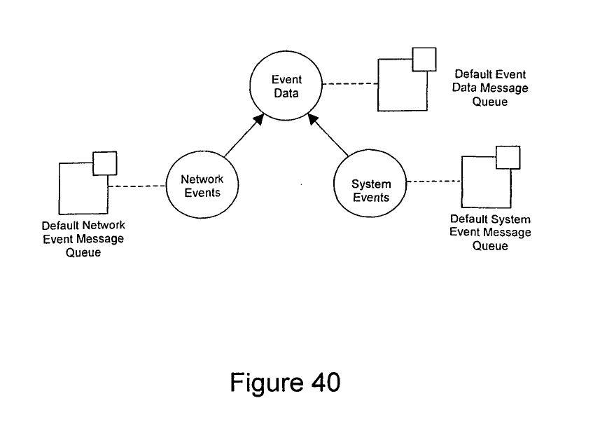

Once the PSS is deployed, the system administrator can introduce new message queue mappings as part of the system configuration process. As illustrated in FIG. 40, these mappings may be arbitrarily complex.

Mapping changes are made via an instrumentation API and propagated through the PSS by a common, universal management communications medium. A system administrator may manually assign one or more Message Queues to any Topic Gateway, and delete any Message Queue assignment from any Topic Gateway. All mappings would be logged, and any exceptional mapping activity will result in an alarm. Due to the decoupled nature of the Publish Subscribe paradigm (i.e. the number, and location, of publishers and subscribers is dynamic), it may not be possible to perform sophisticated checking on the Message Queue assignment. The PSS ensures that a system administrator makes at least two mappings to a particular message queue, so that a publisher is likely to have a matching subscriber.

Similarly, a system administrator may manually assign one or more Topic Gateways to the same Message Queue. Although the Message Queue will then be carrying information on multiple Topics, only PSS Clients that have subscribed to a Topic receive information published on that Topic: i.e., message queue sharing does not result in information sharing between topics. This is enforced by the assignment of Topic identification to information issued onto a Message Queue through a Gateway. Traffic statistics available through the instrumentation API will assist the system administrator in determining optimal mapping configuration.

Envelopes

Envelopes may be viewed from two different points of view as either containers of information or as the basic unit of exchange transported by the PSS. The following two sections identify the way the PSS handles envelopes in both these contexts.

Envelopes as Units of Exchange

As a unit of exchange, an envelope has properties that determine how it will be handled by the transport mechanism. Some properties of the envelope are applicable to the PSS layer only and would be encapsulated by the PSS before passing to the Messaging (AMS) system. The envelope properties are defined in Table 31:

TABLE 31
Envelope Attributes

| Attribute | Description | Set By |
|---|---|---|
| Persistence | Defines whether the envelope is to continue existing after | Publisher |
| | delivery. Envelopes without an expiration time may not | |
| | need to persist, i.e. they cease to exist after delivery | |
| TimeToLive | Defines how long the envelope exists in the | Publisher |
| | messaging system. Envelopes should not be | |
| | delivered after their expiration time, although they | |
| | may be. Actual expiry time calculated by MDS | |
| PSS Timestamp | The time that the envelope is passed to PSS for | PSS |
| | delivery | |
| Priority | Defines the envelope's priority. Every effort is made | Publisher |
| | to ensure that envelopes with higher priority are | |
| | delivered before envelopes with lower priorities | |
| CorrelationID | A PSS Client may use the CorrelationID header field | Publisher |
| | to link one envelope with another. A typical use | |
| | would be to link a response envelope with its request | |
| | envelope | |
| ReplyTo | PSS Clients may use this attribute to define the name | Publisher |
| | of a topic to which replies to this envelope should be | |
| | sent | |
| Type | May be used to provide envelope type information | Publisher |
| | without needing to extract the envelope payload to | |
| | determine its type. This attribute exists for the | |
| | benefit of publishers and subscribers only; it has no | |
| | effect on the delivery of the envelope | |
| QOS Parameters | Quality of Service Parameters (see table 32) | Publisher |
| Contents | The “payload” of the envelope, i.e. the information | Publisher |
| | that is being exchanged | |
| PropertySet | A string that summarises the envelope. Subscribers | Publisher |
| | use this string to determine whether the envelope | |
| | should be granted passage (i.e. used for filtering) | |
| Topic | A string which identifies the Topic on which the | PSS |
| | envelope has been published. This is used to ensure | |
| | that the envelope is only delivered to its intended | |
| | recipients | |
| Replay | The envelope is one which has been generated | PSS |
| | through a specific replay request | |
| Envelope ID | A unique Envelope ID is generated for each. The | PSS |
| | Envelope ID may be a product of the following data: | |
| | The location of the node as defined by the node's | |
| | transport mechanism (an IP number if using | |
| | TCP/IP), | |
| | A client identifier (which may consist of a process | |
| | identifier (NOT process ID) and, if required, a thread | |
| | identifier) | |
| | The local time (in seconds), and | |
| | A message number that is incremented whenever an | |
| | envelope is sent. | |

Envelopes as Containers of Information

The following options and services are made available to publishers of information in the PSS:

Encryption

Provision is made for sensitive information entrusted to the PSS. Full (i.e. entire envelope) and partial (information payload only) encryption are both supported. The use of encryption facilities would typically incorporate the use of compression.

Compression

At present, the amount of information contained in a single envelope is only limited by system resource availability. Bulk information transfer is, therefore, possible. However, network bandwidth is limited and throughput in the system is expected to be very high. To cater for this, a compression option is made available to publishers of information. Publishers are warned however, that a significant time cost is incurred by compression—it is up to the publisher to decide if the time penalty of compression is worth the savings in bandwidth consumption.

Version Tolerance

The systems that the PSS serves are living systems, elements of which may change over a long period of time. A new version of a system element might introduce changes to the format of the information it communicates. Subscribers to the information produced by this changed system element are protected from such changes by the use of MASS serialisation operators. When information is serialised onto an envelope it is interpreted into a generic self-describing format. This format is understood by the deserialisation operator which can then detect incompatibilities between the structure it is writing to and the structure described in the envelope. The receiver can then handle such incompatibilities as they see fit.

Data Portability

Data portability ensures that data serialised on a machine of one type is deserialised correctly on a machine of another type. This, for example, permits data serialised on an Intel-based PC to be deserialised correctly on a Sun workstation.

Quality of Service

Rather than offer grades of service, the PSS offers a set of Quality-of-Service options that may be set independently of each other according to individual PSS Client requirements. These options are detailed in Table 32:

TABLE 32
Quality of Service Parameters

| | | Performance |
|---|---|---|
| QOS Option | Option Selection | Impact |
| Duplicates | {Allowed/Not Allowed} | Low |
| If ‘not allowed’, duplicate messages (identified | | |
| by the same Envelope ID) will be detected, logged | | |
| and discarded by the receiving Envelope Delivery | | |
| Service | | |
| Guaranteed | {Enabled/Disabled} | High |
| Delivery | | |
| If ‘enabled’, the sending application will detect | | |
| failure of message issue and optionally re-send the | | |
| message for a configurable number of times. The | | |
| client application (publisher) will be informed of | | |
| failure to send the message if the configured number | | |
| of attempts has proven unsuccessful. There are three | | |
| configurable items for this mode: | | |
| (a) Number of retry attempts | | |
| (b) Interval between retry attempts | | |
| (c) Acknowledgement override (by the receiver) | | |
| Guaranteed delivery only applies to the list of | | |
| subscribers, as known to the publisher, at the time | | |
| of publishing. Subsequent subscribers may or may not | | |
| receive the envelope. This mechanism could only operate | | |
| on messages which have a defined Time To Live. | | |
| Acknowledgement | {Enabled/Disabled} | High |
| Override | | |
| This is a ‘submode’ of guaranteed delivery. An | | |
| acknowledgement is required, but the receiving | | |
| application decides whether a message needs re- | | |
| transmission or not on th basis of the payload | | |
| (i.e., its integrity or content) | | |
| Reprioritisation | {On/Off} | Low |

If ‘On’, a messages priority is upgraded based
on how long it has spent at a particular
node while in transit. This tool is included
to ensure that messages entering the messaging
system are not ‘starved’ if they are located at
a node shifting a large amount of high priority
traffic

These options exist at both the gateway and envelope levels. QOS options defined at the gateway are the default for information (i.e. envelopes) published onto that gateway. The default gateway options will be able to be overridden on a per envelope basis.

Playback

One of the requirements on the PSS is to make the system more durable. Though the PSS cannot make machines or client processes less susceptible to failure, it can take advantage of the resources available to the system as a whole to make information less susceptible to loss.

The PSS has two resources available to it to preserve information in the face of disaster:

(a) Static storage. Once written to local static storage, information may be preserved between invocations of the owning process.

(b) Distributed network. Information preserved at a remote node may be resent to an interested node that has experienced a prior failure.

The sender is given the option of ‘persisting’ an envelope when it is first sent. If persistence is required, the envelope is written to a repository at the publisher and, as delivered, at all receivers of that envelope. In the event that there are multiple subscribers at a node, the envelope is written just once to the repository. The sender is wholly responsible for determining whether an envelope is to be retained in the repository.

Persisted envelopes serve as the basis for the playback mechanism. When a client makes a playback request to a gateway, the PSS on the requesting machine takes the following steps:

(a) specify the criteria that identify envelopes for playback;

(b) recover and reschedule any envelopes persisted locally that meet the playback criteria;

(c) identify the set of senders that might have envelopes meeting the playback criteria; and

(d) issue the playback request to the senders identified in step (c).

On receiving a playback request, a sender will recover and re-send any eligible envelopes in its local repository to the playback requester. The envelopes it re-issues may be grouped into batches, and if the playback requester receives an envelope it already knows about, the reissued envelope would be discarded as a duplicate.

The criteria for playback of an envelope is provided by the playback requester and can expressed in terms of topic, time, envelope ID and/or Node ID:

(a) Topic. The topic of the envelope issued by the playback sender must be the same as, or related to, the topic of the gateway the client originally requested playback for. Topics can be related by hierarchy.

(b) Time. Since the envelopes for playback may be located remotely, the only common reference between envelopes in the system is time. Because time synchronization between nodes in the MASS system will not be exact, the playback set of envelopes may differ slightly to the set originally received in the time range specified by the playback requester.

(c) Envelope ID/publisher. As each envelope has a unique identifier, it may be desirable to request a playback on a particular envelope sequence. In this instance, the original publisher would be identified and only envelopes matching this publisher would be re-sent.

(d) Node ID. This option is useful when envelopes from a particular Node have been identified as requiring replay. This criteria would be independent of original publisher, and may (as selected) include playback from other Nodes which have envelopes matching this Node ID.

Playback selection criteria includes the starting time for the playback with other selection criteria being optional. Where a complete playback is required the playback requester provides a starting time that encompasses all persisted envelopes. Though playback is principally for disaster recovery, it can also be used for testing, debugging, and auditing. Playback strategies that are supported are enumerated in Table 33.

TABLE 33
Playback Strategies

| Strategy | Description |
|---|---|
| Real-time | Envelopes are enqueued in the order and |
| | frequency recorded. A time-factor may be |
| | applied (i.e. percentage of real-time), |
| | such that slow motion or time-acceleration |
| | is achieved |
| Flood | Envelopes are enqueued and delivered as |
| | fast as possible |
| Trickle | Envelopes are enqueued at a constant |
| | and definable frequency |

Publish-Subscribe Implementation

Architecture

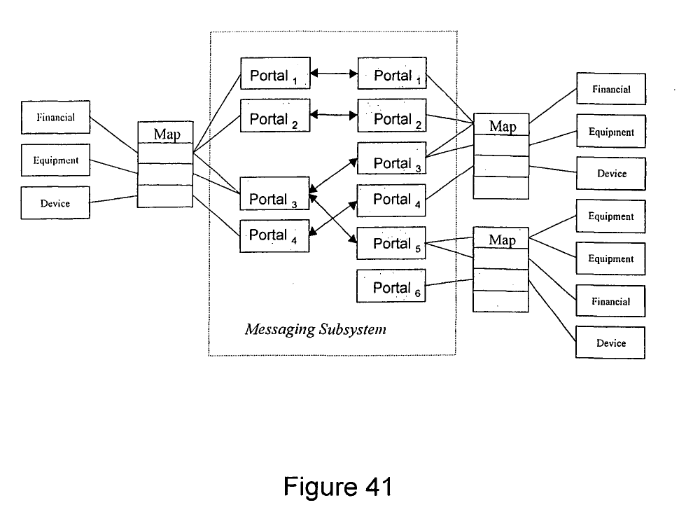

Each node in the MASS executes, as a distinct process, an Envelope Delivery Service (EDS) which is part of the Publish Subscribe Architecture. As is shown in FIG. 41, the EDS mechanism interfaces to the Messaging Delivery Service (MDS), itself a part of the asynchronous messaging system.

Clients wishing to communicate using PSS communicate with this process through an Inter Process Communications (IPC) mechanism, by instantiating a gateway. For each gateway instantiated by clients, the EDS creates a corresponding gateway object within its Gateway Manager (GM). As a part of the instantiation process, the client provides a unique identifier to allow the EDS to maintain gateway mapping information. By default, the Mapping Manager (MM) maps new gateways to the default message queue for the gateway's topic. However, as previously described, a system administrator may change the mappings of message queues to gateways in order to achieve multiple topic domains or to satisfy a technical objective.

When publishing information to a topic via a gateway, the Portal Manager (PM) ensures that an inlet portal exists to each message queue mapped to the gateway. Similarly, when subscribing to a gateway, the PM ensures that an outlet portal exists to each message queue mapped to the gateway. Portals remain in existence until the message queue is no longer mapped to the gateway, or until the gateway is destroyed. Information, of a persistent nature, that has been successfully delivered to the EDS by publishers or subscribers by the EDS is entered into the repository.

Mapping

The PSS realises the hierarchical arrangement of topics as a set of message queues mapped via portals to the appropriate gateways. The Mapping Manager is responsible for determining the set of message queues for a particular topic, and where there is no defined mapping it performs the generation of the default message queue name.

In order to minimise the number of open portals, the EDS maintains mapping of what gateways are connected to a particular portal. This mapping is used whenever an envelope is received, either for publishing or via a message delivered by the messaging system, to ensure that all of the appropriate portals/gateways receive the envelope. As the messaging system delivers messages, which the PSS must translate to/from an envelope, this approach makes more efficient use of system resources.

Topic Hierarchy

Topic Hierarchy is a static element in a particular MASS system. The Topic Hierarchy is defined prior to deployment, and loaded onto each node in the system. It is possible that the Topic Hierarchy may be able to be changed. However, on a live project system as the changes are percolated this may cause undesirable information flows and potentially inconsistent states for subscribers which are dependent on synchronised data flows from multiple Publishers.

Instrumentation

Instrumentation may be employed to inspect the state of various PSS components. Furthermore, it may be used to modify the state of a subset of these components. Most significantly, it allows the management of message queue assignment to topics. Every PSS component may be monitored for its current state, as well as historical information that may be used to gauge its performance. Table 34 lists the components that may be instrumentable, and offers comments on each.

TABLE 34
PSS Components that May be Instrumented

| Component | Instrumentable Properties |
|---|---|
| Topics | The set of gateways opened for each topic |
| | may be obtained |
| Gateways | Historical and real-time statistics may be |
| | obtained pertaining to the state of the |
| | gateway, such as total throughput, average |
| | throughput per second, highest throughput, |
| | number of envelopes, average envelope |
| | size |
| EDS | Historical and current statistics, as well |
| | as the current state of each data |
| | structure within the EDS |
| Map | The mappings of message queues to topic |
| | gateways may be managed |

Configuration Data Management

Configuration Data Management is concerned with the maintenance, distribution and access of the configuration data. The following use cases are concerned with Configuration Data Management.

TABLE 35
Configuration Data Management Use Cases

Title
Maintain Configuration Data Instance
Distribute Configuration Data
Receive Configuration Data
Authorise Configuration Data

Control Data

Control Data affects the behaviour of objects. It is represented as an attribute and value pair. The unique value is loaded into an object attribute through an object interface. An example of configuring an object with control data is: ‘Here is the colour blue with which to paint yourself.’

At the subscriber end, control data is likely to either fully or partially populate the attributes of an object or possibly represent an entire object. The object is likely to play an active role in services provided at the subscriber end.

Referential Data

Referential data is a set of objects of same class that is utilised by other objects in order to obtain a unique value. An example of configuring an object with referential data is: ‘Here is a table of colours. I will let you select one’. At the subscriber end, referential data is perceived as an object that is used for look-up purposes.

Maintain Configuration Data

Configuration Data is dynamic. Its form and content is maintained according to the needs of its producers and consumers.

Persistence

Persistence is the ability of an object to store some or all of its attributes in permanent storage. These attributes are known as persistent attributes. Configuration Data is the subset of persistent attributes that is used to initialise or modify system behaviour. All members of a Configuration Data definition are drawn from this subset. MASS provides persistent classes and attributes that it uses for configuration data and the configuration data definitions that act as containers for those attributes. Through the generic services provided by MASS, city projects can incorporate additional configuration data requirements.

Maintain Configuration Data Instance

Throughout the life of a project system, the values of configuration data will change, such as fares in fare tables. The maintenance of configuration data instances provides the means for configuration data producers to define the values of the persistent attributes of the various configuration data definitions that will be disseminated to consumers. Each configuration data instance has a common set of core attributes that identify and control its use. Representative examples of core attributes are shown in Table 36.

TABLE 36
Examples of Core Attributes of Configuration Data

| Attribute | Description | Notes |
|---|---|---|
| Name | The name of the | Unique |
| | configuration data | |
| | definition | |
| Version | The version of | Unique in |
| | the configuration | combination |
| | data definition | with |
| | | Name |
| Creation | Used to define | |
| Date/Time | when a configuration | |
| | data instance was | |
| | created. | |
| Activation | Used to define when | |
| Date/Time | a configuration | |
| | data instance becomes | |
| | active in the | |
| | system. | |

Distribute Configuration Data

Distribution of configuration data is concerned with the transfer of configuration data between nodes via the PSS. Distribution does not include the transfer of configuration data to devices; this is a separate process that is handled by the Device Management package. Consumers subscribing to a topic associated with a particular configuration data type receive the data. Configuration data may be encrypted and/or signed for secure transfer.

Receive Configuration Data

Receipt of configuration data involves validation and activation of configuration data received from the PSS. Validation of received data is ensuring that the contents have not been corrupted and that the sender's identity is authentic. Activation is placing received configuration data in the local database.

Authorise Configuration Data

Authorisation of configuration data is concerned with a nominated Authorisation Authority ensuring correctness and integrity of revised configuration data. The process is performed before configuration data can be distributed to its consumers. Whether authorisation of configuration data is required.

Database

This section describes the database persistence sub-systems. An overview to the API used for maintaining persistence objects and developing DataSources is also described.

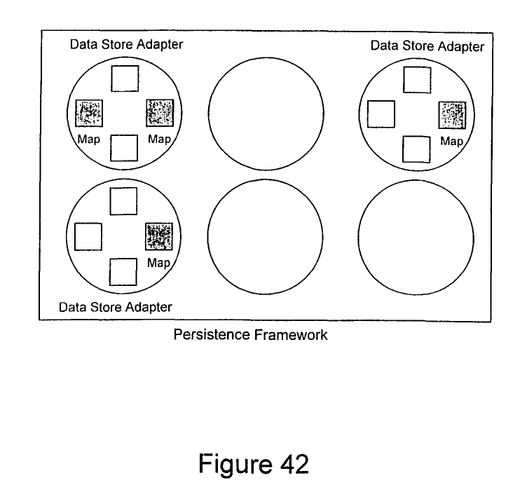

The Persistence Layer hides object orientated/relational database mismatch by removing the need to code SQL statements for retrieval, insertion, update and deletion of objects in application code. The Persistence Layer calls appropriate database interfaces, such as SQL, to retrieve, insert, update and delete object(s). The three elements of object persistence are, as shown in FIG. 42:

(a) Object Schema (model). This defines the structure of objects on the application side.

(b) Database Schema (model). This defines the structure of data stored in the Data Store.

(c) Mapping Definition. The mapping between the two schemas (models).

The Persistence Layer abstracts basic Database functionality such as:

(a) connecting to a database with authentication;

(b) maintaining data integrity through the use of database transactions;

(c) database error handling (such as data integrity and permission);

(d) pessimistic and optimistic locking of records (objects).

The Persistence Layer offers additional functionality appropriate to persistence objects frameworks such as:

(i) retrieval of object collections

(ii) persistence and deletion of persistence objects

(iii) audit of changes to persistence objects

(iv) data integrity

(v) failure management

(vi) performance options such as:

(a) Partial object retrieval.

(b) Demand based referencing. Objects are retrieved and instantiated automatically by the Persistence Layer on navigation of retrieved objects relationships.

(c) Deep retrieval. Full Object retrieval, including referenced objects.

(d) Dirty attribute flag maintenance. Functionality for performance gains on SQL update statements.

The Persistence Layer has:

(a) Database independence. Application code remains unchanged for different databases and database schema versions. An alternative database could require an alternative mapping definition or a new database adapter. An alternative database schema would only require a new mapping definition.

(b) Version tolerance. Particularly between applications and databases schemas.

Architecture

The Persistence Layer is designed around an extensible architecture. The Persistence Layer may be extended with alternative database or storage technologies, by developing alternative DataSources that load into the Persistence Layer.

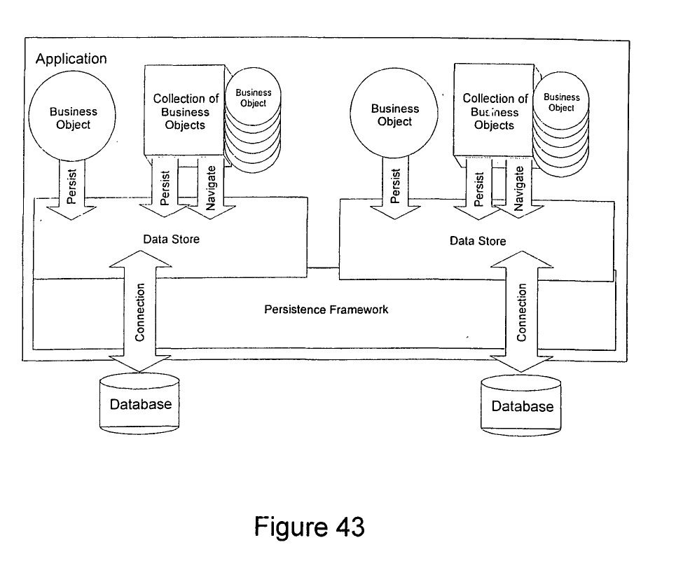

The Persistence Layer dynamically loads DataSources and mapping modules, as shown in FIG. 43. The binding of persistence implementation to persistence objects is at run-time and as such, the same application can manage persistence objects to different data storage mediums or databases. This enables applications with the same object model to run on different database schemas.

Datasource Sub-System

The Persistence Layer will map the call to connect to a DataStore with a dynamically loaded sub-system, ie a DataSource. It is the responsibility of a DataSource to:

(a) map from object model to database schema for a particular database or storage technology;

(b) load data store mapping definitions; and

(c) optionally dynamically load a module that implements the overriding persistence of an object. This may be required where the mapping definitions prove inflexible.

Mapping Definition Data may exist in:

(a) a dynamically loaded module and is the same as DataSource sub-system;

(b) a configuration file

An implemented DataSource has the following responsibilities:

(i) abstract database connections;

(ii) abstract database transactions;

(iii) abstract object storage and retrieval;

(iv) abstract database result-sets (cursors) into object collections;

(v) abstract object identifiers (database primary keys);

(vi) abstract object locking (pessimistic and optimistic); and

(vii) marshal any overriding code to the dynamically loaded overriding module.

The Interface Classes

Maintaining Persistence Objects involve the following classes:

(a) DataStore. Represents a single storage instance.

(b) DataStoreUser. Represents a session to a storage instance.

(b) Persistence Transaction. Used as an envelope for database transactions.

(c) DataStore Query. Used for retrieving multiple instances of a single object type.

DataStore Class

Creation of an instance of a DataStore with a name instructs the Persistence Layer to map to the desired data store module. The Persistence Layer loads the DataSource module and all future Persistence against this DataStore is mapped into the module implementation. Responsibilities of the class include:

(i) Managing connections to databases.

(ii) Managing multiple connections to provide for bump-less failure handling for Persistence Layer clients.

DataStoreUser Class

A DataStoreUser is created from a DataStore and is responsible for:

(i) Persisting and deleting objects.

(ii) Serialising/De-serialising Objects to storage (where necessary).

(iii) Auditing of Object insertions, deletions, modifications and retrieval.

Persistence Transaction Class

Creation of an instance of a Persistence Transaction allows a number of persistence operations to be batched into a single database transaction. Responsibilities include batching operations into a database transaction and Managing distributed transactions.

DataStore Query

Creation of an instance of DataStore Query allows queries to be made requesting a collection of objects fitting a particular criterion. Responsibilities of the class include:

(a) query objects with parameters filter, sorting, retrieval and locking modes;

(b) navigation methods returning instances of persistence object; and

(c) count returns the object count in the collection.

The following are persistence objects types.

Dependently Persistable Classes

An object is defined as dependently persistable if they are only every persisted as part of another class. This in effect allows objects that are contained by reference to be treated as if they are contained by value (composition). Dependently Persistent classes share storage with their container class.

Independently Persistable Classes

An object is defined as independently persistable if it may be instantiated as an object in isolation. When independently persistable Objects exist in association and aggregation relationships, applications are responsible for ensuring correct order on calling persist and delete Methods.

The rules are:

(a) Referenced objects, that have been created or modified, are persisted before referencing object is persisted.

(b) Referenced objects must be deleted after referee object is deleted or referee attribute is modified.

Independently persistable classes do not share storage of their container classes, and they have their own storage. Therefore, independently persistable classes are referenced in the database storage.

Transactional Support

Persistence Objects, existing through composition, are automatically persisted or deleted with the client object inside a database transaction, maintaining data integrity. Relationships, specifically association and aggregation, involving independently persistable objects require transactional support to maintain data integrity. This is required to meet application failure handling requirements.

Collections

A collection attribute has:

(a) navigation methods returning references to retrieved object instances

(b) returning of collection size

Collection of Instances

Collections representing composition abstract a collection of instances and:

(a) Add new object instance to the collection, which will add to data store on persist.

(b) Remove existing object instances from the collection, which will delete the object from the data store on persist.

Collection of References

Collections representing aggregation or association abstract a collection of references, and:

(a) adding an object reference to a collection, which will add a reference on persist; and

(b) remove object references from a collection, which will delete a reference on persist.

Navigability

For relationships that are association, and navigability may be specified in two directions, attributes exist in objects on both sides to represent the relationship. A reference is used for single instances and a collection for many instances.

Authentication

In the MASS Persistence Layer, authentication provided by the underlying Database. Therefore:

(a) there is synchronisation between MASS user/group maintenance and Database users/groups;

(b) MASS Application Framework gives a token, username and password, after authentication to applications to make a connection to the database

With database authentication being used, the authentication service is performed by either:

(a) the database itself through a database vendor's security implementation;

(b) the database servers operating system or network domain; or

(c) authentication adapters.

Data Privacy and Data Integrity

To ensure that data has not been modified, deleted, or replayed during transmission, database connection protocols generate a cryptographically secure message digest and include it with each packet sent across the network. To ensure that data is not viewed during transmission, transmission encrypt each packet sent across the network.

The options for data privacy and data integrity are:

(a) for the Persistence Layer to utilise data privacy and data integrity services provided by a database vendor;

(b) secure the transport layer;

Authorisation

Database Authorisation is ensuring that a user, program, or process receives the appropriate privileges to retrieve, insert, update or delete an object or a set of objects. In the Persistence Layer, class/attribute authorisation is provided by the Database, as the Databases allow permission to be set on tables and fields for a user or group. Since MASS Persistence Classes and Attributes map to Tables and Fields, MASS systems class and attribute permission can also be mapped to tables and fields. This involves synchronisation between MASS class/attribute permission maintenance and Database table/field permission maintenance. If authorisation is required to the object level rather than the class level, then the Persistence Layer handles this authorisation.

Data Auditing and Security Exceptions

Data Auditing handles recording retrieval, insertion, deletion and modification of Data Objects. Security Exceptions is security being compromised or attacked. Data Auditing and security exceptions are handled by:

(a) Use triggers provided by a database vendor. This imposes the following additional requirement. A reverse mapping from tables/fields to classes/attributes needs to be used to produce reports that describe audit changes in an object world rather than table/field world. Database Auditing through use of triggers, provides the highest level of auditability, as all connections will be audited, including third party tools.

(b) Client side logging of object changes or security attacks in the Persistence Layer. This imposes the following limitations: external connections not using the Persistence Layer, such as reporting tools will not be audited.

Data Access Denial

To provide fail-over support and therefore continuity of data services, databases replicate data to a stand-by server. To provide fail-over support and therefore continuity of data services, the Persistence Layer may need to provide bump-less transfer from primary to stand-by database server. This involves a connection being established to the stand-by server and the current transaction being re-run by the Persistence Layer against the new connection.

Instrumentation

Performance counters are implemented inside the data store object. The performance counters are available per data store per data store client. The requirement for performance counters is performance tuning of the Persistence Layer and application code using the Persistence Layer.

Devices

In MASS, a device is a computer (or embedded computer) that can communicate with a card (through a card reader/writer). Supporting computers that exist only as an adjunct to one or more devices, yet have no direct card interface of their own, are also considered to constitute devices (e.g. Driver's Display Unit—DDU).

For devices a technical infrastructure exists in the back-office, and a related but distinctly separate framework exists for devices and device adapters.

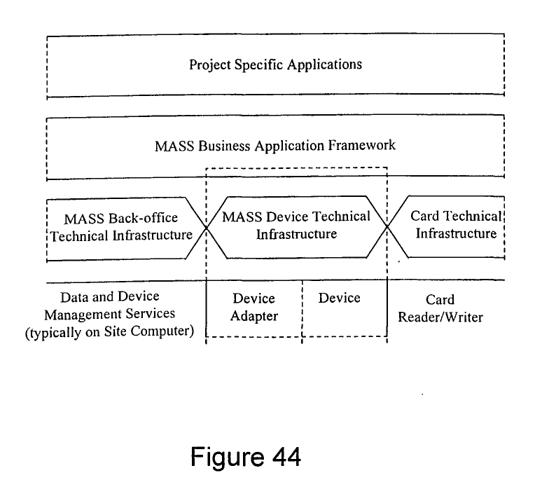

As mentioned previously, all devices not capable of being fully compliant with the MASS device interface communicate using a device adapter. The MASS device interface between the device adapter and the data and device management services marks the delineation between the MASS back-office technical infrastructure and the MASS device technical infrastructure, as shown in FIG. 44

Although the technical infrastructure within the device and device adapter is separate from the technical infrastructure in the back-office, there is some mirroring of functionality between the two infrastructures. For example, the security, serialisation and interface communications sub-sections contain some common elements to allow interworking of the back-office and the device.

Device/Site Computer Interfaces

Devices interact with site computers as the point of contact with the MASS back-office using device interfaces.

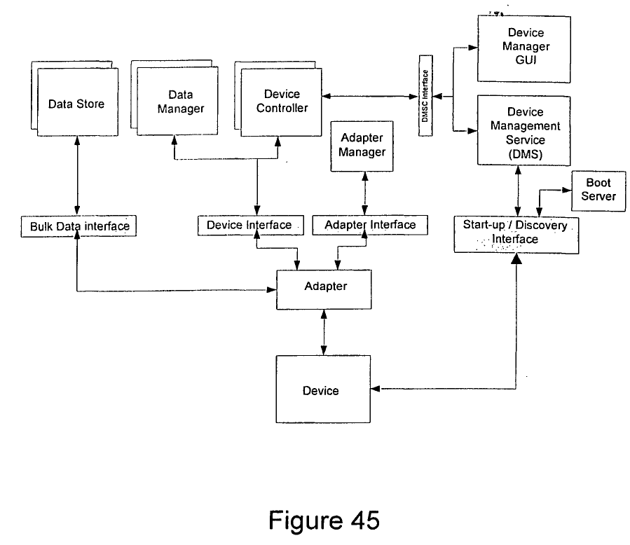

There are a number of interfaces between the services provided by the site computer and the device and device adapter. FIG. 45 illustrates the arrangement of these interfaces. The device start-up and discovery are handled through one interface, device and device adapter monitoring and control through a second interface, and bulk data transfer through a third, entirely separate interface.

During device start-up and connection to the site computer, only the start-up/discovery interface is used. Once connected and authenticated, the device and adapter interfaces provide synchronous communications (i.e. a request/response blocking style of procedural communications), while the bulk data interface provides asynchronous communications (i.e. more akin to a file transfer protocol). The device and adapter interfaces are used for device (and adapter) monitoring and control, while the bulk data interface is used for UD upload, CD download and any other forms of non-time critical bulk data transfer.

Device Start-up and Discovery

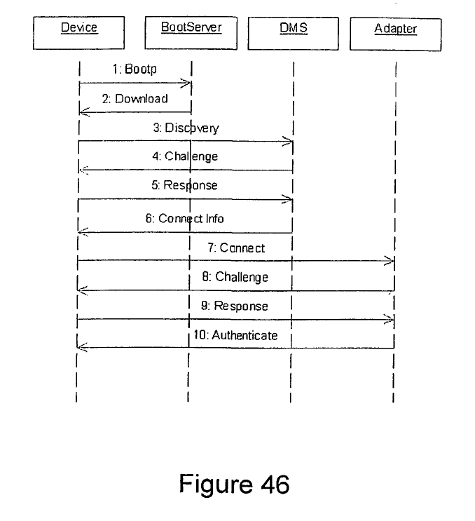

FIG. 46 illustrates a typical sequence a device may go through on initial start-up. If the device has not been commissioned before, it may go through an initial BOOTP style of application download. In addition to downloading the application, this mechanism may also be used to retrieve an IP address for the device. After initial boot loading and assignment of an IP address, the device uses a discovery mechanism protocol to announce its presence to the Device Management Service (DMS). After authentication, the DMS provides information to the device to allow it to connect to the appropriate services. The device then connects to the adapter and a secure session is negotiated and established. Once the connection and session are in place, the device is authenticated and connected, and the discovery interface plays no further part in the operation of the device.

Device Adaptation

MASS is independent of the devices used in a project and be able to support a variety of different devices in a “plug in” fashion. Furthermore, MASS is capable of supporting third part devices that may only be detailed to an interface protocol level (e.g. a MASS Device Extensible Protocol (DEP)).

To support a range of possible device implementations, if a device is unable to fully implement the MASS device interface, a device adapter is written to translate the MASS device interface into the device's native interface protocol. A specific project implementation may use one device adapter to communicate with a number of devices conforming to one device interface protocol standard (e.g. DEP) and another device adapter for communicating to a custom designed third party device.

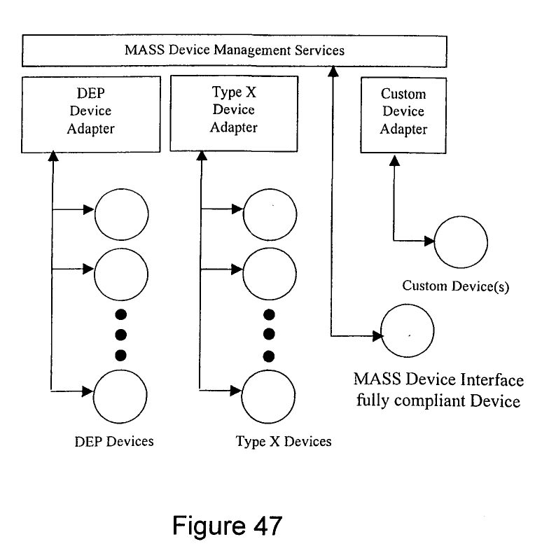

As indicated in FIG. 47, a single device adapter may communicate with one or more devices. The flexibility of the design and implementation of the adapter are the determining factors as to how many devices the adapter can handle, and also the range of device types the adapter can communicate with. For example a specific project's implementation may use multiple DEP adapters, each one customised for a particular DEP device type. Alternatively, it may be possible for the project to implement a powerful, generic DEP adapter that is able to communicate with all DEP device types. Device adapters are targeted for deployment on the site computer as separate processes. Alternately, an adapter may be deployed on a physically separate computer to the site computer.

Physical and Logical Devices

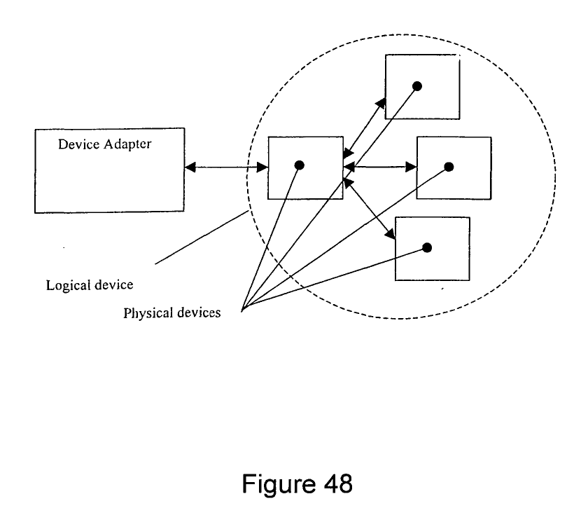

The concept of a logical device is used to denote a group of physical devices that appear as a single device from the device adapter's perspective, as shown in FIG. 48. In this document, unless specifically stated otherwise, ‘device’ may be interpreted as a logical device. The concept of a logical device may be useful in scenarios where the site computer (through the device adapter) communicates with a single master device, which in turn communicates with a network of other devices. A bus with a driver's fare console and multiple bus card processors is an example of a logical device.

Virtual Devices

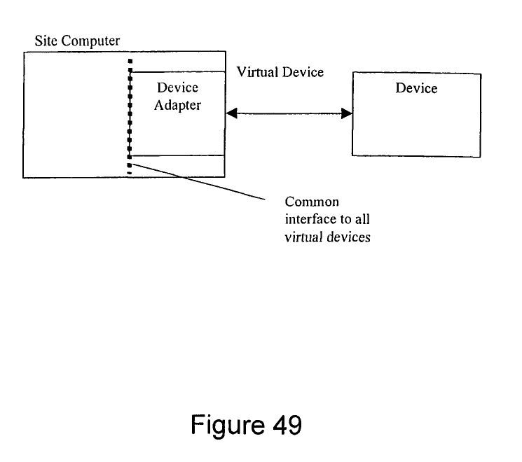

The term ‘virtual device’ is used to indicate the combination of a logical device and its appropriate device adapter. From the perspective of the back-office, a virtual device is an instantiation of a single logical device. All virtual devices present the same interface to the MASS back-office, as shown in FIG. 49.

Device Model

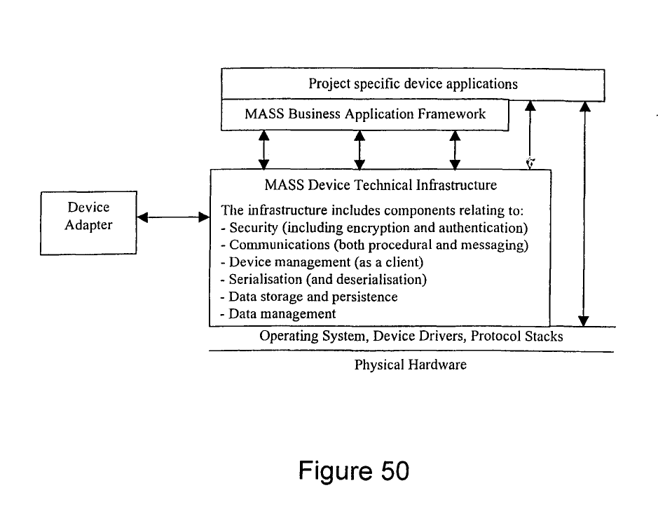

FIG. 50 illustrates that within a device, the operating system (and associated system components such as hardware device drivers and communications protocol stacks) completely abstracts the physical hardware of the device from all other software within the device. The MASS Device Technical Infrastructure (DTI) forms a toolkit for the developers of the MASS Business Application Framework (ie the Business Infrastructure) and project specific device applications.

Naming and Directory Service

The naming services provides a naming system that allows a natural, understandable way of associating names with data for the purposes of organising and acting on data and objects. For example, the DOS file system uses a naming system for associating folder and file names with data. A naming system allows humans to interact with complex computer addressing systems through simple understandable names. The directory service is a natural extension to the naming service. It organises naming services in a hierarchical manner and adds functionality for evaluating and modifying NDSAttributes attached to NDSDirectory objects and the ability to search using NDSAttributes as a filter. This subsystem requires that clients deal in the names or vocabulary of the MASS system. The subsystem associates a set of data types with these names.

Directory services are organised as hierarchical-naming services organising data and objects within the context of directories and subdirectories. Directory services add functionality for evaluating and modifying attributes attached to directory objects and the ability to search a directory using attributes as a filter.

Directory and naming services employs two layers: a client layer and a server layer. The server is responsible for maintaining and resolving the actual name-object bindings, controlling access, and managing operations performed on the structure of the directory service. The client acts as an interface that applications use to communicate with the directory service.

Such an independent naming and directory service is used in serving clients on the distributed nodes and devices working together that comprise a MASS system.

The MASS naming and directory service provides application developers with a common mechanism for accessing and managing the resources of the system. The naming and directory service may be based one existing naming and directory services, such as X.500 and LDAP. X.500 is the CCITT standard for directories, and the Lightweight directory access protocol (LDAP) is a specification for a client-server protocol to retrieve and manage directory information. LDAP is designed so that a client using TCP/IP protocols interacts with a single LDAP server which, in turn, interacts with one or more X.500 servers via OSI protocols on behalf of the client. It can also be used with any other directory system that follows the X.500 data models.

Notification Generation

A notification event is a record of an event occurrence within MASS, persisted in a non-volatile storage medium. The details stored can be used to generate audit trails that can aid in the isolation of problems that occur within the system. In MASS, notification events are handled in a consistent manner. The reporting of a notification event is handled via the notification event service.

TABLE 38
Notification Generation Use Cases

Title
Maintain Notification Event Configuration
Generate an Alarm
Purge Notification Event Log Entries

Notification Event Types

Within MASS, there are four types of notification event. The design of the notification event system is such that different types of notification events can be created on a project by project basis.

The notification event types are:

(a) data audit

(b) operational

(c) security access

(d) exception

Capturing Notification Events

All notification events are identified in individual use cases. This provides an indication of the amount of logging that will occur in MASS and associated details such as alarm generation. This information also provides the generation of a notification event categorisation tree.

Levels of Severity

If the type of notification event generated requires a level of severity then these are identified in the use case and are part of the configuration entry. The current severity levels are as follows:

(a) Low severity. This type of notification event has minimal impact on the system operation and the application is able to correct the condition and continue processing.

(b) High severity. This type of notification event will have a major impact on the system operation. An application may or may not be able to recover from this type of notification event and therefore may not be able to resume processing.

Internationalisation of Stored Logs

The internationalisation of exception event logs allows text description strings to be stored in a non-English language. If English is not the primary language used to store the event log, then a second English text description will also be stored with the log. This allows the viewing of the logs to have access to both English and non-English versions of the text string describing the log entry.

Notification Events

When a notification event occurs, the details are passed to the notification event interface with a unique categorisation identification. The interface will also retrieve any additional details and pass this data to the notification event service. The notification event service will use the unique categorisation identification to locate a matching configuration entry and generate the appropriate log entry. The logging of notification events is configurable and has the ability to dynamically create text descriptions based on other languages. This configurability is achievable without the re-compilation of source code.

Notification Event Configuration

Details of logged notification events is configurable on a project implementation basis. Any notification event generated contains a unique notification event identifier that allows the event service to locate a matching configuration entry. The configuration entry contains information such as event text description, event severity, who to notify and the type of event e.g. User, System, Business, Alarm. This information is also used to confirm that the event information passed matches the event type specified. When the event notification is received, it contains a number of implementation specific parameters, which may be used to customise the event text.

The following is an example of an event to be logged by an application.

### EXAMPLE

GenerateExceptionEvent(EVENT_ID, m_objectName);

The configuration data might contain a format text string as follows:

### EXAMPLE

Database Write Failure While Attempting to Write <P>

When this is assembled, parameters passed to the event service construct a configurable text description that has added meaning. If the context of the message needs to be changed, then the configuration entry is changed and does not require the re-compilation of source code. The number of additional parameters passed to the generateExceptionEvent( ) function is unlimited and the parameters inserted into the configuration string one at a time. If no parameter is passed where one is expected, then this will be identified in the text description string.

### EXAMPLE

Database Write Failure While Attempting to Write (No Value Supplied)

The parameters passed in the generateExceptionEvent( ) call may be used in the text string either left to right or right to left depending on the language the system is logging. This involves use of an API to allow logging to be compatible with issues associated to internationalisation.

Alarms

Alarms may be generated due to a notification event's configuration data identifying a requirement to generate an alarm. This could be the result of either a critical exception or the result of a number of minor exceptions occurring. Any generated notification event can be configured to generate an alarm based on the configuration entry associated with the event. Alarms will always have a nominated role responsible for their acknowledgment. This role could be the System Administrator, the Device Manager or the Database Administrator. As these actors can vary from node to node, the event configuration entry will contain the user responsible for the alarm acknowledgment. However the node configuration may determine who and where the user resides within the network.

When alarm events are generated, a number of configuration parameters are used in order to determine the severity of the alarm and the actions to be taken. These parameter include:

(i) the role that the alarm is intended for;

(ii) the severity of the alarm;

(iii) the date and time the alarm was raised;

(iv) the location of the source of the alarm;

(v) a text description detailing the alarm;

(vi) whether or not the alarm is required to be acknowledged;

(vii) the time in which the alarm is to be acknowledged; and

viii) a nominated central storage centre node (if applicable).

The notification event service will then publish the alarm to the network and if the nominated role user is listening, an alarm notification will be displayed on their interface. An alarm also has a centralised storage centre, which generally will be a nominated processor such as the Service Provider. The centralised storage centre allows actors to review a summary of alarms from a number of sources e.g. station computers. The summary of alarms contains the current alarm status including whether the alarm has been acknowledged or cleared. The centralised storage area is best located on a processor that is running on continuously and is fault tolerant. The nomination of the centralised storage area may be configured on a node by node basis or associated with the nominated actor responsible for the alarm.

Life Cycle of Alarm Generated

When an alarm is generated, it is sent to the nominated role responsible as specified by the node generating the alarm. The alarm is also be sent to a centralised storage centre for storage and, if desired, review.

If an alarm remains unacknowledged after a timeout period, a callback procedure is called to perform any required secondary actions. The node that generated the alarm also keeps a record of the alarms it has generated. If the node detects an event that will clear the alarm, then an alarm clearing event is sent to the centralised storage centre to update the alarm status. This may occur in situations such as where an alarm is generated for a faulty device and a maintenance crew decides to decommission the device and take it away for repair. When the de-commission event is received, a check is made to determine if any alarms need to be cleared for this device. Not all alarms may be cleared automatically and therefore an alarm mechanism is provided to archive old alarms.

Security of Event System

The notification event system manages the audit trails of notification events. The system provides consistent logging methods such that:

(i) it is infeasible to bypass creating a log entry when a notification event occurs as the various sub systems will also be responsible for notification event generation;

(ii) it is infeasible for an authorised principal to create a false log entry;

(iii) it is infeasible to modify an existing log entry;

(iv) it is infeasible to delete an existing log entry prior to its expiration time; and

(v) access to the log entries must be suitably restricted depending on the sensitivity of the information contained.

Purging of Notification Events

As notification events are part of the audit process associated with the security of the system, the purging of notification events may remove traces of notifications that have occurred. Generally, audit logs are kept for a nominated period and cannot be removed until this time period has expired. Therefore notification events may have a nominated period of storage associated with them to prevent the purging of notification events prematurely.

Scheduling

The scheduler service provides the mechanism for the management of a set of scheduled actions for a MASS server or client workstation. A scheduled action is an action that can be configured to occur at specific points in time and recur on a specified basis. There are four types of scheduled actions managed by this service:

(i) Process. This scheduled action results in the running of a process, typically an implementation of a business process controller.

(ii) Transmit message. This scheduled action results in a message being sent.

(iii) Instruct service. This scheduled action results in an instruction being distributed to a named service.

(iv) Run report. This scheduled action results in a specified report being run.

The following use cases are associated with scheduling.

TABLE 39
Scheduler Use Cases

Title
Perform Scheduled Action
Maintain Scheduled Action

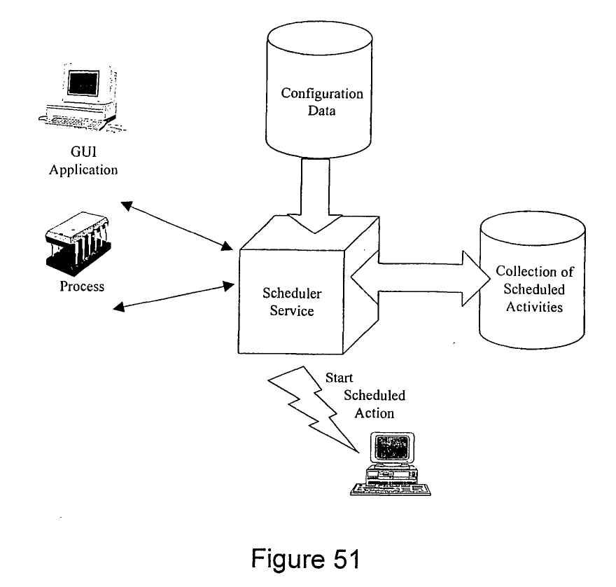

Scheduled action information is loaded in from a scheduled action configuration object, referred to as the scheduled action collection. When the scheduler service is started the scheduled action collection is loaded along with the last known state information for each of the scheduled actions. The service then searches for any scheduled actions that were not completed during the previous session and asynchronously re-starts them. Once these initial actions have been started the service will fall into a process loop. In this loop the scheduler will, amongst other housekeeping tasks, monitor the system time in respect to the scheduled actions and start them as they come due, as shown in FIG. 51.

Scheduler Service Configuration

The scheduler service uses service configuration data stored in a system configuration registry to determine its workflow specifics. The information loaded from this registry includes:

(i) Base scheduler loop time. This is the maximum time the scheduling service will wait before performing service administration tasks or performing a scheduled action.

Maintaining Scheduled Actions

This section describes the process involved in the maintenance of the scheduled action configuration data used by the scheduler service for managing the running of scheduled actions.

Once a user has logged into the process they may perform the following actions:

(i) Create a scheduled action. This action creates a new scheduled action entry and adds it to the collection.

(ii) Update a scheduled action. Allows the user to edit and update a scheduled action entry.

(iii) Delete a scheduled action. Allows the user to remove scheduled action entry.

The information contained in a scheduled action configuration entry could be:

1) Scheduled action type. The type of scheduled action to be performed: run process, transmit message, instruct service, run report.

2) Scheduled Action State. Contains the current state of the scheduled action.

3) Period between execution. The period the scheduler service waits before re-executing the scheduled action. This is mutually exclusive to execution start time (below).

4) Execution start time. Mutually exclusive to period between execution (above). Specifies an exact date/time for execution, i.e. on a given date at a given time, or every Friday at a given time, etc.

5) Maximum execution time. The maximum time interval in which the scheduled task should complete.

6) Enabled/disabled. An indication that the scheduled task has been enabled or disabled.

Performing Scheduled Actions

This section describes the process involved in the management of the scheduled action collection in respect to scheduling and running the actions.

At the start-up of the scheduler service, the scheduled action collection is loaded from the scheduled action configuration object along with the collection state information. Following this, the scheduler service will move into a process loop. In this process loop, the primary task is to determine which actions are due to be run. If a specific scheduled action has not completed processing before the next scheduled occurrence, it is left to complete, unless it has exceeded its maximum execution time, in which case alarm activities ensue. Where a task has exceeded its maximum execution time, the task will not be recovered or restarted. When each scheduled action is started the next execution time for the action is calculated and tagged to the action.

Security for the Scheduler

The scheduler creates audit trails to acknowledge the receipt and transmission of all messages in context. For example, the scheduler will log the fact that it has requested the launch of a scheduled task via the service manager, and that scheduled tasks have completed. The scheduler will also log significant procedural events. The scheduler also logs exceptional events.

Security Toolbox

The security toolbox provides an array of low-level cryptographic functions dovetailing with a sophisticated key management system. The toolbox provides the tools for the verification of data integrity, authenticity, privacy and nonrepudiation. Specifically, support is provided for encryption and decryption (asymmetric and symmetric), message digest generation and verification, digital signature generation and verification, and the generation and verification of message authentication codes. The key management system allows for secure and flexible maintenance of the cryptographic keys used within a MASS system.

Cryptographic Services

The toolbox provides a set of algorithms which is highly extensible, yet sufficient for a wide range of applications. The algorithms are implemented through a succinct API, masking myriad implementation details. The toolbox provides cryptographic services using either a hardware module or a software equivalent. This detail is hidden from the user by an API internal to the package, which is configured to use an appropriate security engine required for a specific application. The software engine is loaded completely within each client's process space, while the hardware version is implemented through a client-server architecture. In the latter scenario, the client process performs all non-cryptographically sensitive operations, and calls the server for sensitive operations. The server cooperates with the clients in arbitrating between multiple service requests. A hardware cryptographic engine provides highly secure key storage and cryptographic operation, but will most likely be slower than the software implementation. Thus contention arises between providing speed and providing security. The toolbox provides the two extremes of this scale with the software and hardware incarnations. Several variations of each of these implementations is possible, such as using the hardware module for secure key storage alone, while client processes perform cryptographic operations, storing keys in volatile memory only. Such an implementation may be faster than the hardware module alone, but is less secure. Such tradeoffs need to be made on a per project basis. The toolbox design allows for such changes to take place without affecting the code of dependent packages.

Service Utilities

A Service Manager subsystem starts up the Services at Processor boot time for each processor and it is responsible for managing the operational Service requirements and stopping the running Services upon processor shutdown.

Service Manager Features

Externally, Service Manager exposes an interface to provide Management Clients, namely the Service Management GUI, to start, stop, suspend and resume Services. Internally, the Service Manager tracks Service Configuration sets in CD, and determines what services should be running.

Processes are viewed as containers of Services. The Service Manager starts up processes, on a need basis. If the process for a Service is already running, only a signal to the process to start the service is required. The Service Agent within each process provides the proxy handling for that process, it directly manages the Service.

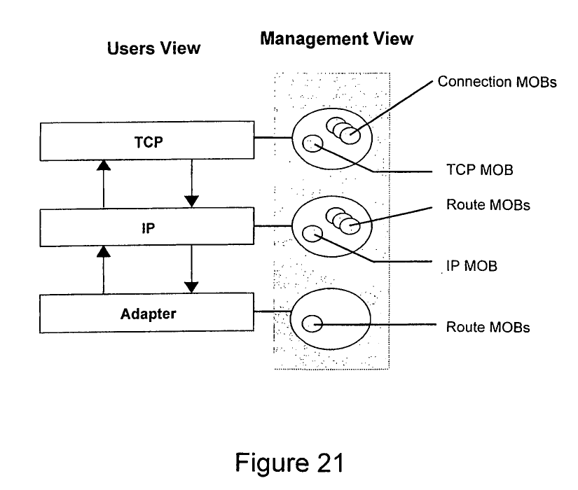

Service Manager is responsible for presenting Service state. This presentation is through managed objects from Management Infrastructure. A Managed Object (MOB) is a collection of managed attributes that describe the management functionality for a resource. The different types of MOBs, and their relationship to the different process layers, is shown in FIG. 21. A Service Management GUI will observe the managed state objects and represent them graphically. Any other programs requiring to monitor Services and Service states can also subscribe as observers to these managed objects.

Service Manager employs an Event Timer Task class to monitor asynchronous events such as Service state changes and heartbeat monitoring. Service viability is monitored by heartbeating. Signals are directed to Service Agents, Services and acknowledgments are expected back. Failure to do so within the specified timeout invokes logged notifications to be generated and GUI service states to be tagged as failed.

Service dependencies are modelled in the Service configuration. If one service has a requirement on another then this is defined in the configuration. If a Service is required to be started, its dependants will also be started. Similarly if a Service is to be suspended or resumed its dependants will also be suspended or resumed. This is regardless of whether the suspension is processor or business based. Service stoppage causes dependants also to be stopped, suspended. These dependencies are represented in the Service Management GUI, so that an administrator can interpret the dependencies configured.

Service Agent

The Service Agent performs the Service Management duties within a Service Process. These duties are to:

(a) Instantiate and initialise the Service factory.

(b) Advise the Service of impending state changes through the base Service class.

(c) Monitor Service viability.

The Service Agent is automatically instantiated and initialised at process startup. It operates through instruction from the Service Manager and ultimately terminates when all Services within the process have stopped.

The Service Agent maintains an communication session with the Service Manager. Commands are issued through the communication connection, acted upon by the Service Agent and responses are sent back to the Service Manager. The state of all the Services within the process are tracked and updated on Service state changes. The thread details related to a Service are made available so that suspension, resumption and enforced thread termination are performed. Service Agent also handles notifications from Services. If the service pre-empts a state change such as auto-suspension of business processing, it notifies the Service Manager of the new Service state.

Service heartbeating is also classed as a Service Notification. Services regularly signal their viability in the form of a heartbeat notification to their Service Agent. If the notification is not received within a specified period, the Service Agent either re-starts the Service or just togs a failure notification, depending on the Service configuration data.

MService is provided for use whenever a subsystem is required to be under the direct management of the Service Manager. This is a subsystem that is not instantiated by another subsystem but rather is considered as an independent processing element in its own right. MService provides service side functionality. It provides background heartbeating as well as a co-operative command structure for use between a service and the service agent that issues the commands. The relationship is co-operative in the sense that if a command is issued to suspend a service and the service responds negatively to the request, then the issuer of the command will be advised of the command failure and the service will not be forced to suspend. The MService base class is also a placeholder for the service's IdentityToken as well as the service's identification details. These attributes are passed to the service during the service's creation. It is also responsible for the generation of applicationID's used for communication connections. The MService base class is also able to provide an interface to allow:

(a) Datastore creation and retrieval

(b) PSS gateway creation and retrieval

Services inherit from the MService base class. The MService class contains a number of attributes required to provide background service heartbeating. When a service is created via the inheritance of MService, the following occurs:—

(a) Service overrides all virtual operation calls. Although the compiler will force this issue, the service decides how it will respond to the co-operative command operations when they are called by the ServiceAgent. If a service does not need to perform any specific work as a result of the operation call, it may simply choose to return true or false where appropriate.

(b) Service respond to failure management commands. A service responds appropriately to Failure Management commands that are issued to it. If a service does not respond to the Failure Management commands correctly, then the operation of the processor could be compromised

User Interface

The user interface application framework is a toolkit for application development. It does not specifically conform to the notion of a sub-system with interfaces and factories. Where there is significant inherent complexity to a package appropriate use of a facade and hiding is employed. This section describes specific elements and the generic applications relying on this framework plus a number of GUI components that have been developed to support the generic components as well as other applications built by for projects.

TABLE 41
Application Framework Use Cases

Use Case Title
Log-on To System
Log-off From System
Verify User Permissions
Maintain User Account

The framework, GUI components and generic applications:

(a) minimise the number of applications needing to be built to deliver an operational system;

(b) minimise the amount of application specific code to be developed to support general requirements including internationalisation and interaction with the server; and

(c) enforce a degree of consistency in application development and behaviour.

Implementation on the client is predominantly coded in Java.

Commands

A toolkit for commands is provided to:

(i) simplify the implementation of actions within a graphical user interface application;

(ii) provide a general solution to enable actions to operate over one or several selections in the same manner;

(iii) present an easy-to-use facade for application developers to work with providing useful default behaviour for a typical application. Allow further functionality by interaction directly with supporting classes;

(iv) guarantee a command (appearing in possibly more than one command context) is executed only once;

(v) integrate access control features to:

(a) Display an action only if the user has the permission to generally perform the action

(b) Enable an action if at least one of the currently selected objects in focus to support the command and the user has the permission to execute the command. Disable it otherwise.

(c) execute a user requested command on any currently selected objects in focus that either support that command, or the user has the permission to execute that command.

Specialisations of add methods for JMenu, JPopupMenu and JToolBar are provided to ensure that menus and tool-bars contain images and/or text as specified for an application.

This toolkit establishes the following:

(i) Command

(ii) Command Type

(iii) Command Set

(iv) Command Context

(v) Action

(vi) Commandable objects

(vii) Commandable types of objects

A command is an action that may be performed on an object, referred to here as a Commandable object. Commands typically manifest themselves in the form of menu items, buttons, button bars and so on.

A Commandable object is an abstract concept defined by way of an interface. It can therefore be anything material to an application, which implements the Commandable interface. A commandable object in the following example is the card entitled CC.

The framework can support numerous application defined types of commandable objects. Cards would all be things of the type ‘CARD’. Every thing that is commandable must be of a commandable type. It is the commandable type that defines the types of commands which can be performed on things of that type.

A command is reflected in the user interface according to its type. Each command type has an identity/key used to obtain a localised string (for menus and on buttons) and/or an icon (for tool-bars and on buttons) which client applications may use to build a GUI. Client applications can request such Action objects from this framework.

Localised strings and file references are maintained in property resource bundles, maintained by administrators. Using the bundle naming scheme, such a key would be resolved by checking either the application bundle for the key, or the general bundle.

If the key is not found then:

(a) For string requests: the relative key (the penultimate token in the string) would be returned,

(b) For image requests: a default icon would be returned.

In addition if the file containing the external resource, such as the image, is not found then a default resource is returned.

For convenience and to support generic applications, this framework defines certain command types. Examples include ‘Insert’, ‘Edit’ and ‘Delete’. Applications may define new command types or reuse existing command types as appropriate.

This framework supports the notion of a command set, being a logically related set of command types. There are a number of pre-defined command sets used by generic applications. Using this framework, an application may populate tool-bars and menus and pop-up menus with command sets. In a tool-bar, it maintains additional space between command sets. In menus, it inserts a line between each command set.

To present application specific menu items and tool-bar buttons, an application may define its own command sets and associated command types. These are associated with a commandable type. Developers define and ensure a correct mapping to the associated text and graphical resources for new command types. The resources may be defined as either the application specific property resource bundle, or the general property resource bundle.

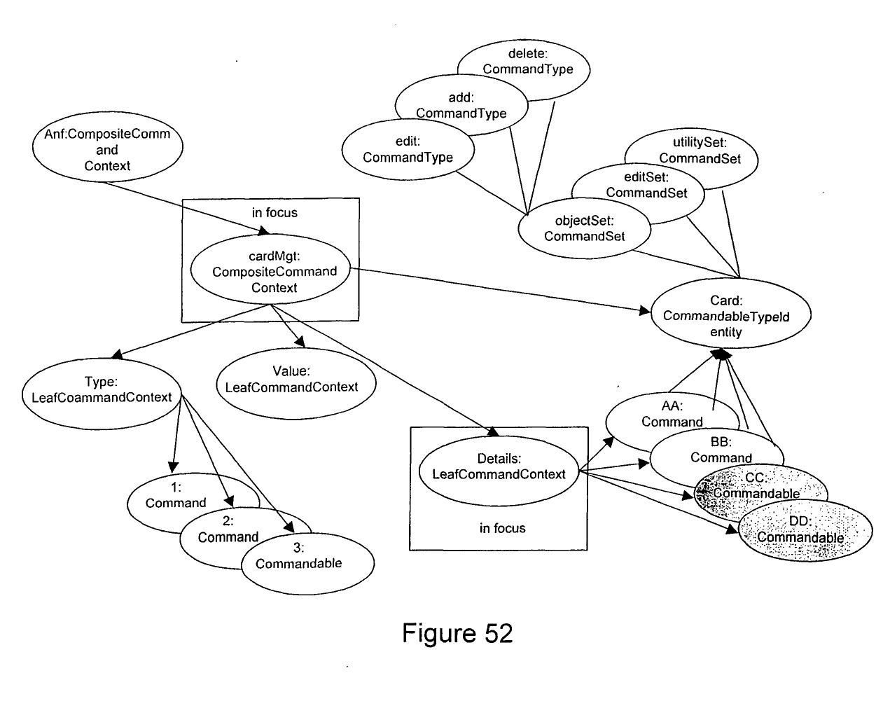

A command type has a many-to-many relationship with a command set and so may be presented in a variety of ways to users. Part of the command set implementation for card management is shown in FIG. 52. Command types may be overloaded within the application to perform similar operations on different types of managed objects. The actual meaning of a command is implementation specific, however, the intent is that overloaded commands should perform logically similar operations. It is counter-intuitive to call a ‘suspend user’ action ‘Delete’ for the sake of not defining a ‘Suspend’ command type.

Given that command types are overloaded and form the basis of the actions presented to users, it is important to define the set of commandable objects against which an action is intended to be performed. This framework provides the notion of a command context for this purpose. A command context is a collection of commandable objects as perceived by the user. To support this, the application developer registers commandable objects with a command context.

It is the command context from which Actions are obtained that defines which commandable objects will be called upon to perform a command type. The framework calls upon commandable objects to execute a command type if the:

(i) commandable object is referred to in the command context or a child context;

(ii) context in which the commandable object is referred is in focus;

(iii) commandable object is selected;

(iv) commandable object supports the command type; and

(v) user is permitted to perform that command type on the commandable object.

For example, tab panes in Card Management each represent a separate context. In this instance, pressing the Delete button on the Details pane should only affect selected cards within that pane (as defined by the Details pane command context).

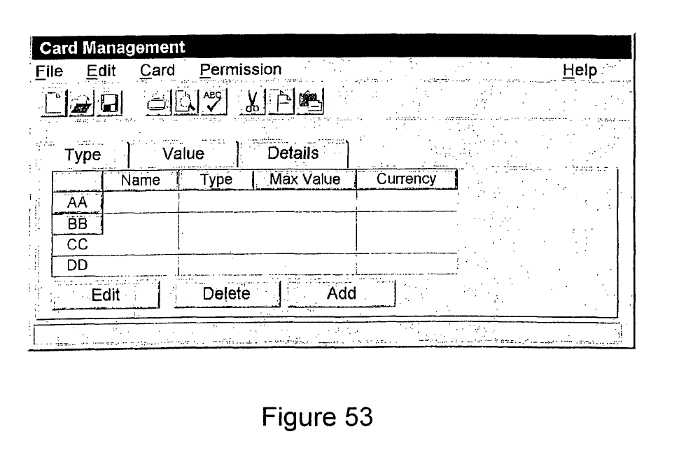

Commands associated with menu items and tool-bar buttons should also only affect the context in focus as perceived by the user. In FIG. 53, they would again be the cards selected in the Details pane. It is possible however that commands for the overloaded ‘Delete’ command could also include references to managed objects exposed in the Value and Type tab panes. Hence, the scope of such commands may actually exceed the context which is currently in focus, i.e. the action context (the set of all managed objects for menu items and buttons) may span across several command contexts. This framework therefore supports the notion that one context may support several sub-contexts. Whilst a (parent) context may be associated with several (sub) contexts, it should only execute commands within (sub) contexts that are ‘in focus’. To facilitate this, the developer is provided with command contexts that support the composite design pattern.

The application may elect to ‘self-manage’ a pool of commandable objects. A self-managed pool would present itself to the command framework as a single managed object by extending the abstract CommandableCollection class. Such clients conform to the requirements for access control. Otherwise each atomic managed object is managed by the command framework and will require the managed object to properly implement its getId( ) and get Type( ) methods. The abstract CommandableEntity class is specialised for this purpose. The command framework listens for state changes in commandable objects to determine when to disable and enable menus. The framework relies on ‘enabled’ event notifications from commandable objects in order to determine if at least one managed object can presently execute supported commands. If no managed objects support a command then that command will be disabled.

Security Framework for User Interface

The following general security feature apply:

(i) The system shall authenticate all users wishing to access the system.

(ii) A user who does not interact with system within a configured period of time is locked out of the system. The system prompts the user to enter their password i.e. verify themselves to the system again.

(iii) The system verifies the user's right to perform privileged commands upon resources. A course-grained permission allows a user to perform a particular command across a broad type of resource. Whereas, a fine-grained permission specifies a particular resource with which a user can execute a particular command.

(iv) If no coarse-grained permissions are specified for a particular user or group of users then the system acts as if all users have had this permission denied.

(v) If no fine-grained access control exists then the system acts as if all users have been denied this permission.

(vi) If a permission is granted, the system makes available an action (which can be linked to a menu item or button in a particular context, e.g. within a tab pane, at the application developer's discretion) that will trigger the permitted command upon selection.

(vii) In practise, the system enables such an action only if the user has selected at least one resource that permits their performing the action for the resource selected.

(viii) The system supports a naming scheme which allows a single permission to be specified that either grants or revokes:

(a) Every operation on every instance of every type of resource.

(b) Every operation on every instance of a specified type of resource.

(c) Every operation on a specified instance of a specified type of resource.

(d) A specified operation on every instance of a specified type of resource.

(ix) A permission includes three elements (strings) representing:

(a) resource type

(b) instance identifier

(c) operation type

(x) An explicit permission overrides a wildcard permission where both are specified at the same level.

(xi) Permissions are verified according to an exact match on managed object type, instance identifier and command type or, in the case of a wildcard, an automatic match on this component of the permission definition.

(xii) Coarse-grained access controls are defined with a Resource Type=‘RESOURCE’; and an Instance Identifier matching the name of the resource type, e.g. ‘CARD’, ‘APPLICATION’, ‘PURSE’.

(xiii) Fine-grained access controls are defined with a Resource Type matching the name of the resource type, e.g. ‘CARD’, ‘APPLICATION’, ‘PURSE’; and an instance identifier which is a resource type defined string.

(xiv) A resource type is responsible for ensuring the uniqueness and long life of instance identifiers within their name-space.

(xv) Operation type is resource-type specific. It is used in the coarse-grained and fine-grained access control definitions to imply granting or revoking the right to perform this command on this type of resource and this instance of the resource respectively. The name of the operation type need not be unique, and should be shared where its meaning is consistent across different contexts.

Without the right to perform this command on the type of resource type there is an implied inability to perform that same command on this instance of the resource.

(a) Operation (or command) names will be used in conjunction with the naming scheme for Internationalisation to provide localised variants of text and graphical resources in actions to the user.

Manual operations utilising the services of CRUD satisfy the following permission management requirements:

(i) Given a user Id, identify and delete permission associations and, where applicable, the permission;

(ii) Given a permission, get the users granted or denied that permission, delete those associations and delete the permission;

(iii) Dissociate a user from a permission;

(iv) Associate a user with a permission;

(v) Revoke a permission for a user;

(vi) Create a new permission.

The format of the naming scheme for describing permissions is as follows:

<Resource Type>.<Instance ID>/<Command Type>

where:

(a) <Resource Type> is the designated type of object upon which a particular set of operations will be executed.

(b) <Instance ID> is the unique attribute pertaining to an instance of each instance of the resource type.

(c) <Command Type> represents the name of a command supported by the particular resource type.

The scheme allows for two forms of permission, described by way of an example:

(a) Coarse-Grained. An application that deals with Card objects allows for a ‘Delete’ operation and controls execution of this via a suitable UI control e.g. a menu item. At the point of assembling an interface, the application performs a check that the current user has the permission ‘RESOURCE.CARD/Delete’. For a user without the permission to delete a Card object, no Delete menu option would be created. For a user with the permission, a Delete menu item would be added to the edit menu that may be enabled or not depending upon the following.

(b) Fine-Grained. Assume that the user has the coarse-grained permission to delete cards. An application would enable a Delete menu item that pertains to deleting selected cards if that the user has selected one or more cards in the current context and has the permission to delete at least one of these cards. Another scenario might see that a user selects a card with a Card ID of CID000111. The Delete menu option will be enabled if no permissions of the form ‘CARD.CID000111/Delete’ have been revoked since the user has the coarse-grained permission to delete any card.

In the case of self-managed resource collections, it is the responsibility of the application programmer to handle the case of multiple selections within such data ‘views’ e.g. a list view, and their effect on those UI controls e.g. buttons backed with actions like ‘delete’. The following is made available in accordance with the proposed naming scheme, to allow maintenance of permissions and verification of specific permissions on an ad-hoc basis.

bool checkpermission(IDToken userId, MString object, MString objectID, MString operation);

where:

| | |
|---|---|
| UserId | the caller's identity token |
| Object | the generic type of object on which the permission is |
| | being checked, eg ‘card’, ‘file’ |
| ObjectID | the specific object (may be blank, or ‘*’, which implies |
| | ‘all’) |
| Operation | the operation being requested (may be blank, or ‘*’, |
| | which implies ‘all’) |

For example,

checkPermission(userId, ‘card’, ‘*’, ‘*’);

Reads ‘can userId do anything to any card?’

checkPermission(userId, ‘file’, ‘c:\ntloader.sys’, ‘delete’);

Reads ‘can userId delete ntloader.sys?’

checkpermission(userId, ‘security:certificates’, ”, ‘create’);

Reads ‘can userId create a certificate?’

checkPermission(userId, ‘security:certificates’, ‘ERG’, ‘delete’);

Reads ‘can userId delete ERG's certificate?

Internationalisation

Images and text to be displayed to the user are localised, and resources localised include:

(i) Messages

(ii) Labels

(iii) Tool-tips

(iv) Mnemonics

(v) Icons

If the text, icon or other localised resource cannot be obtained from its source then the system shall provide a default, and generate an error log message. The framework provides a single point of access to localised resources which may be modified to access server-side resources. File names, for icons and other file type resources are not referred to directly in the code. The naming directory service is in place to cater for the correct identification of various objects within a graphical user interface. Examples of objects that require unique identification within an application are visual controls such as text fields and tables, buttons and menus that perform specific operations and various messages. Some objects within an application will require identification, but not necessarily in a unique sense. Some examples would be OK and cancel buttons, messages/prompts such as ‘Are you sure you want to delete the selected object(s)?’.

The use of an internationalisation class allows easy access to localised resources for use within an application. Resources are provided on the basis of the currently specified locale for the user. Based upon the Naming and Directory Service an application may specify application specific or general keys by which to acquire resources. The application specific naming scheme assumes a dot notation naming format of the following form.

<BundleName>“.”(<context“.”)*<defaultName>

where:

<BundleName> is the name of the property resource bundle which must not be ‘general’ and should otherwise indicate the name of the application.

<context> is any application specific contextual information to assist in managing resource bundle entries.

<defaultName> is the name to be used for text resources in the event that a resource could not be found. If required, the defaultName will be returned with underscores replaced by spaces.

### EXAMPLE

```
Public myFrame(...)
{
...
    goFlyButton.setName(‘myApp.myFrame.Go_Fly’);
    closeButton.setName(‘Close’);
...
    goFlyButton.setText(i18n.getText(myButton.getName( )));
    goFlyButton.setIcon(i18n.getIcon(myButton.getName( )));
    closeButton.setText(i18n.getText(closeButton.getName( )));
    closeButton.setIcon(i18n.getIcon(closeButton.getName( )));
...
}
```

From the above request and in accordance with a current ‘Australian English’ locale, the internationalisation class would know to retrieve the ‘myFrame.Go_Fly.TEXT’ and ‘myFrame.Go_Fly.ICON’ resources from the ‘myApp_en_AU.properties’ resource bundle. In instances where a requested locale is not available, the internationalisation searches for the nearest match. Specifically, ‘myApp_en.properties’ may be the closest match for the locale's language. Failing such a file's existence, the default resource bundle would be used—in this case ‘myApp.properties’. If the requested property could not be retrieved for the getText( ) request, the string ‘Go Fly’ would be returned and an error message logged.

In the case of the closeButton, the internationalisation class would seek to obtain resources for the key ‘Close’ from the general_en_AU.properties file. It's processing otherwise is as above. Implementations may maintain server-side pools of resources and client-side caches. A server implementation establishes whether an object in the pool affecting a specified locale has changed and notifies the client accordingly so that the client may flush its current set of resources and read them again from the server.

Metadata

This element provides a swing component that displays, in a tree structure, information describing the objects, their attributes and associations. The user is provided with facilities to be able to select elements. This component provides a tree selection model that accepts listeners (applications) and notifies them of changes in the selection model. It interfaces with a facade that provides this metadata. This facade provides methods to perform the following:

(a) Access a list of all managed object types

(b) Access the names of attributes for a managed object type

(c) Access the names of associations and important characteristics about such associations, e.g. multiplicity.

The MetaData Interface allows retrieval of metadata pertaining to the business objects and their attributes from the server. A graph of classes and associations is defined by this interface to include MASS managed object classes only. Terminating nodes are Java classes and Java native types. This interface may be used by applications to query class names, attributes of classes and the multiplicity of such associations.

JNDI

The system supports standard file operations (in addition to those already specified under FileDialog) via the MASS naming and directory service. To maintain a standard interface to naming and directory services, the Java Naming and Directory Interface (JNDI) is used. JNDI is designed to be able to delegate to various services to provide a standard view over all services. For the purposes of MASS, JNDI sits over MassNDS, NotificationGeneration and MASS Security. MASS Naming and Directory Service is accessed via a Java Native Interface.

MassNDS supports a content type for serialised objects enabling the storage and retrieval of objects. Developers implement Java classes to store or retrieve via this mechanism.

Undo Redo

Support is provided for object level undo. That is, the ability to revert an object back to the state in which it existed prior to editing. This support is provided at the GUI level in addition to object level. This is integrated with commands such that previous states may be stored. Within swing components such as text editor panes, use is made of existing facilities to support undo and redo. The command framework, working in conjunction with managed objects, maintains a collection of mementos such that it is possible for the user to perform undo and redo operations.

Printing

A printing interface for an application is provided at the component/control level (i.e. context sensitive). This is initially activated via a ‘Print’ dialogue.

Application Interfaces

CRUD (Create Read Update Delete) provides support for the following additional types of editors:

(a) List

(b) Combo Box

(c) Radio Button

(d) Spin button

The CRUD application is adapted to be able to use the persistence Query language, so that queries can be specified by the user, if required. The CRUD application integrates with the new Command framework. CRUD commands are driven by javax.swing.Action instances. The following editor classes are added:

(a) List—List of possible values

(b) Combo box—List of possible text values, with the option to type in some other value

(c) Radio button—Control where one of two possible values must be chosen

(d) Spin button—Control where a numeric value may be entered as text, or incremented/decremented using buttons

ANF

ANF ensures that only authenticated users can access the system. If there is no current user logged on, ANF ensures that a user is forced to login prior to accessing applications within the ANF.

ANF provides a facility for the user to log out in which event, all open applications are closed and the ANF removes access to all applications that the previously logged in user had access to (according to their privileges). Profiles are CD based and thus require the use of the Configuration Data sub-system to retrieve the following as part of a user's profile:

(a) List of applications each of which contain:

(i) The Id of the Application (unique key)

(ii) Name of Application (displayable)

(iii) Iconic representation (32×32) (displayable)

(iv) Class name (canonical form) e.g. mass.base.core.MTime.class (form suitable for direct reflection)

(b) Inactivity timeout period (min. resolution secs)

ANF uses the command framework to launch applications.

The system provides the following user interface components:

(a) Parent ANF Frame to provide a UI context for managing applications

(b) Views (using Command Framework):

(i) Tree view

(ii) Button bar view

A user's username/password is captured via a login dialogue of the interface. The Authentication and Authorisation Service provides the security framework within which to perform this capturing. The framework allows project teams to develop and plug in addition authentication services (e.g. launch a fingerprint capturing dialogue). A standard username/password combination is provided for in a standard modal dialogue box. Management of the inactivity timeout may be done via a separate thread monitoring mouse/key input within the top-level ANF frame (since all mouse events logically delegate through it) and counter resetting.

The Command Framework establishes an initial application context by presenting actions for applications that the user has the permission to run. That is, if a user has permission to run an application, the application will exist in the tree view, button bar and other UI controls from which the application can be run. The ANF's context is the ancestor for all other application contexts and is normally always in focus (unlike individual applications that must handle changes in focus).

Report

For the report writer there is provided the following:

(i) A simple GUI component that displays tabular data in a text format.

(ii) Can use the query sub-system.

(iii) Standard selection and copy operation.

(iv) Provide the user with facilities to save the report with data separated by a user-configurable character, allowing the standard formats of comma separated values (CSV), and tab-delimited.

(v) Provide the user with the facility to specify the report type.

The Report sub-system integrates the command framework.

A system administrator is able to define a number of report types. For a report type a System Administrator is able to define access controls.

The report viewer application is a graphical component that provides a means to view the report within a text pane. It contains menus for file operations and help. File operations integrate the file dialogue component and implement CSV and tab delimited file format save and read mechanisms. The Report Viewer is a simple Frame containing a text pane. The class has a method such as:

public void setData(Collection data);

This method can be used to set the data displayed.

Menu items or buttons will be included to set a query, and to save displayed data in various formats.

The Query Integration interface provides an interface to receive and display a result set.

GUI Components

Binding

Binding allows a user to display and/or edit a value held in a data object in a screen object. More over, it will typically be the case that a set of values will be treated as a single entity. An instantiation of binding has the following characteristics:

(i) A screen object is bound to an attribute of an object.

(ii) The representation in the screen object is determined from the value of the attribute in the object.

(iii) The representation in the screen object can be reset to the value in the attribute.

(iv) The value in the attribute can be set to the value represented in the screen object.

(v) The object instance that a screen attribute is to bound to can be changed, provided that the new instance is of the same class.

An important part of achieving this capability is the use of adaptors. Adaptors convert a value held in an attribute to and from the representation required by the screen object. Each adaptor provides a conversion service for a specific class (and derived classes) of screen object to data value classes that can reasonably be represented by the screen object. The adaptor to be used is determined by the binder based upon the class of the screen object and the class of the attribute in the object. This approach provides the flexibility to build adaptors for screen objects that are added subsequently.

It is useful to work with a collection of screen items as a single entity (given that the primary purpose here is to support the development of value editing and display of information). To this end a binding set is used. A binding set is a collection of bindings with certain coordinating operations that apply to the set as a whole. The operations supported are the same as that available on individual bindings except that they are applied to all bindings in the binding set.

While this could be done on a case by case basis by the application developer, a more general method reduces the effort, testing and maintenance and provides greater uniformity across the entire development.

Logondialog

The Application Navigation Framework requires a simple login dialogue to be presented to the user to allow authentication within the security framework. The design of the dialogue leverages an existing Java framework—the Java Authentication and Authorisation Service (JAAS). This framework provides a generic mechanism upon which to implement a variety of means of capturing user information and authenticating it.

The dialogue provides the default mechanism of capturing information from the user. Integrating the design with JAAS provides the opportunity to provide alternate mechanism of capturing information from the user. This uses an extension of certain classes from this framework, primarily a javax.security.auth.LoginModule and javax.security.auth.CallbackHandler. The dialogue also implements the javax.security.auth.Callback interface or can be wrapped with an adapter that does.

### Base Services

The lowest infrastructure level of MASS is the Base Services layer. The service packages include:

(a) Core Classes

(b) Operating System Abstraction (OSA)

(c) Serialisation

Core Classes

The MASS Core classes are grouped as follows:

(i) primitive data types

(ii) collections

(iii) maps (associative collections)

(iv) time

(v) money

(vi) exceptions

(vii) streams

(viii) run time class definition

Many of the core MASS classes are prefixed by the letter M. Examples include MObject, MString and MTime. The M prefix highlights that these are MASS specific versions of the more general Object, String and Time class names. This assists in reducing name space issues at both the programming and design levels. It also allows discussions between design and implementation personnel for projects to distinguish between MASS specific class concepts and generic class concepts. MASS core classes that are not prefixed by the letter M, such as the LocalPettyMoney class, have class names that are not easily confused with other non-MASS class libraries or frameworks.

Core Classes

Primitive Data Types

The primary supported MASS programming languages, C++ and Java, both include the concept of primitive data types in their language definitions. This section defines the primitive data types and the type names used in the MASS framework. Table 42 lists the supported primitive data types.

TABLE 42
MASS Primitive Data Types

| Model | Data | | |
|---|---|---|---|
| Type | C++ Type | Java Type | Comment |
| Integer64 | int64 | long | 64 bit |
| | | | signed |
| | | | integer |
| Integer32 | int32 | int | 32 bit |
| | | | signed |
| | | | integer |
| Integer16 | int16 | short | 16 bit |
| | | | signed |
| | | | integer |
| Integer8 | int8 | byte | 8 bit |
| | | | signed |
| | | | integer |
| Float | Float | float | Single precision |
| | | | IEEE floating |
| | | | point |
| | | | number |
| Double | Double | double | Double precision |
| | | | IEEE floating |
| | | | point |
| | | | number |
| Boolean | Bool | boolean | A data type that |
| | | | can only have a |
| | | | true or |
| | | | false value |

The model data type columns define what primitive data types can be entered in Rose, ie Rational Rose, a modelling tool by Rational Systems Inc. The standard Rose primitive data types Integer, Long and Short will result in error messages at code generation time. This ensures that the expected integer bit size is explicit in the model and the generated code.

The approach taken with the MASS UML model and C++ integer primitive types is to prefix the primitive type name with an integer label and suffix it with the size in bits of the integer. This approach highlights the form of integer a programmer is dealing with. The facility for defining aliases for primitive data types is not supported in the Java language, hence the standard type names are used.

MObject

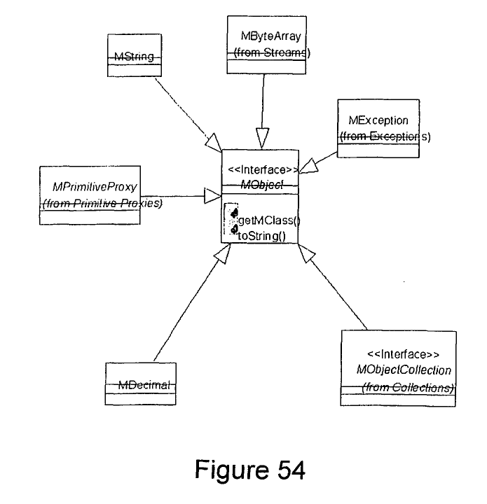

All classes that are to be able to be serialised or persisted via MASS implement the MObject interface. Because of this, the majority of the MASS core classes described herein implement the MObject interface. It allows the core classes to be members of any class that is to be serialisable or persistable. FIG. 54 displays a sample set of the classes that implement the MObject interface. MObject is fundamentally tied to the MASS Run Time Class Definition functionality described below.

The ability for the serialisation and persistence packages to be able to query an MObject at run time for its class structure information allows these packages to be run time (dynamically) oriented in their design. This has advantages in areas such as:

(a) run time mapping between objects and a relational database schema

(b) run time handling of serialisation format and version control issues

For implementation with the Java programming language, MObject is a Java interface. For C++ implementation, it is an abstract base class that persistable or serialisable classes are required to inherit from and over-ride.

A class that implements the MObject interface can be instructed to:

(a) Return an MClass instance, which describes the class structure and MASS specific settings within the class structure at run time.

(b) To place a representation of itself into an MString. An MString is a string of Unicode characters and hence can be displayed to users.

If a class is marked as serialisable and/or persistable, then there is no need to explicitly implement the MObject interface since the MASS Code Generation functionality will automatically generate code that states the class implements the MObject interface.

MString

An MString class is a sequence of Unicode characters of arbitrary size. All strings within MASS should be represented as MString objects to ensure MASS applications are internationalised. For the MString class:

(a) For Java implementation, it maps directly to the standard java.lang.String class. This is because the standard Java string class is also a sequence of Unicode characters.

(b) For C++ implementation, a concrete MString class is available. It inherits from both the MObject class and the UnicodeString class. The UnicodeString class is part of the IBM Unicode Classes for C++.

(c) It is treated as a primitive by the MASS serialisation and persistence packages.

For C++ development, the MString class should always be used in preference to the standard byte oriented string class.

MDecimal

An MDecimal class is a representation of a fixed precision and size decimal value, where the precision is defined at run time. Decimal values are a useful replacement for floating point numbers whenever fixed numeric precision and calculation accuracy is needed. The C++ implementation implements operator overloading for all applicable arithmetic operators, so calculation code that uses the MDecimal class is very readable. For Java implementations, the MDecimal class extends the standard java.math.BigDecimal class and implements the MObject interface.

Collections

The MASS Collections package is built on top of the following standard collection/container frameworks:

(a) The STL Container framework defined in the C++ Standard.

(b) The Java 2 SDK Collections Framework.

The MASS Collections package meets the needs of two distinct forms of software:

(a) Application software, which deals with specific instances of application classes. It is beneficial that application software deals with collections in a type safe manner. This allows errors such as attempting to place an object of the wrong type into a collection or incorrectly down-casting to retrieve an object from a collection from occurring.

(b) Internal MASS packages, such as Serialisation and Persistence, which need to work with collections of objects in a generalised fashion and deal with a significant number of implementation issues at run time as opposed to compile time.

The MASS collections framework functionality extends the STL container functionality and retrofits it with an MObject based interface using the C++ template functionality. This allows general purpose packages such as serialisation and persistence to access the STL container contents without being explicitly linked at compile time to the class of the collection or the collectable.

Mass C++ Collections

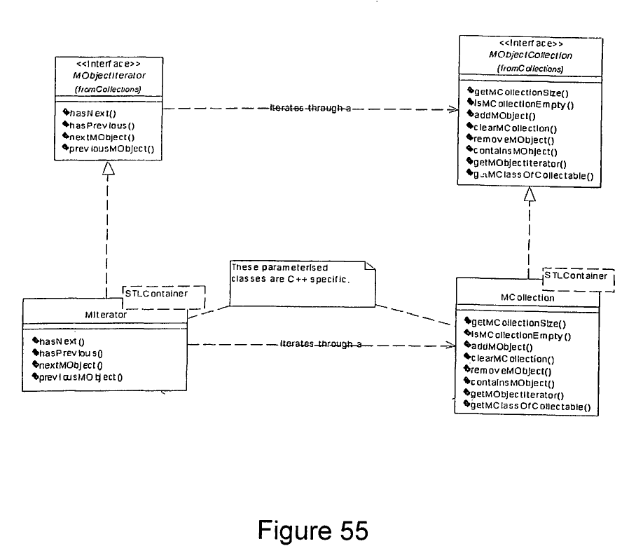

FIG. 55 illustrates how the MASS framework retrofits STL containers with an MObject based interface. The MCollection and MIterator parameterised classes perform the retrofit action at compile time.

The MObjectCollection class is an interface class that defines operations, which allow packages such as Serialisation and Persistence to deal with MASS collections as collections of MObject instances. Similarly the MObjectIterator class is an interface class which iterates through an MObjectCollection.

The use of the MObjectCollection and MObjectIterator interface classes is relevant for packages that need to be able to interact with collections of an arbitrary MASS object at runtime. Examples of such packages are serialisation and persistance. There are also areas in Network Management, Device Management and generic GUI tools which need to deal with collections of arbitrary MASS objects at runtime.

The parameterised types MCollection<C> and MIterator<C> define operations, which allow application programs to deal with MASS collections as collections of specific application classes. The operations defined in these classes allow for type safe interaction with the collections and iterators.

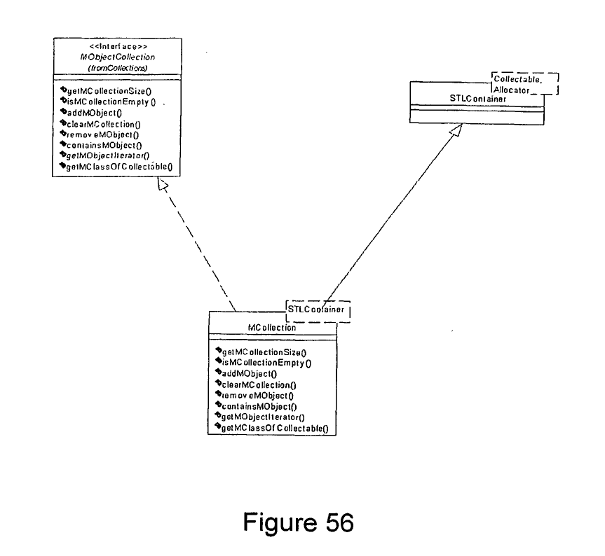

Multiple inheritance is used in C++ to achieve a seamless extension of the STL containers to support the MObject based interface. This is illustrated in FIG. 56. The STLContainer reference in the diagram applies to any of the STL container classes such as vector, list and deque. Instances of the MCollection<C> parameterised class support both the MObjectCollection methods and the standard STL container methods.

In addition to the MCollection and MIterator templates, the MASS collections framework includes the pointer based templates MPCollection and MPIterator. These templates are used when the STL container contains pointers to MObject instances as opposed to containment by value. Separate template specifications are required because of the need to consistently implement the MObjectCollection interface.

The MASS collections framework implementation in Java shall use a standard Java Collections framework approach.

Maps

The MASS Map package is built on top of the following standard map/associative container implementations:

(a) The STL Associative Container template classes defined in the C+Standard.

(b) The map interface and concrete implementations defined in the Java 2 SDK Collections Framework.

As is the case with the MASS collections package, the MASS Map package is required to meet the needs of two distinct forms of software:

(a) Application software, which deals with specific instances of application classes. It is beneficial that application software deals with collections in a type safe manner. This allows errors such as attempting to query a map with the wrong class of key or incorrectly down-casting to find an object in a map from occurring. Internal MASS packages, such as Serialisation and Persistence, which need to work with collections of objects in a generalised fashion and deal with a significant number of implementation issues at run time as opposed to compile time.

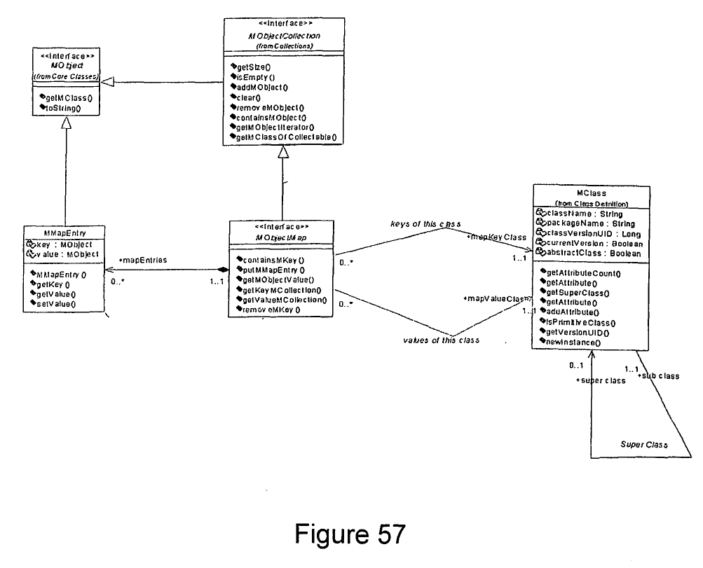

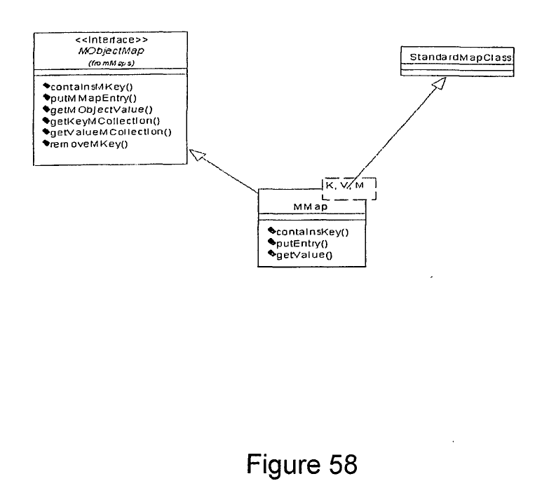

These requirements are met by the MASS map package by each map class implementing both an MObject based interface and a type-safe parameterised class map interface. This is structured in a similar way to the MASS collections package parameterised classes and is illustrated in FIG. 57 and FIG. 58.

The MObjectMap class is an interface class that defines operations, which allow packages such as Serialisation and Persistence to deal with MASS maps as collections of MMapEntry instances and as a mapping between MObject keys and MObject values.

The parameterised class MMap<K, V, M> defines operations which allow application programs to deal with MASS maps as mapping between keys of class K and values of class V. The operations defined in these classes allow for type safe interaction with the map. The parameter class M refers to a standard library map implementation such as map in the C++ standard library or HashMap in the Java collections framework.

Time

The MASS core time classes represent two basic concepts, a point in time and a time duration. The base class for points in time is the abstract MPointInTime class. Concrete versions of this class represent points in time measured to varying resolutions. The MDate class represents points in time measured to a resolution of one day. The MTime class represents points in time measured to a resolution of one millisecond.

Time classes of alternative resolutions may be used. Examples include time measured to an accuracy of one second or one microsecond or of arbitrary accuracy. The MASS core classes are limited to day and millisecond accuracy choices as these fit the envisaged requirements for MASS projects. Applications that only require a resolution of one second should use the MTime millisecond accurate time class. It provides more than the required resolution with minimal additional memory resource costs.

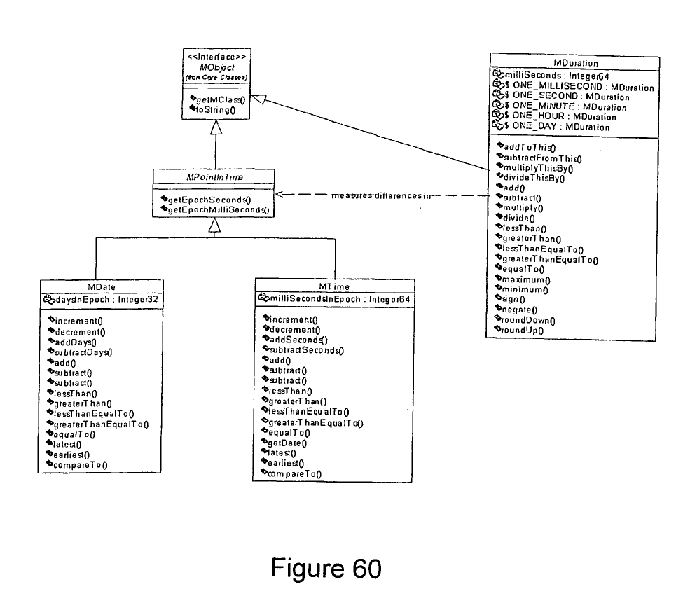

Both the MDate and MTime class include operations, which allow time and date arithmetic to be performed. The MDuration class represents a length of time. It also includes arithmetic operations, but these operations are specific to time durations as opposed to points in time. FIG. 60 shows the relationships between the core MASS time classes.

Money

The MASS core classes includes three classes for the representation of money. These are MMoney, MCurrency and LocalPettyMoney. An MMoney instance is a numeric measurement of a number of monetary units, where the units are defined by a currency. An MCurrency object instance defines a currency such as US dollars, Japanese Yen or British Pounds. The attributes of the MCurrency class include information such as the symbol for the currency and the ISO numeric code for that currency.

The MMoney class includes a variety of arithmetic operations, which allow calculations involving money objects to be easily performed. The internal numeric representation for the MMoney class is a fixed precision decimal number. This allows arithmetic calculation accuracy to be specified as needed and results in a more accurate calculation mechanism than that available with floating point numbers. Since the MMoney class includes an indication of currency and allows for very large monetary values, it is quite “heavy weight” considering the number of money object instances created in MASS systems. An alternative lightweight option is to use the LocalPettyMoney class.

As it's name suggest, LocalPettyMoney is a class that represents small amounts of money of the local currency. It is best used in situations where the money instances being handled are always low value local currency. The class includes the same set of arithmetic operations that the MMoney class has, though any operations that could result in a value overflow return an MMoney instance. This is done because MMoney handles very large monetary values, whilst LocalPettyMoney does not.

Exceptions

All exception classes in MASS are derived from a common base class MException. This provides basic operations that are common to all exceptions. It also allows exceptions to be processed in a consistent manner, rather than individual packages inventing an internal incompatible exception framework. The MASS core classes provide some common exception classes in addition to the base exception class.

Streams

Stream functionality is a common feature of the standard libraries of both the C++ and Java languages. Though stream concepts are common in the languages, the implementation is somewhat different between the Java 2 API and the C++ standard. For this reason, the IInputStream and IOutputStream abstract classes are defined in the MASS Rose model. These classes represent the common abstractions between the Java 2 API (InputStream and OutputStream) and the C++ standard (istream, ostream and iostream). The InputStream class can be requested for a sequence of bytes via its read operations, whilst the IOutputStream class can accept a sequence of bytes via its write operations

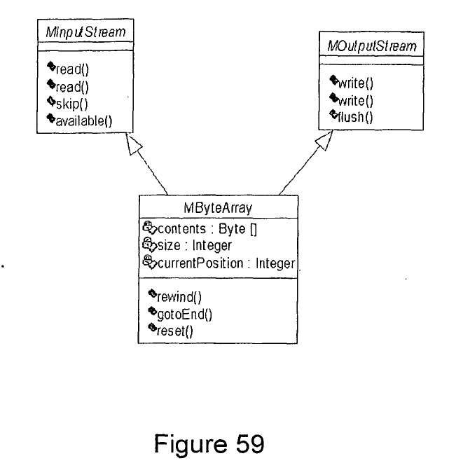

The MASS core classes include only a single class MByteArray, as shown in FIG. 59, which is an implementation of the stream interfaces. The MByteArray class stores a sequence of bytes in memory. It requires both an IInputStream and IOutputStream based interface so that bytes can be placed into the memory storage and read from it using standard mechanisms.

This approach allows the IInputStream and IOutputStream classes to be used for operations which need to generate and accept sequences of bytes respectively. The operations can then be passed an MByteArray instance or another class which implements IInputStream or IOutputStream. This is more flexible than explicitly requiring an MByteArray argument. It is best to use the stream interfaces when specifying an operation to receive or generate a sequence of bytes rather than passing an MByteArray instance. The interface approach allows any object that implements the stream interface to be used with that operation.

Run Time Class Definition

The MASS core classes provide a mechanism for accessing class structure information at run time. Three classes support this facility, and these are described below, in Table 43.

TABLE 43
Run Time Class Definition Classes

| Core Class | Description |
|---|---|
| MClass | Defines a class derived from the MObject class within MASS. It |
| | identifies the class name, a collection of attributes, the super class of |
| | the class and other class level information. |
| MAttribute | Defines an attribute of a class derived from MObject within MASS. |
| | The MAttribute class refers to another MClass instance to allow the |
| | representation of a graph of MClass objects structure. |
| MClassRegistry | A registry of classes derived from MObject stored as MClass |
| | instances. By default the registry includes the current version of |
| | classes compiled into the current executable. It can also include |
| | MClass instances, which define the class structure of other versions of |
| | MASS classes external to the current executable. This can be utilised |
| | by communication processes for handling version control issues. |

A registry of classes derived from MObject stored as MClass instances. By default the registry includes the current version of classes compiled into the current executable. It can also include MClass instances, which define the class structure of other versions of MASS classes external to the current executable. This can be utilised by communication processes for handling version control issues.

Static instances of MClass and MAttribute are automatically created for all classes that support serialisation or persistence. This automatic process is performed by the MASS code generation functionality. As such, there is no additional manual coding required by developers using the MASS framework.

These classes and the ability of an MObject to return it's associated MClass instance, allow the serialisation and persistence packages to get access to the internals of an object derived from MObject at run time. The MASS run time class definition functionality is data oriented and does not provide knowledge of class operations—only class attributes. This capability breaks data encapsulation of MASS objects and allows software such as MASS serialisation and persistence to not be bound to application class interfaces.

Primitive Proxies

The MASS Run Time Class Definition functionality allows access to the internals of an object's data structure hierarchy. Part of that data structure hierarchy involves primitive data types. The design of the MASS run time class definition functionality requires that all objects can be represented as MObject instances. For primitive data types, this is achieved by using proxy objects. The various proxy classes are listed in Table 44.

TABLE 44
Primitive Proxy Class Names

| Proxy Class | | | |
|---|---|---|---|
| Name | Model Type | C++ Type | Java Type |
| MInteger64Proxy | Integer64 | int64 | long |
| MInteger32Proxy | Integer32 | int32 | int |
| MInteger16Proxy | Integer16 | int16 | short |
| MInteger8Proxy | Integer8 | int8 | byte |
| MFloatProxy | Float | float | float |
| MDoubleProxy | Double | double | double |
| MBooleanProxy | Boolean | bool | boolean |

Instances of the primitive proxy classes will be returned when there is a need to deal with primitive data type attributes via the MASS run time class definition functionality. This functionality is only relevant when there is a need to deal with arbitrary objects or attributes of objects as MObject instances.

The use of the primitive proxy classes should be restricted to infrastructure packages such as serialisation and persistence which need to deal with arbitrary objects and primitives at run time. The majority of applications should use the standard primitive types and not the primitive proxy classes.

Operating System Abstraction

The Operating System Abstraction (OSA) provides an interface between MASS and the Operating System that functions in a similar fashion to an operating system API and allows programmers to write applications with all the operating system-independent advantages of writing to an API. This interface provides control, management of OS resources and access to OS properties or attributes to provide device independence.

The Operating System Abstraction package is divided into a set of sub-packages. Each sub-package is a grouping of use cases with related OSA functionality. They are:

(i) File Management

(ii) Shared Library Loading

(iii) Thread Management

(iv) Process Management

(v) Timer Management

(vi) Synchronisation

(vii) System Properties

File Management

File Management is a software component that manages the storage of files on a mass storage device by providing services that can create, read, write and delete files. File systems impose an ordered database on file on the mass storage device, called volumes, that use hierarchies of directories to organise files. File and File System Management provides an interface to manage file and directory content and attributes, and provide an abstraction of file paths consistent between independent operating systems. File types consist of raw binary and line formatted files. Access to files and directories is controlled by attributes, and the component allows.

(a) Raw Reads and Writes for Raw Files

(b) Read lines and Write lines for Formatted Files

(c) Plugin stream interfaces for both file types.

Shared Library Loading

The Shared Library Loader is responsible for loading shared libraries at run-time and symbolic referencing of functions within the library. This is primarily used by the Service Management-Service Agent to load in the subsystems relevant for each Service.

Process Management

By definition, the difference between a process and a thread are minimal. A process and thread can be the same. They are both execution entities, but processes are software services or programs running concurrently performing certain functions; whereas threads share the memory space of the process. Processes encapsulate a protected memory space and environment for its threads.

A process is composed of one or more threads. Process management allows for the termination of a process, to obtain the process Id or a running program and test to see if a program is executing. Process management also has a callback facility for the notification of process state changes.

Threading Management

A thread is a part of a program or process that executes independently of other parts. A thread is the most basic unit of code that can be scheduled for execution. A software chain of execution can run concurrently to perform the functionality of a process within the address space of that process. Threading Management is concerned with, creating threads, and thread local storage. Threads can also be considered as resources. They are created and represented as objects. The thread execution can either be running, suspended or stopped.

In terms of capabilities threads provide facilities for:

(i) Thread creation and destruction.

(ii) Executing the thread code (behaviour).

(iii) Remotely stopping a running thread.

(iv) Remotely suspending and resuming a thread.

(v) Setting thread priority.

(vi) Yielding thread activity.

(vii) Callback facility for the notification of state changes.

Thread local storage provides for global variables with data that is thread specific. This is to store:

(a) The MWorkerId—the thread identifier.

(b) The ErrorStack for the thread

(c) The thread interface.

Timer Management

Timer Management supports requirements for:

(a) Millisecond time graduation.

(b) Timers of repetitive and non repetitive nature.

Timer Management provides:

(i) For the creation and destruction of timers.

(ii) A callback facility to be performed on timeout.

(iii) Setting timer periodicity (millisecond time base)

(iv) Starting and stopping timer operation.

(v) Timer resetting.

Socket Management

Sockets provide a standard interface to transports such as TCP/IP and IPX. The standard Berkley Socket Distribution (BSD) TCP/IP socket model is used across all the operating systems.

The model caters for:

(i) A representation for the IP address and port addressing.

(ii) Connection sockets—sockets initiating connections.

(iii) Acceptor sockets—sockets waiting for connections.

(iv) Socket event notification.

(v) TCP and UDP

Synchronisation

A synchronisation handles the coordination of thread activity. This coordination can be inter-thread or inter-process.

The package includes synchronisation subsystems:

(a) Mutexes

(b) Event

(c) Semaphores

Whereas multithreading allows a single process the capability to execute multiple pieces of code, a mutex (mutual exclusive) locks a resource so that only one thread can access a resource at one time. Two object types are employed to perform a mutual exclusive locking: a lock object and a lock effector. The lock object contains the operating system mutex resource to handle the locking and the lock effector manages the locking scope and lifetime.

Mutexes can be named or unnamed. Unnamed mutexes have only thread scope (local) whereas named mutexes have inter-process scope (global).

System Properties

System Properties gives characteristics and resources values related to the operating system. This includes information on:

(i) date and time

(ii) Operating System Architecture

(iii) OS version

(iv) timezone

(v) locale

(vi) host name

(vii) host address

Serialisation

Serialisation is the conversion of a software object to a stream of bytes organised in a pre-defined format. Conversely de-serialisation is the conversion of a stream of bytes in a pre-deed format to a software object.

Because an object can be related to many other objects, serialisation of a single object may result in the serialisation of many related objects forming an object graph. This also applies to de-serialisation in that many related objects can be created. Object values and types are serialised with sufficient information to ensure that the equivalent typed object can be recreated. The term Serialisation is often used as a blanket term to refer to both directions of conversion.

The MASS Serialisation services allow applications to transfer and receive objects in a controlled and consistent manner. Only the state or data component of objects is transferred by the MASS serialisation functionality. Object behaviour is not serialised. The MASS serialisation services allow applications to:

(a) run on different processor platforms

(b) run on different operating systems

(c) interact with application classes at different revision levels

(d) be developed in different computing languages

MASS based systems have the following characteristics:

(i) higher end computing nodes run on either Sparc based servers or Intel based servers and workstations;

(ii) higher end computing nodes run either the Solaris or Windows NT operating systems;

(iii) embedded devices run on a variety of processors and operating systems;

(iv) MASS may be deployed in a multi-vendor environment due to customer requirements;

(v) MASS may be deployed in City wide scenarios, where deployment of software upgrades can only practically be applied over an extended period of time, hence, different versions of software need to be able to communicate successfully; and

(vi) MASS core software, and project software that builds on MASS, is written in the C++ and/or Java programming languages.

Serialisation Example

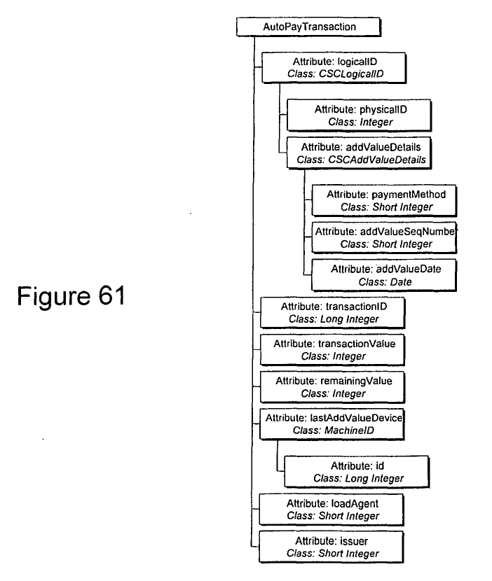

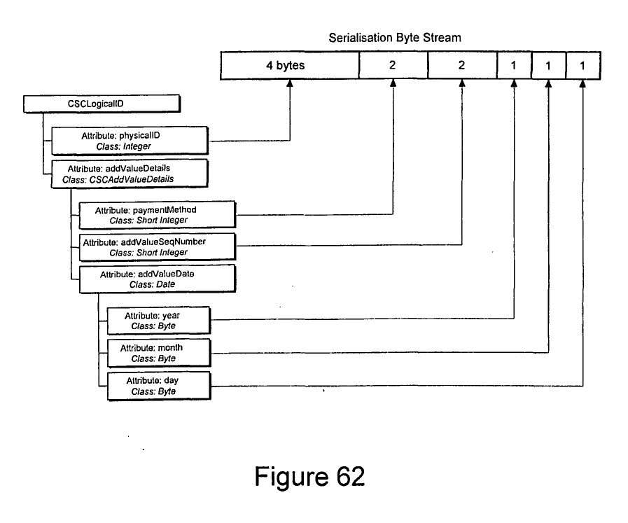

This section describes a simple example of the serialisation of an object. FIG. 61 shows an object graph for class called AutoPayTransaction. A serialisation mechanism translates the contents of an object such as an AutoPayTransaction instance into a sequence of bytes. FIG. 62 illustrates how a simple serialisation mechanism can be used to map an object's data contents into a sequence of bytes. The serialisation mechanism traverses the entire object graph and writes information to the byte stream when a primitive class such as an integer or byte is reached. In this simple example, the serialisation format stores integers as four bytes, short integers as two bytes and byte values as single bytes. For the serialisation format to be portable, the eight-bit sections of an integer or short integer would need to be stored in a consistent order. Examples of consistent ordering are little-endian and big-endian orderings. This simple serialisation format example has a number of deficiencies. These deficiencies are addressed by the features of the MASS serialisation mechanism described below

One of the deficiencies, of the simple serialisation format example provided, is that no object structure information is stored in the stream of bytes. This implies that the format can not tolerate any changes to the CSCLogicalID object structure. For example, if the addValueSeqNumber attribute was modified so that it was an integer instead of a short integer, errors would result during deserialisation of a byte stream created using the original version of the class definition.

Also, this simple serialisation format relies on the application knowing by context what class of objects have been serialised to a byte stream. The application that de-serialises the example stream either assumes or ‘knows’ that a CSCLogicalID has been serialised to the stream. XDR is an example of a serialisation format that writes no object structure information to a byte stream. This style of serialisation provides very little scope for handling the deployment of multiple software revisions without significant application code development.

Although this example illustrates a binary storage based serialisation format, serialisation formats can also be textual in nature. Textual formats are easily readable by humans, but have disadvantages in terms of storage and processor resource usage.

Application Areas

Listed below are the areas of application for Serialisation within the MASS framework and applications that build on the framework.

File Based Storage

The state of objects may need to be stored to storage media for recoverability or long term availability. The storage media does not have to be a “traditional” hard disk file, but can be storage destinations such as flash memory or the storage keys used in the ERG TRAX system for buses. Though a large proportion of the long term storage functionality within MASS is oriented towards persistence to databases and relational databases, there is likely to be specialised cases where simple file based storage is preferable. An example is the storage of the schema mappings for the MASS database persistence mechanism. Another example is the localisation information for MASS deployment.

RDBMS BLOB Storage

Objects can be mapped to relational database tables using a persistence mechanism and object-relational mapping. Even with database persistence, serialisation can still be useful where the relational tables being mapped to contain BLOB columns. Objects or collections of objects can be serialised to BLOB columns if needed for application specific reasons.

Synchronous Communications

Synchronous communications facilities such as Sun RPC, CORBA, Microsoft COM and Sun's JAVA RMI all require some form of serialisation to convert objects or remote procedure call requests to a sequence of bytes to transmit and receive across a communications network. The term marshalling is typically used in this functionality domain to describe similar concepts. CORBA packages allow the internal marshalling mechanism for the transmission of object data to be retrofitted with a programmer specified alternative.

The MASS serialisation mechanism can be used in these scenarios to serialise/de-serialise object state for transmission across a network. The advantage of using MASS serialisation functionality is its strengths in the area of software revision handling.

External Systems and Third Party Devices

Systems external to MASS can communicate by the interchange of objects. The use of a serialisation mechanism formalises this interchange. Examples of objects that need to be communicated between devices and Third Party devices include event information and configuration data.

Features of Serialisation Mechanism

The feature of the MASS Serialisation package are:

(i) Consistency.

(ii) Platform Independence. All byte ordering, packing boundaries and other machine specific formatting issues are handled by the serialisation package.

(iii) Minimal Application Programming Effort.

(iv) Efficient Storage. The serialisation mechanism efficiently store data structures/objects so that the size of the resulting stream size in bytes is minimised

(v) Third Party Integration. The serialisation mechanism allows for easy integration with third parties. Examples of third parties include embedded device vendors, financial institutions and existing customer equipment.

(vi) Communication Services Integration. The serialisation mechanism allows for easy integration with the asynchronous and synchronous communication mechanisms of MASS.

(vii) Class Structure Separation. The serialisation mechanisms optionally write the class data definition of the objects being serialised to the stream. This allows two communicating parties to be able to transfer serialised object class structure once at the start of a communication session, rather than continually transmitting the data structure information.

(viii) Attribute Encryption. The serialisation process is capable of encrypting and decrypting specific attributes of classes of objects, as opposed to just supporting the encryption of the stream as a whole.

(ix) Extendable Formats. The serialisation functionality is extendable to support project specific serialisation formats

(x) Version Independence. The Serialisation package detects and handles differences in different versions of the same information communicated between different releases of software

Serialisation Format

A serialisation format defines the format in which bytes are output to a stream to represent objects and class definitions. MASS supports two serialisation formats by default. In addition, projects can build on the MASS framework to implement project specific serialisation formats. The two standard MASS serialisation formats are:

(a) a MASS Binary Serialisation format (MBS).

(b) XML based serialisation format.

Two serialisation formats are supported to provide the features described above. The MASS binary serialisation format is used internally within MASS systems for performance and storage reasons. The XML based serialisation format is used when communicating with third parties or external systems.

Serialisation and Version Control

Aspects of the MASS serialisation mechanism that provide support for inter-operability between software of different versions are listed below.

Class Version Unique Identifier

Each version of a class can be uniquely identified by the Class Version UID. This is a digest calculated from the all of the information that defines the structure of a class. This includes the class name, super class specification, member names and member types. Any change to a class definition results in a change in the Class Version UID. This unique identifier provides a means of identifying whether classes are of different versions and does not rely on humans to define version numbers.

Primitive Data Type Changes

Pre-defined primitive data type changes are supported automatically. For example changing a member from one number type to another such as changing from a short to a long. Any conversion errors relating to data ranges are reported to the de-serialised object.

Attribute Removal

If an attribute is received in a serialised stream, which does not exist in the local version of the class, the occurrence of this attribute is reported to the de-serialised object. The default behaviour is that the de-serialised object ignores the attribute.

Attribute Addition

If a de-serialised object is created and it does not have all of its attribute values set, then the values that have not been set take on the default value for the attribute. The de-serialised object is informed of all attributes that have taken their default value and can take additional action if necessary.

Attribute Class Change

If an attribute of a de-serialised object has a completely different class than that defined by the stream being read, then the attribute is informed of the difference. The attribute object can then initialise itself from an object read from the stream. This allows classes to include backward compatibility functionality for information serialised with older versions of the software in difficult version control scenarios such as a class change. The default behaviour is to accept the default value and not try and interpret the older revision serialised information. The approach taken is that the serialisation reader mechanism has defined defaults for handling version differences in classes. Application classes can then include additional classes, which can be tailored to individual version handling.

Many modifications will be apparent to those skilled in the art without departing from the scope of the present invention as herein described with reference to the accompanying drawings.

1. A card system including a plurality of component infrastructures, said component infrastructures each having core components of said system, said infrastructures having a hierarchal relationship such that one infrastructure is dependent on components of a lower infrastructure, and said core components being configurable for different card transaction applications.

2. A card system as claimed in claim 1, wherein the components of an upper infrastructure are selectable for said applications and at least the components of a lower infrastructure are configured on the basis of configuration data.

3. A card system as claimed in claim 1, wherein an upper infrastructure includes management components to control data for cards, devices operable with the cards, participants, patrons and card purses.

4. A card system as claimed in claim 3, wherein a lower infrastructure has a component for managing configuration data for other components.

5. A card system as claimed in claim 3, wherein a lower infrastructure has a messaging component for handling message delivery between nodes of said system, and a publishing component for generating messages independent of said messaging component.

6. A card system as claimed in claim 5, wherein the messages received by a processor of a node are persisted in a data store of the node irrespective of whether the messages require further processing by other nodes of the system.

7. A card system as claimed in claim 6, wherein said nodes are communication network nodes and include components for a service provider, an acquirer, a clearing house and a card issuer, respectively.

8. A card system as claimed in claim 4, wherein the system includes nodes connected by a communications network, said nodes each having a transaction handler, said transaction handler including a unpacker to unpack transaction messages and route the messages to an instance of a transaction processor, said transaction processor controlling subsequent processing for said message.

9. A card system as claimed in claim 8, wherein said transaction processor initiates role processing of the message, based on a role for the message, such as purse or card management.

10. A card system as claimed in claim 9, wherein said processor initiates a validation process to validate the message.

11. A card system as claimed in claim 9, wherein said transaction processor initiates a process to determine the message is not a duplicate.

12. A card system as claimed in claim 2, wherein the upper infrastructure includes card management components for managing card issuance, maintenance of card data and hotlisting of cards.

13. A card system as claimed in claim 2, wherein said upper infrastructure includes components for managing devices of the system, including adding and removing devices, and remote configuration monitoring of devices, said devices being adapted to communicate with cards of the system.

14. A card system as claimed in claim 2, wherein the upper infrastructure includes components for managing financial services for participants, such as clearing and reconciliation of transactions between participants.

15. A card system as claimed in claim 2, wherein the upper infrastructure includes components for assigning roles and services to participants.

16. A card system as claimed in claim 2, wherein the upper infrastructure includes components for managing a purse on a card and for managing data associated with a patron using the card.

17. A card system as claimed in claim 1, wherein the components of a lower infrastructure include tools for graphical user application development to establish a framework for authentication of users.

18. A card system as claimed in claim 1, wherein components of a lower infrastructure include service components for handling transactions for components of an upper infrastructure at nodes of the system, and for maintaining and distributing action lists to a node.

19. A card system as claimed in claim 1, wherein the components of a lower infrastructure establish a messaging system for publishing messages to respective users of the system based on a topic of the message.

20. A card system as claimed in claim 1, wherein an upper infrastructure includes components for controlling the maintenance, distribution and access to configuration data for components of the system.

21. A card system as claimed in claim 1, wherein one of said infrastructures is a base services layer including core classes and an operating system interface having APIs for controlling, managing and providing access to OS resources.

22. A card system as claimed in claim 21, wherein said base service layer includes a serialisation component for converting objects into a stream for delivery.

23. A card system as claimed in claim 1, wherein an upper infrastructure has components adjusted by the components of a lower infrastructures.

24. A card system as claimed in claim 1, wherein the infrastructures include APIs and are platform independent.

25. A card system as claimed in claim 1, including managed objects having attributes to control the state of a resource of said system.

26. Software for a multiple application card system, stored on computer readable storage media, including a plurality of component infrastructures, said component infrastructures each having core components, said infrastructures having a hierarchal relationship such that one infrastructure is dependent on components of a lower infrastructure, and said core components being configurable for different card transaction applications.

27. Software as claimed in claim 26, wherein the components of an upper infrastructure are selectable for said applications and at least the components of a lower infrastructure are configured on the basis of configuration data.

28. Software as claimed in claim 26, wherein the upper infrastructure includes card management components for managing card issuance, maintenance of card data and hotlisting of cards.

29. Software as claimed in claim 27, wherein said upper infrastructure includes components for managing devices of the system, including adding and removing devices, and remote configuration monitoring of devices, said devices being adapted to communicate with cards of the system.

30. Software as claimed in claim 27, wherein the upper infrastructure includes components for managing financial services for participants, such as clearing and reconciliation of transactions between participants.

31. Software as claimed in claim 27, wherein the upper infrastructure includes components for assigning roles and services to participants.

32. Software as claimed in claim 27, wherein the upper infrastructure includes components for managing a purse on a card and for managing data associated with a patron using the card.

33. Software as claimed in claim 26, wherein the components of a lower infrastructure include tools for graphical user application development to establish a framework for authentication of users.

34. Software as claimed in claim 26, wherein components of a lower infrastructure include service components for handling transactions for components of an upper infrastructure at nodes of the system, and for maintaining and distributing action lists to a node.

35. Software as claimed in claim 26, wherein the components of a lower infrastructure publish messages to respective users of the system based on a topic of the message.

36. Software as claimed in claim 26, wherein an upper infrastructure includes components for controlling the maintenance, distribution and access to configuration data for components of the system.

37. Software as claimed in claim 26, wherein one of said infrastructures is a base services layer including core classes and an operating system interface having APIs for controlling, managing and providing access to OS resources.

38. Software as claimed in claim 37, wherein said base service layer includes a serialisation component for converting objects into a stream for delivery.

39. Software as claimed in claim 266, wherein an upper infrastructure has components adjusted by the components of a lower infrastructure.

40. Software as claimed in claim 26, wherein the infrastructures include APis and are platform independent.

41. Software as claimed in claim 26, including managed objects having attributes to control the state of a resource of said system.

42. A transaction handler for a card system, executed on a node of the system, having:
an unpacker for unpacking messages received by the node;
a router for routing unpacked messages to a transaction processor; and
a transaction processor for controlling validation, role processing and forwarding of said message.

43. A transaction handler for a card system as claimed in claim 26, wherein said transaction processor maintains a cache for all messages received.

44. A transaction handler for a card system as claimed in claim 27, wherein said transaction handler initiates a plurality of threads of said unpacker and said transaction processor.
